(19) United States
(12) Patent Application Publication
(10) Pub. No.: US 2025/0219699 A1
(43) Pub. Date: Jul. 3, 2025

(54) METHOD AND APPARATUS FOR REPORTING CHANNEL STATE INFORMATION IN WIRELESS COMMUNICATION SYSTEM

(71) Applicant: SAMSUNG ELECTRONICS CO., LTD., Suwon-si (KR)

(72) Inventors: Youngrok JANG, Suwon-si (KR); Seongmok LIM, Suwon-si (KR); Hyoungju JI, Suwon-si (KR); Kyungjun CHOI, Suwon-si (KR)

(21) Appl. No.: 19/001,028

(22) Filed: Dec. 24, 2024

(30) Foreign Application Priority Data
Dec. 26, 2023 (KR) 10-2023-0190762
Feb. 16, 2024 (KR) 10-2024-0022863

(51) Int. Cl. H04B 7/06; H04L 5/14; H04W 24/10; H04W 72/0453

(52) U.S. Cl. CPC H04B 7/0626; H04L 5/14; H04W 24/10; H04W 72/0453

(57) ABSTRACT

The disclosure relates to a 5G or 6G communication system for supporting a higher data transmission rate. The disclosure relates to operations of a UE and base station in a wireless communication system, and specifically, the disclosure relates to a method for transmitting and receiving an uplink reference signal in a wireless communication system and an apparatus capable of performing the same. The disclosure provides an apparatus and method capable of effectively providing services in a mobile communication system.

### CROSS REFERENCE TO RELATED APPLICATIONS

The present application claims priority to Korean Patent Application No. 10-2023-0190762 filed on Dec. 26, 2023, and Korean Patent Application No. 10-2024-0022863 filed on Feb. 16, 2024, the entire contents of which is incorporated herein for all purposes by this reference.

### BACKGROUND

### 1. Field

The disclosure relates to the operations of a user equipment (UE) and base station in a wireless communication system. Specifically, the disclosure relates to a method for reporting channel state information in a wireless communication system and an apparatus capable of performing the same.

### 2. Description of Related Art

5^{th} generation (5G) mobile communication technologies define broad frequency bands such that high transmission rates and new services are possible, and can be implemented not only in “Sub 6 GHZ” bands such as 3.5 GHZ, but also in “Above 6 GHZ” bands referred to as mmWave including 28 GHz and 39 GHz. In addition, it has been considered to implement 6G mobile communication technologies, which is referred to as Beyond 5G systems, in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra-Reliable Low-Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of Band-Width Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, drone communication, and the like.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The disclosed embodiment is intended to provide an apparatus and method capable of effectively providing a service in a mobile communication system.

The technical objects to be achieved by various embodiments of the disclosure are not limited to the technical objects mentioned above, and other technical objects not mentioned may be considered by those skilled in the art from various embodiments of the disclosure to be described below.

According to an embodiment, a method performed by a user equipment (UE) in a communication system is provided.

According to an embodiment, the method may include receiving, via higher layer signaling, a first configuration associated with subband non-overlapping full duplex (SBFD) and a second configuration associated with channel state information (CSI) reference signal (CSI-RS) resources; identifying, based on the first configuration and the second configuration, CSI-RS resources corresponding to at least one SBFD symbol of an SBFD slot, wherein the CSI-RS resources corresponding to at least one SBFD symbol include at least one first CSI-RS resource overlapped with at least one downlink SBFD subband corresponding to the SBFD slot and at least one second CSI-RS resource overlapped with at least one uplink SBFD subband corresponding to the SBFD slot; receiving, based on the at least one first CSI-RS resource, a first CSI-RS corresponding to a sequence, wherein the sequence is mapped to resource elements (REs) within resource blocks (RBs) corresponding to the at least one first CSI-RS resource and the at least one second CSI-RS resource; and transmitting CSI associated with the first CSI-RS.

According to an embodiment, wherein the at least one second CSI-RS resource is not used for reception of the first CSI-RS.

According to an embodiment, wherein the RBs are contiguous in a frequency domain.

According to an embodiment, wherein the RBs are identified based on a start RB configuration and number of RB configuration in the second configuration.

According to an embodiment, the method may include receiving, via the higher layer signaling, a first CSI report configuration associated with the SBFD symbol, and a second CSI report configuration associated with a non-SBFD symbol; identifying, based on the first configuration and the second configuration, CSI-RS resources corresponding to at least one non-SBFD symbol; receiving, based on the CSI-RS resources corresponding to at least one non-SBFD symbol, a second CSI-RS; and transmitting CSI associated with the second CSI-RS.

According to an embodiment, wherein the CSI corresponding to the first CSI-RS is transmitted based on the first CSI report.

According to an embodiment, wherein the CSI corresponding to the second CSI-RS is transmitted based on the second CSI report.

According to an embodiment, wherein the CSI corresponding to the first CSI-RS is derived by using the first CSI-RS and the second CSI-RS is not used for derivation of the CSI corresponding to the first CSI-RS.

According to an embodiment, wherein the CSI corresponding to the second CSI-RS is derived by using the second CSI-RS and the first CSI-RS is not used for derivation of the CSI corresponding to the second CSI-RS.

According to an embodiment, a user equipment (UE) in a communication system is provided.

According to an embodiment, the UE may include a transceiver; and a processor coupled with the transceiver and configured to: receive, via higher layer signaling, a first configuration associated with subband non-overlapping full duplex (SBFD) and a second configuration associated with channel state information (CSI) reference signal (CSI-RS) resources; identify, based on the first configuration and the second configuration, CSI-RS resources corresponding to at least one SBFD symbol of an SBFD slot, wherein the CSI-RS resources corresponding to at least one SBFD symbol include at least one first CSI-RS resource overlapped with at least one downlink SBFD subband corresponding to the SBFD slot and at least one second CSI-RS resource overlapped with at least one uplink SBFD subband corresponding to the SBFD slot; receive, based on the at least one first CSI-RS resource, a first CSI-RS corresponding to a sequence, wherein the sequence is mapped to resource elements (REs) within resource blocks (RBs) corresponding to the at least one first CSI-RS resource and the at least one second CSI-RS resource; and transmit CSI associated with the first CSI-RS.

According to an embodiment, wherein the at least one second CSI-RS resource is not used for reception of the first CSI-RS.

According to an embodiment, wherein the RBs are contiguous in a frequency domain.

According to an embodiment, wherein the RBs are identified based on a start RB configuration and number of RB configuration in the second configuration.

According to an embodiment, wherein the processor is further configured to: receive, via the higher layer signaling, a first CSI report configuration associated with the SBFD symbol, and a second CSI report configuration associated with a non-SBFD symbol; identify, based on the first configuration and the second configuration, CSI-RS resources corresponding to at least one non-SBFD symbol; receive, based on the CSI-RS resources corresponding to at least one non-SBFD symbol, a second CSI-RS; and transmit CSI associated with the second CSI-RS.

According to an embodiment, wherein the CSI corresponding to the first CSI-RS is transmitted based on the first CSI report.

According to an embodiment, wherein the CSI corresponding to the second CSI-RS is transmitted based on the second CSI report.

According to an embodiment, wherein the CSI corresponding to the first CSI-RS is derived by using the first CSI-RS and the second CSI-RS is not used for derivation of the CSI corresponding to the first CSI-RS.

According to an embodiment, wherein the CSI corresponding to the second CSI-RS is derived by using the second CSI-RS and the first CSI-RS is not used for derivation of the CSI corresponding to the second CSI-RS.

According to an embodiment, a method performed by a base station in a communication system is provided.

According to an embodiment, the method may include transmitting, via higher layer signaling, a first configuration associated with subband non-overlapping full duplex (SBFD) and a second configuration associated with channel state information (CSI) reference signal (CSI-RS) resources; identifying CSI-RS resources corresponding to at least one SBFD symbol of an SBFD slot, wherein the CSI-RS resources corresponding to at least one SBFD symbol include at least one first CSI-RS resource overlapped with at least one downlink SBFD subband corresponding to the SBFD slot and at least one second CSI-RS resource overlapped with at least one uplink SBFD subband corresponding to the SBFD slot; transmitting, based on the at least one first CSI-RS resource, a first CSI-RS corresponding to a sequence, wherein the sequence is mapped to resource elements (REs) within resource blocks (RBs) corresponding to the at least one first CSI-RS resource and the at least one second CSI-RS resource; and receiving CSI associated with the first CSI-RS.

According to an embodiment, wherein the at least one second CSI-RS resource is not used for transmission of the first CSI-RS.

According to an embodiment, wherein the RBs are contiguous in a frequency domain, and

According to an embodiment, wherein the RBs are configured based on a start RB configuration and number of RB configuration in the second configuration.

According to an embodiment, the method may include transmitting, via the higher layer signaling, a first CSI report configuration associated with the SBFD symbol, and a second CSI report configuration associated with a non-SBFD symbol; identifying CSI-RS resources corresponding to at least one non-SBFD symbol; transmitting, based on the CSI-RS resources corresponding to at least one non-SBFD symbol, a second CSI-RS; and receiving CSI associated with the second CSI-RS.

According to an embodiment, wherein the CSI corresponding to the first CSI-RS is associated with the first CSI report.

According to an embodiment, wherein the CSI corresponding to the second CSI-RS is associated with the second CSI report.

According to an embodiment, wherein the CSI corresponding to the first CSI-RS is derived by using the first CSI-RS and the second CSI-RS is not used for derivation of the CSI corresponding to the first CSI-RS.

According to an embodiment, wherein the CSI corresponding to the second CSI-RS is derived by using the second CSI-RS and the first CSI-RS is not used for derivation of the CSI corresponding to the second CSI-RS.

According to an embodiment, a base station in a communication system is provided.

According to an embodiment, the base station may include a transceiver; and a processor coupled with the transceiver and configured to: transmit, via higher layer signaling, a first configuration associated with subband non-overlapping full duplex (SBFD) and a second configuration associated with channel state information (CSI) reference signal (CSI-RS) resources; identify CSI-RS resources corresponding to at least one SBFD symbol of an SBFD slot, wherein the CSI-RS resources corresponding to at least one SBFD symbol include at least one first CSI-RS resource overlapped with at least one downlink SBFD subband corresponding to the SBFD slot and at least one second CSI-RS resource overlapped with at least one uplink SBFD subband corresponding to the SBFD slot; transmit, based on the at least one first CSI-RS resource, a first CSI-RS corresponding to a sequence, wherein the sequence is mapped to resource elements (REs) within resource blocks (RBs) corresponding to the at least one first CSI-RS resource and the at least one second CSI-RS resource; and receive CSI associated with the first CSI-RS.

According to an embodiment, wherein the at least one second CSI-RS resource is not used for transmission of the first CSI-RS.

According to an embodiment, wherein the RBs are contiguous in a frequency domain.

According to an embodiment, wherein the RBs are configured based on a start RB configuration and number of RB configuration in the second configuration.

According to an embodiment, wherein the processor is further configured to: transmit, via the higher layer signaling, a first CSI report configuration associated with the SBFD symbol, and a second CSI report configuration associated with a non-SBFD symbol; identify CSI-RS resources corresponding to at least one non-SBFD symbol; transmit, based on the CSI-RS resources corresponding to at least one non-SBFD symbol, a second CSI-RS; and receive CSI associated with the second CSI-RS.

According to an embodiment, wherein the CSI corresponding to the first CSI-RS is associated with the first CSI report.

According to an embodiment, wherein the CSI corresponding to the second CSI-RS is associated with the second CSI report.

According to an embodiment, wherein the CSI corresponding to the first CSI-RS is derived by using the first CSI-RS and the second CSI-RS is not used for derivation of the CSI corresponding to the first CSI-RS.

According to an embodiment, wherein the CSI corresponding to the second CSI-RS is derived by using the second CSI-RS and the first CSI-RS is not used for derivation of the CSI corresponding to the second CSI-RS.

The above-described various embodiments of the disclosure are merely some of the preferred embodiments of the disclosure, and various embodiments reflecting the technical features of the disclosure may be derived and understood by those skilled in the art based on the following detailed description of the disclosure.

The disclosed embodiment provides an apparatus and method capable of effectively providing a service in a mobile communication system.

The effects that can be achieved through the disclosure are not limited to the effects mentioned in the various embodiments, and other effects not mentioned will be clearly understood by those skilled in the art from the description below.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a basic structure of a time-frequency domain of a wireless communication system according to an embodiment of the disclosure;

FIG. 2 illustrates a structure of a frame, a subframe, and a slot in a wireless communication system according to an embodiment of the disclosure;

FIG. 3 illustrates an example of bandwidth part configuration in a wireless communication system according to an embodiment of the disclosure;

FIG. 4 illustrates radio protocol structures of a UE and a base station in single cell, carrier aggregation, and dual connectivity situations in a wireless communication system according to an embodiment of the disclosure;

FIG. 5 illustrates an example of an aperiodic CSI reporting method;

FIG. 6 illustrates an example of a control resource set configuration of a downlink control channel in a wireless communication system according to an embodiment of the disclosure;

FIG. 7 illustrates a structure of a downlink control channel in a wireless communication system according to an embodiment of the disclosure;

FIG. 8 illustrates an example of an antenna port configuration and resource allocation for cooperative communication in a wireless communication system according to an embodiment of the disclosure;

FIG. 9 illustrates an example of a downlink control information (DCI) configuration for cooperative communication in a wireless communication system according to an embodiment of the disclosure;

FIG. 10 illustrates an uplink-downlink resource configuration of an XDD system in which uplink and downlink resources are flexibly divided in time domain and frequency domain, according to an embodiment of the disclosure;

FIG. 11 illustrates an example of an uplink-downlink resource configuration of a full duplex communication system in which uplink and downlink resources are flexibly divided in time domain and frequency domain, according to an embodiment of the disclosure;

FIG. 12 illustrates a transmission/reception structure for a duplex scheme according to an embodiment of the disclosure;

FIG. 13 illustrates an example of downlink and uplink resource configuration in an XDD system;

FIG. 14 illustrates an example of SBFD operated in a TDD band of a wireless communication system to which the present disclosure is applied;

FIG. 15 illustrates an SBFD configuration according to an embodiment of the disclosure;

FIG. 16 illustrates an aperiodic CSI report signaling structure that a UE may be configured through higher layer signaling according to an embodiment of the disclosure;

FIG. 17 illustrates an aperiodic CSI report and aperiodic CSI-RS triggering situations and constraints according to an embodiment of the disclosure;

FIG. 18 illustrates a CSI-RS reception scheme considering SBFD, according to an embodiment of the disclosure;

FIG. 19A illustrates a structure of CSI reporting-related higher layer signaling considering SBFD based on the channel estimation in the downlink slot (19-01), according to an embodiment of the disclosure;

FIG. 19B illustrates a structure of CSI reporting-related higher layer signaling considering SBFD based on the channel estimation in the downlink slot (19-21), according to an embodiment of the disclosure;

FIG. 19C illustrates a structure of CSI reporting-related higher layer signaling considering SBFD based on the channel estimation in the downlink slot (19-41), according to an embodiment of the disclosure;

FIG. 20 illustrates another structure of CSI reporting-related higher layer signaling considering SBFD, according to an embodiment of the disclosure;

FIG. 21 illustrates an operation of a UE for CSI-RS reception and CSI reporting considering SBFD, according to an embodiment of the disclosure;

FIG. 22 illustrates an operation of a base station for CSI-RS reception and CSI reporting considering SBFD, according to an embodiment of the disclosure;

FIG. 23 illustrates a non-codebook based PUSCH transmission process, according to an embodiment of the disclosure;

FIG. 24 illustrates a method for determining an associated CSI-RS transmission position for non-codebook based PUSCH transmission in an SBFD system, according to an embodiment of the disclosure;

FIG. 25 illustrates an operation of a UE for non-codebook based PUSCH transmission in an SBFD system, according to an embodiment of the disclosure;

FIG. 26 illustrates an operation of a base station for non-codebook based PUSCH transmission in an SBFD system, according to an embodiment of the disclosure;

FIG. 27 illustrates a structure of a UE in a wireless communication system according to an embodiment of the disclosure; and

FIG. 28 illustrates a structure of a base station in a wireless communication system according to an embodiment of the disclosure;

### DETAILED DESCRIPTION

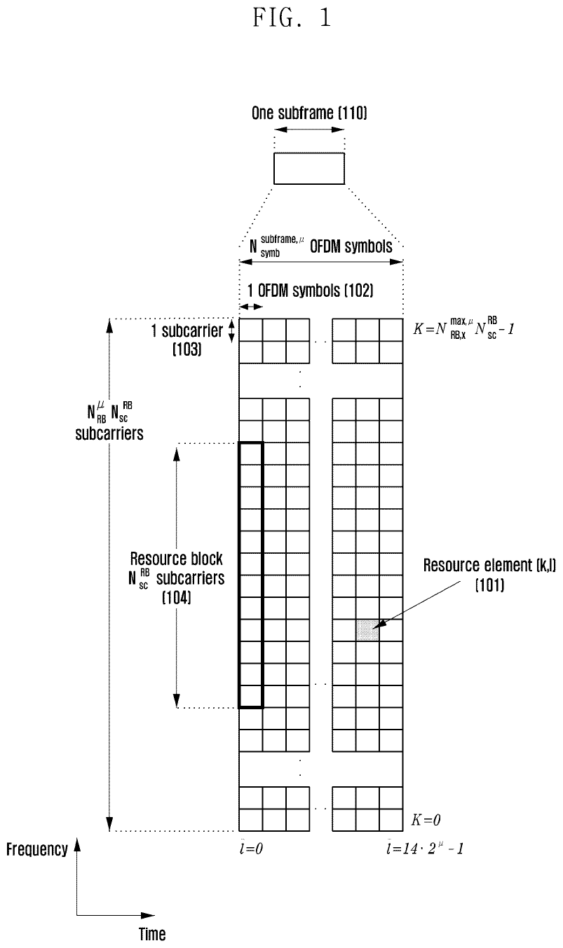

FIGS. 1 through 28, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Furthermore, in describing the disclosure, a detailed description of known functions or constitution incorporated herein will be omitted in the case that it is determined that the description may make the subject matter of the disclosure unnecessarily unclear. The terms which will be described below are terms defined in consideration of the functions in the disclosure, and may be different according to users, intentions of the operators, or customs. Therefore, the definitions of the terms should be made based on the contents throughout the specification.

Hereinafter, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. In the disclosure, a downlink (DL) refers to a radio link through which a base station transmits a signal to a UE, and an uplink (UL) refers to a radio link through which a UE transmits a signal to a base station. Furthermore, hereinafter, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and hereinafter, the 5G may be the concept that covers the exiting LTE, LTE-A, or other similar services. In addition, based on determinations by those skilled in the art, the embodiments of the disclosure may also be applied to other communication systems through some modifications without significantly departing from the scope of the disclosure.

Herein, it will be understood that each block of the flowchart illustrations, and combinations of blocks in the flowchart illustrations, may be performed by computer program instructions. These computer program instructions may be loaded onto a processor of a general purpose computer, special purpose computer, or other programmable data processing apparatus to produce a machine, such that the instructions, which perform through the processor of the computer or other programmable data processing apparatus, create means for performing the functions specified in the flowchart block(s). These computer program instructions may also be stored in a computer usable or computer-readable memory that may direct a computer or other programmable data processing apparatus to function in a particular manner, such that the instructions stored in the computer usable or computer-readable memory produce an article of manufacture including instruction means that perform the function specified in the flowchart block(s). The computer program instructions may also be loaded onto a computer or other programmable data processing apparatus to cause a series of operational steps to be performed on the computer or other programmable data processing apparatus to produce a computer executed process such that the instructions that perform on the computer or other programmable data processing apparatus provide steps for executing the functions specified in the flowchart block(s).

Further, each block may represent a module, segment, or portion of code, which includes one or more executable instructions for executing the specified logical function(s). It should also be noted that in some alternative implementations, the functions noted in the blocks may occur out of the order. For example, two blocks shown in succession may in fact be performed substantially concurrently or the blocks may sometimes be performed in the reverse order, depending upon the functionality involved.

As used in embodiments of the disclosure, the “˜unit” refers to a software element or a hardware element, such as a Field Programmable Gate Array (FPGA) or an Application Specific Integrated Circuit (ASIC), which performs a predetermined function. However, the “˜unit” does not always have a meaning limited to software or hardware. The “˜unit” may be constructed either to be stored in an addressable storage medium or to execute one or more processors. Therefore, the “˜unit” includes, for example, software elements, object-oriented software elements, components such as class elements and task elements, processes, functions, properties, procedures, sub-routines, segments of a program code, drivers, firmware, micro-codes, circuits, data, database, data structures, tables, arrays, and parameters. The components and functions provided by the “˜unit” may be either combined into a smaller number of components and a “˜unit,” or divided into additional components and a “˜unit.” Moreover, the components and “˜units” may be implemented to reproduce one or more CPUs within a device or a security multimedia card. Further, in the embodiments, the “^{˜}unit” may include one or more processors.

A wireless communication system has developed into a broadband wireless communication system that provides a high-speed and high-quality packet data service according to communication standards, such as high speed packet access (HSPA) of 3GPP, long term evolution (LTE or evolved universal terrestrial radio access (E-UTRA)), LTE-Advanced (LTE-A), LTE-Pro, high rate packet data (HRPD) of 3GPP2, ultra mobile broadband (UMB), and IEEE 802.16e, beyond the initially provided voice-based service.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link through which a user equipment (UE) (or a mobile station (MS)) transmits data or control signals to a base station (BS) (eNode B), and the downlink refers to a radio link through which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, may be able to freely reflect various requirements of users, service providers, and the like, services satisfying various requirements may be supported. The services considered in the 5G communication system include enhanced mobile broadband (eMBB) communication, massive machine-type communication (mMTC), ultra reliability low latency communication (URLLC), and the like.

eMBB aims at providing a data rate higher than that supported by conventional LTE, LTE-A, or LTE-Pro. For example, in the 5G communication system, eMBB may provide a peak data rate of 20 Gbps in the downlink and a peak data rate of 10 Gbps in the uplink from the perspective of a single base station. Furthermore, the 5G communication system may provide an increased user-perceived data rate of the UE, as well as the maximum data rate. In order to satisfy such requirements, transmission/reception technologies including a further enhanced multi input multi output (MIMO) transmission technique are required to be improved. In addition, while LTE transmits signals using a transmission bandwidth up to 20 MHz in a band of 2 GHz, 5G communication systems can satisfy the data transmission rate required for the 5G communication systems by using a frequency bandwidth more than 20 MHz in the frequency band of 3 to 6 GHz or 6 GHz or more.

Meanwhile, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it may support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC may be constituted to be inexpensive, and may require a very long battery lifetime such as 10 to 15 years because it is difficult to frequently replace the battery of the UE.

Lastly, URLLC, which is a cellular-based mission-critical wireless communication service, may be considered for services used for remote control for robots or machines, industrial automation, unmanned aerial vehicles, remote health care, emergency alert, and the like. Thus, URLLC may provide communication with ultra-low latency and ultra-high reliability. For example, a service supporting URLLC may satisfy an air interface latency of less than 0.5 ms, and requires a packet error rate of 10⁻⁵ or less at the same time. Therefore, for the services supporting URLLC, a 5G system may provide a transmit time interval (TTI) shorter than those of other services, and also may require a design for assigning a large number of resources in a frequency band in order to secure reliability of a communication link.

The three 5G services, that is, eMBB, URLLC, and mMTC, may be multiplexed and transmitted in a single system. In this case, different transmission/reception techniques and transmission/reception parameters may be used between services in order to satisfy different requirements of the respective services. It is apparent that 5G is not limited to the above-described three services.

Hereinafter, a/b can be understood as at least one of a and b.

### [NR Time-Frequency Resource]

Hereinafter, the frame structure of a 5G system will be described in more detail with reference to the accompanying drawings.

FIG. 1 illustrates a basic structure of a time-frequency domain, which is a radio resource domain in which data or control channels are transmitted in a 5G system.

In FIG. 1, the horizontal axis denotes a time domain, and the vertical axis denotes a frequency domain. The basic unit of resources in the time and frequency domains is a resource element (RE) 101, which may be defined as one OFDM symbol 102 along the time domain and one subcarrier 103 along the frequency domain. In the frequency domain, N_{SC}^{RB} (for example, 12) contiguous REs may constitute one resource block (RB) 104. In the time domain, one subframe 110 may include a plurality of OFDM symbols 102. For example, the length of one subframe may be 1 ms.

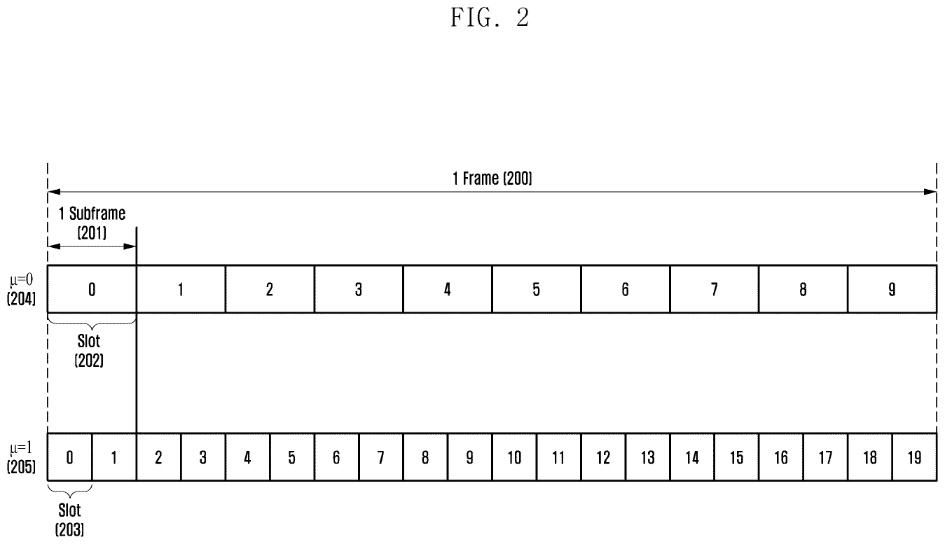

FIG. 2 illustrates a structure of a frame, subframe, and slot in a wireless communication system according to an embodiment of the disclosure.

An example of the structure of a frame 200, a subframe 201, and a slot 202 is illustrated in FIG. 2. One frame 200 may be defined as 10 ms. One subframe 201 may be defined as 1 ms. Therefore, one frame 200 may include a total of ten subframes 201. One slot 202 or 203 may be defined as 14 OFDM symbols (that is, the number of symbols per one slot N_{symb}^{slot}=14). One subframe 201 may be constituted with one slot or a plurality of slots 202 and 203. The number of slots 202 and 203 per one subframe 201 may differ depending on configuration values μ 204 and 205 regarding the subcarrier spacing. The example in FIG. 2 illustrates a case in which the subcarrier spacing configuration value is μ=0 (204), and a case in which μ=1 (205). In the case of μ=0 (204), one subframe 201 may be constituted with one slot 202. In the case of μ=1 (205), one subframe 201 may be constituted with two slots 203. That is, the number of slots per one subframe Nₛₗₒₜ^{subframe,μ} may differ depending on the subcarrier spacing configuration value μ, and the number of slots per one frame Nₛₗₒₜ^{frame,μ} slot may differ accordingly. Nₛₗₒₜ^{subframe,μ} and Nₛₗₒₜ^{frame,μ} may be defined slot according to each subcarrier spacing configuration μ as in [Table 1] below:

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, bandwidth part (BWP) configuration in a 5G communication system will be described in detail with reference to the accompanying drawings.

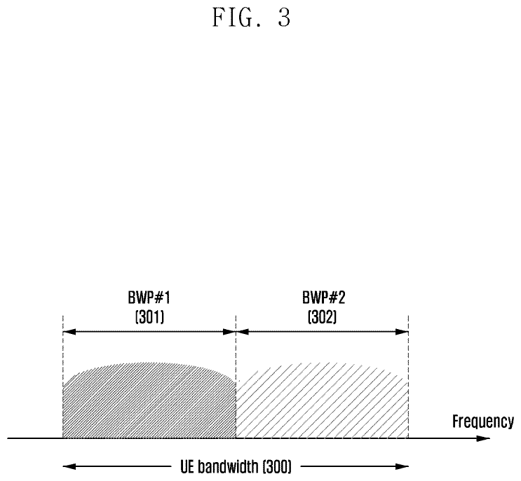

FIG. 3 illustrates an example of bandwidth part configuration in a wireless communication system according to an embodiment of the disclosure.

FIG. 3 illustrates an example in which a UE bandwidth 300 is configured to include two bandwidth parts, that is bandwidth part #1 (BWP #1) 301 and bandwidth part #2 (BWP #2) 302. A base station may configure one or a plurality of bandwidth parts for a UE, and may configure the following information of [Table 2] with regard to each bandwidth part.

TABLE 2

| | |
|---|---|
| BWP ::= | SEQUENCE { |
| bwp-Id | BWP-Id, |

(Bandwidth part identifier)

| | |
|---|---|
| locationAndBandwidth | INTEGER (1..65536), |

(Bandwidth part location)

| | |
|---|---|
| subcarrierSpacing | ENUMERATED {n0, n1, n2, n3, n4, |
| | n5}, |

(Subcarrier spacing)

| | |
|---|---|
| cyclicPrefix | ENUMERATED { extended } |

(Cyclic prefix)
}

It is apparent that the pieces of information configured for the UE is not limited to the above example, and various parameters related to the bandwidth part may be configured for the UE, in addition to the configuration information in Table 2. The above pieces of configuration information may be transferred from the base station to the UE through higher layer signaling, for example, radio resource control (RRC) signaling. Among one or a plurality of bandwidth parts configured for the UE, at least one bandwidth part may be activated. Whether or not to activate the configured bandwidth part may be semi-statically transferred from the base station to the UE through RRC signaling, or dynamically transferred through DCI.

According to some embodiments, the UE, prior to RRC connection, may be configured to an initial BWP for initial access by the base station through a master information block (MIB). To be more specific, the UE may receive configuration information regarding a control resource set (CORESET) and a search space through which a PDCCH for receiving system information (which may correspond to remaining system information (RMSI) or system information block 1 (SIB1)) necessary for initial access through the MIB in the initial access stage may be transmitted. Each of the control resource set and the search space configured by the MIB may be considered as identity (ID) 0. The base station may notify the UE of configuration information, such as frequency allocation information regarding control resource set #0, time allocation information, and numerology, through the MIB. In addition, the base station may notify the UE of configuration information regarding the monitoring cycle and monitoring occasion regarding control resource set #0, that is, configuration information regarding control resource set #0, through the MIB. The UE may consider that a frequency domain configured by control resource set #0 acquired from the MIB is an initial bandwidth part for initial access. In this case, the ID of the initial bandwidth part may be considered as 0.

The bandwidth part-related configuration supported by 5G may be used for various purposes.

According to some embodiments, in the case that the bandwidth supported by the UE is smaller than the system bandwidth, this may be supported through the bandwidth part configuration. For example, the base station may configure the frequency position (configuration information 2) of the bandwidth part for the UE such that the UE can transmit/receive data at a specific frequency position within the system bandwidth.

In addition, according to an embodiment, the base station may configure a plurality of bandwidth parts for the UE for the purpose of supporting different numerologies. For example, in order to support a data transmission/reception using both a subcarrier spacing of 15 kHz and a subcarrier spacing of 30 kHz for the UE, two bandwidth parts may be configured as subcarrier spacings of 15 kHz and 30 kHz, respectively. Different bandwidth parts may be subjected to frequency division multiplexing (FDM), and in the case that data is to be transmitted/received at a specific subcarrier spacing, the bandwidth part configured as the corresponding subcarrier spacing may be activated.

In addition, according to some embodiments, the base station may configure bandwidth parts having different sizes of bandwidths for the UE for the purpose of reducing power consumption of the UE. For example, in the case that the UE supports a substantially large bandwidth, for example, 100 MHz, and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the situation of traffic absence. For the purpose of reducing power consumption of the UE, the base station may configure a bandwidth part of a relatively small bandwidth, for example, a bandwidth part of 20 MHz, for the UE. The UE may perform a monitoring operation in the 20 MHz bandwidth part in the situation of traffic absence, and may transmit/receive data with the 100 MHz bandwidth part as indicated by the base station in the case that data has occurred.

In the method for configuring the above bandwidth part, before being RRC-connected, the UE may receive configuration information regarding the initial bandwidth part through the MIB in the initial access stage. To be more specific, the UE may be configured with a control resource set (i.e., CORESET) for a downlink control channel through which DCI for scheduling a system information block (SIB) from the MIB of a physical broadcast channel (PBCH) may be transmitted. The bandwidth of the control resource set configured by the MIB may be considered as the initial bandwidth part, and the UE may receive, through the configured initial bandwidth part, a physical downlink shared channel (PDSCH) through which a SIB is transmitted. The initial bandwidth part may be used not only for the purpose of receiving the SIB, but also for other system information (OSI), paging, and/or random access.

### [Change of Bandwidth Part (BWP)]

In the case that a UE is configured with one or more bandwidth parts, the base station may indicate to the UE to change (or switch, transition) the bandwidth parts by using a bandwidth part indicator field inside DCI. As an example, in the case that the currently activated bandwidth part of the UE is bandwidth part #1 301 in FIG. 3, the base station may indicate bandwidth part #2 302 with a bandwidth part indicator in the DCI to the UE, and the UE may perform changing of the bandwidth part to bandwidth part #2 302 indicated by the bandwidth part indicator in the received DCI.

As described above, DCI-based bandwidth part changing may be indicated by DCI for scheduling a PDSCH or a PUSCH, and the UE, upon receiving a bandwidth part change request, may be able to receive or transmit the PDSCH or PUSCH scheduled by the corresponding DCI in the changed bandwidth part with no problem. To this end, a requirement regarding the delay (T_{BWP}) required during a bandwidth part change is specified in the specification, and may be defined, for example, as in [Table 3] below.

TABLE 3

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}:
Depends on UE capability.
Note 2:
If the BWP switch involves changing of SCS, the BWP switch delay is determined by the larger one between the SCS before BWP switch and the SCS after BWP switch.

The requirement regarding the bandwidth part change delay supports type 1 or type 2, depending on the capability of the UE. The UE may report the supportable bandwidth part delay type to the base station.

According to the above-described requirement regarding the bandwidth part change delay, in the case that the UE has received DCI including a bandwidth part change indicator in slot n, the UE may complete a change to the new bandwidth part indicated by the bandwidth part change indicator at a timepoint not later than slot n+T_{BWP}, and may transmit/receive a data channel scheduled by the corresponding DCI in the newly changed bandwidth part. In case that the base station intends to schedule a data channel with the new bandwidth part, the base station may determine time domain resource assignment regarding the data channel, in consideration of the UE's bandwidth part change delay T_{BWP}. That is, when scheduling a data channel with the new bandwidth part, the base station may schedule the corresponding data channel after the bandwidth part change delay, in the method for determining time domain resource assignment regarding the data channel. Accordingly, the UE may not expect that the DCI that indicates a bandwidth part change indicates a slot offset value K0 or K2 smaller than the bandwidth part change delay T_{BWP}.

When the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset value K0 or K2, which is indicated by a time domain resource assignment indicator field within the corresponding DCI. For example, when the UE has received DCI indicating a bandwidth part change in slot n, and the slot offset value indicated by the corresponding DCI is K, the UE may perform no transmission or reception from the third symbol of slot n to the symbol before slot n+K (that is, the last symbol of slot n+K−1).

### [Regarding CA/DC]

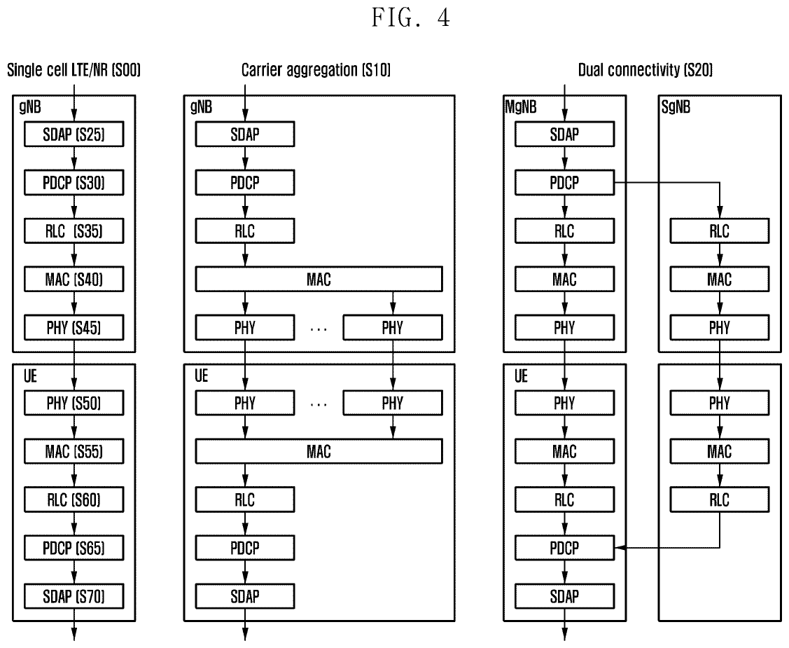

FIG. 4 illustrates radio protocol structures of a base station and a UE in single cell, carrier aggregation, and dual connectivity situations according to an embodiment of the disclosure.

With reference to FIG. 4, a radio protocol of a next-generation wireless communication system includes an NR service data adaptation protocol (SDAP) S25 or S70, an NR packet data convergence protocol (PDCP) S30 or S65, an NR radio link control (RLC) S35 or S60, and an NR medium access control (MAC) S40 or S55 in each of a UE and an NR base station.

The main functions of the NR SDAP S25 or S70 may include some of the following functions:
Transfer function of user data (transfer of user plane data);
Mapping function between a QoS flow and a data bearer for uplink and downlink (mapping between a QoS flow and a DRB for both DL and UL);
Marking function of a QoS flow ID for uplink and downlink (marking QoS flow ID in both DL and UL packets); and
Mapping function of a reflective QOS flow to a data bearer with respect to UL SDAP protocol data units (PDUs) (reflective QoS flow to DRB mapping for the UL SDAP PDUs).

For the SDAP layer entity, whether to use a header of the SDAP layer entity, or whether to use a function of the SDAP layer entity may be configured for the UE through an RRC message for each PDCP layer entity, each bearer, or each logical channel. In the case that an SDAP header is configured, the SDAP layer entity may indicate the UE to update or reconfigure mapping information relating to a QOS flow and data bearer for uplink and downlink through a NAS QOS reflective configuration one-bit indicator (NAS reflective QoS) and an As QOS reflective configuration one-bit indicator (AS reflective QoS) of the SDAP header. The SDAP header may include QoS flow ID information indicating a QoS. The QoS information may be used as data processing priority, scheduling information, etc. for smoothly supporting the services.

The main functions of the NR PDCP S30 or S65 may include some of the following functions:
Header compression and decompression functions (Header compression and decompression: ROHC only);
Transfer function of user data (Transfer of user data);
In-sequence delivery function (In-sequence delivery of higher layer PDUs);
Out-of-sequence delivery function (Out-of-sequence delivery of higher layer PDUs);
Reordering function (PDCP PDU reordering for reception);
Duplicate detection function (Duplicate detection of lower layer SDUs);
Retransmission function (Retransmission of PDCP SDUs);
Ciphering and deciphering functions (Ciphering and deciphering); and
Timer-based SDU discard function (Timer-based SDU discard in uplink).

The above reordering function of the NR PDCP entity may refer to a function of reordering PDCP PDUs received from a lower layer in an order based on PDCP sequence numbers (SNs), and may include a function of delivering data to a higher layer according to a rearranged order. Alternatively, the reordering of the NR PDCP entity may include a function of directly delivering data without considering order, a function of rearranging order to record lost PDCP PDUs, a function of reporting the state of lost PDCP PDUs to a transmission side, and a function of requesting retransmission of lost PDCP PDUs.

The main functions of the NR RLC S35 or S60 may include some of the following functions:
Data transfer function (Transfer of higher layer PDUs);
In-sequence delivery function (In-sequence delivery of higher layer PDUs);
Out-of-sequence delivery function (Out-of-sequence delivery of higher layer PDUs);
ARQ function (Error Correction through ARQ);
Concatenation, segmentation and reassembly functions (Concatenation, segmentation and reassembly of RLC SDUs);
Re-segmentation function (Re-segmentation of RLC data PDUs);
Reordering function (Reordering of RLC data PDUs);
Duplicate detection function (Duplicate detection);
Error detection function (Protocol error detection);
RLC SDU discard function (RLC SDU discard); and
RLC re-establishment function (RLC re-establishment).

The above in-sequence delivery function of the NR RLC entity may refer to a function of delivering RLC SDUs received from a lower layer to a higher layer in sequence. The in-sequence delivery of the NR RLC entity may include a function of, in the case that one original RLC SDU is divided into several RLC SDUs and then the RLC SDUs are received, reassembling the several RLC SDUs and delivering the reassembled RLC SDUs, a function of rearranging received RLC PDUs with reference to RLC sequence numbers (SNs) or PDCP sequence numbers (SNs), a function of rearranging order to record lost RLC PDUs, a function of reporting the state of lost RLC PDUs to a transmission side, and a function of requesting retransmission of lost RLC PDUs. The in-sequence delivery function of the NR RLC entity may include a function of, in the case that there is a lost RLC SDU, sequentially delivering only RLC SDUs before the lost RLC SDU to a higher layer, or a function of, although there is a lost RLC SDU, if a predetermined timer has expired, sequentially delivering, to a higher layer, all the RLC SDUs received before the timer is started. Alternatively, the in-sequence delivery function of the NR RLC entity may include a function to deliver all RLC SDUs received so far in sequence to the higher layer if a predetermined timer has expired, even if there are lost RLC SDUs.

Alternatively, the in-sequence delivery function of the NR RLC entity may process RLC PDUs in a reception order (an order in which the RLC PDUs have arrived, regardless of an order based on sequence numbers) and then deliver the processed RLC PDUs to a PDCP entity regardless of order (out-of-sequence delivery). In the case of segments, the NR RLC entity may receive segments stored in a buffer or to be received in the future, reconfigure the segments to be one whole RLC PDU, then process the RLC PDU, and deliver the processed RLC PDU to a PDCP entity. The NR RLC layer may not include a concatenation function, and the concatenation function may be performed in an NR MAC layer or replaced with a multiplexing function of an NR MAC layer.

The out-of-sequence delivery function of the NR RLC entity may refer to a function of immediately delivering RLC SDUs received from a lower layer, to a higher layer regardless of the order thereof, and may include a function of, in the case that one original RLC SDU is divided into several RLC SDUs and then the RLC SDUs are received, reassembling the several RLC SDUs and delivering the reassembled RLC SDUs, and a function of storing an RLC SN or PDCP SN of received RLC PDUs and arranging order to record lost RLC PDUs.

The NR MAC S40 or S55 may be connected to several NR RLC layer entities configured in a single UE, and the main functions of the NR MAC may include some of the following functions:
Mapping function (Mapping between logical channels and transport channels);
Multiplexing and demultiplexing functions (Multiplexing/demultiplexing of MAC SDUs);
Scheduling information reporting function (Scheduling information reporting);
HARQ function (Error correction through HARQ);
Priority handling function between logical channels (Priority handling between logical channels of one UE);
Priority handling function between UEs (Priority handling between UEs by means of dynamic scheduling);
MBMS service identification function (MBMS service identification);
Transport format selection function (Transport format selection); and
Padding function (Padding).

An NR PHY layer S45 or S50 may perform channel coding and modulation of higher layer data to make the data into OFDM symbols and transmit the OFDM symbols through a wireless channel, or may perform demodulation and channel decoding of OFDM symbols received through a wireless channel, and then deliver the OFDM symbols to a higher layer.

A detailed structure of a radio protocol structure may be variously changed according to a carrier (or cell) operation scheme. For example, in the case where a base station transmits data to a UE, based on a single carrier (or cell), the base station and UE use a protocol structure having a single structure on each layer as shown in S00. On the contrary, in the case that the base station transmits data to the UE, based on carrier aggregation (CA) using multiple carriers at a single TRP, the base station and UE use a protocol structure having a single structure up to RLC, but multiplexing a PHY layer through a MAC layer as shown in S10. As another example, in the case that the base station transmits data to the UE, based on dual connectivity (DC) using multiple carriers at multiple TRPs, the base station and UE use a protocol structure having a single structure up to RLC, but multiplexing a PHY layer through a MAC layer as shown in S20.

### [CSI Resource Configuration]

NR has a channel state information (CSI) framework to indicate the measurement and reporting of CSI from a base station to a UE. The CSI framework of NR may be constituted by at least two elements: a resource setting and a report setting, and the report setting may have a connection relationship with the resource setting by referencing at least one ID of the resource setting.

According to an embodiment of the disclosure, the resource setting may include information related to a reference signal (RS) for the UE to measure channel state information. The base station may configure at least one resource setting for the UE. For example, the base station and the UE may exchange signaling information such as [Table 4] to transfer information about the resource setting.

TABLE 4
-- ASN1START
-- TAG-CSI-RESOURCECONFIG-START

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |

nzp-CSI-RS-ResourceSetList SEQUENCE (SIZE (1..maxNrofNZP-CSI-RS-
ResourceSetsPerConfig)) OF NZP-CSI-RS-ResourceSetId

| | |
|---|---|
| | OPTIONAL, -- Need R |
| csi-SSB-ResourceSetList | SEQUENCE (SIZE (1..maxNrofCSI-SSB-ResourceSetsPerConfig)) |

OF CSI-SSB-ResourceSetId

OPTIONAL -- Need R

},

| | |
|---|---|
| csi-IM-ResourceSetList | SEQUENCE (SIZE (1..maxNrofCSI-IM-ResourceSetsPerConfig)) OF |

CSI-IM-ResourceSetId
},

| | |
|---|---|
| bwp-Id | BWP-Id, |
| resourceType | ENUMERATED { aperiodic, semiPersistent, periodic }, |

...
}
-- TAG-CSI-RESOURCECONFIG-STOP
-- ASN1STOP

In [Table 4], the signaling information CSI-ResourceConfig includes information about each resource setting. According to the signaling information, each resource setting may include a resource setting index (csi-ResourceConfigId) or a BWP index (bwp-ID) or a time-axis transmission configuration of a resource (resourceType) or a resource set list (csi-RS-ResourceSetList) including at least one resource set. The time-axis transmission configuration of the resource may be set to aperiodic transmission or semi-persistent transmission or periodic transmission. The resource set list may be a set including resource sets for channel measurement or a set including resource sets for interference measurement. If the resource set list is a set including resource sets for channel measurement, each of the resource sets may include at least one resource, which may be an index of a CSI reference signal (CSI-RS) resource or a synchronization/broadcast channel block (SS/PBCH block, SSB). If the resource set list is a set including resource sets for interference measurement, each of the resource sets may include at least one interference measurement resource (CSI interference measurement, CSI-IM).

For example, when the resource set includes CSI-RS, the base station and the UE may exchange signaling information such as [Table 5] to transfer information about the resource set.

TABLE 5
-- ASN1START
-- TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-RS-ResourcesPerSet)) OF |

NZP-CSI-RS-ResourceId,

| | | |
|---|---|---|
| repetition | ENUMERATED { on, off } | OPTIONAL, -- Need S |
| aperiodicTriggeringOffset | INTEGER(0..6) | OPTIONAL, -- Need S |
| trs-Info | ENUMERATED {true} | OPTIONAL, -- Need R |

...
}
-- TAG-NZP-CSI-RS-RESOURCESET-STOP
-- ASN1STOP

In [Table 5], the signaling information NZP-CSI-RS-ResourceSet includes information about each resource set. According to the signaling information, each resource set includes at least information about the resource set index (nzp-CSI-ResourceSetId) or the index set of the included CSI-RS (nzp-CSI-RS-Resources), and may include part of information about the spatial domain transmission filter of the included CSI-RS resource (repetition) or whether the included CSI-RS resource is used for tracking (trs-Info).

CSI-RS may be the most representative reference signal included in the resource set. The base station and the UE may exchange signaling information such as [Table 6] to transfer information about the CSI-RS resource.

TABLE 6
-- ASN1START
-- TAG-NZP-CSI-RS-RESOURCE-START

| NZP-CSI-RS-Resource ::= | SEQUENCE { | |
|---|---|---|
| nzp-CSI-RS-ResourceId | NZP-CSI-RS-ResourceId, | |
| resourceMapping | CSI-RS-ResourceMapping, | |
| powerControlOffset | INTEGER (−8..15), | |
| powerControlOffsetSS | ENUMERATED{db−3, db0, db3, db6} | OPTIONAL, -- Need R |
| scramblingID | ScramblingId, | |
| periodicityAndOffset | CSI-ResourcePeriodicityAndOffset | OPTIONAL, -- Cond |

PeriodicOrSemiPersistent

| | | |
|---|---|---|
| qcl-InfoPeriodicCSI-RS | TCI-StateId | OPTIONAL, -- Cond Periodic |

...
}
-- TAG-NZP-CSI-RS-RESOURCE-STOP
-- ASN1STOP

In [Table 6], the signaling information NZP-CSI-RS-Resource includes information about each CSI-RS. The information included in the signaling information NZP-CSI-RS-Resource may have the following meanings:
nzp-CSI-RS-ResourceId: CSI-RS resource index;
resourceMapping: Resource mapping information of CSI-RS resource;
powerControlOffset: Ratio between PDSCH EPRE (Energy Per RE) and CSI-RS EPRE;
powerControlOffsetSS: Ratio between SS/PBCH block EPRE and CSI-RS EPRE;
scramblingID: Scrambling index of CSI-RS sequence;
periodicity AndOffset: Transmission period and slot offset of CSI-RS resource; and
qcl-InfoPeriodicCSI-RS: TCI-state information if the corresponding CSI-RS is a periodic CSI-RS.

The resourceMapping included in the above signaling information NZP-CSI-RS-Resource indicates resource mapping information of the CSI-RS resource, and may include frequency resource resource element (RE) mapping, number of ports, symbol mapping, CDM type, frequency resource density, and frequency band mapping information. The number of ports, frequency resource density, CDM type, and time-frequency axis RE mapping that may be configured through the resourceMapping may have a value defined in one of the rows in [Table 7] below.

TABLE 7

| | | | | | CDM | | |
|---|---|---|---|---|---|---|---|
| | Ports | Density | cdm- | | group | | |
| Row | X | ρ | Type | (k̅, l̅) | index j | k′ | l′ |
| 1 | 1 | 3 | No | (k₀, l₀), (k₀ + 4, l₀), (k₀ + 8, l₀) | 0, 0, 0 | 0 | 0 |
| | | | CDM | | | | |
| 2 | 1 | 1, 0.5 | No | (k₀, l₀) | 0 | 0 | 0 |
| | | | CDM | | | | |
| 3 | 2 | 1, 0.5 | FD- | (k₀, l₀) | 0 | 0, 1 | 0 |
| | | | CDM2 | | | | |
| 4 | 4 | 1 | FD- | (k₀, l₀), (k₀ + 2, l₀) | 0, 1 | 0, 1 | 0 |
| | | | CDM2 | | | | |
| 5 | 4 | 1 | FD- | (k₀, l₀), (k₀, l₀ + 1) | 0, 1 | 0, 1 | 0 |
| | | | CDM2 | | | | |
| 6 | 8 | 1 | FD- | (k₀, l₀), (k₁, l₀), (k₂, l₀), (k₃, l₀) | 0, 1, 2, 3 | 0, 1 | 0 |
| | | | CDM2 | | | | |
| 7 | 8 | 1 | FD- | (k₀, l₀), (k₁, l₀), (k₀, l₀ + 1), | 0, 1, 2, 3 | 0, 1 | 0 |
| | | | CDM2 | (k₁, l₀ + 1) | | | |
| 8 | 8 | 1 | CDM4 | (k₀, l₀), (k₁, l₀) | 0, 1 | 0, 1 | 0, 1 |
| | | | (FD2, TD2) | | | | |
| 9 | 12 | 1 | FD- | (k₀, l₀), (k₁, l₀), (k₂, l₀), | 0, 1, 2, 3, | 0, 1 | 0 |
| | | | CDM2 | (k₃, l₀), (k₄, l₀), (k₅, l₀) | 4, 5 | | |
| 10 | 12 | 1 | CDM4 | (k₀, l₀), (k₁, l₀), (k₂, l₀) | 0, 1, 2 | 0, 1 | 0, 1 |
| | | | (FD2, TD2) | | | | |
| 11 | 16 | 1, 0.5 | FD- | (k₀, l₀), (k₁, l₀), (k₂, l₀), (k₃, l₀), | 0, 1, 2, 3, | 0, 1 | 0 |
| | | | CDM2 | (k₀, l₀ + 1), (k₁, l₀ + 1), (k₂, l₀ + 1), | 4, 5, 6, 7 | | |
| | | | | (k₃, l₀ + 1) | | | |
| 12 | 16 | 1, 0.5 | CDM4 | (k₀, l₀), (k₁, l₀), (k₂, l₀), (k₃, l₀) | 0, 1, 2, 3 | 0, 1 | 0, 1, |
| | | | (FD2, TD2) | | | | |
| 13 | 24 | 1, 0.5 | FD- | (k₀, l₀), (k₁, l₀), (k₂, l₀), (k₀, l₀ + 1), | 0, 1, 2, 3, | 0, 1 | 0 |
| | | | CDM2 | (k₁, l₀ + 1), (k₂, l₀ [symbol] (k₀, l₁), (k₁, l₁), | 4, 5, 6, 7, | | |
| | | | | (k₂, l₁), (k₀, l₁ + 1), (k₁, l₁ + 1), (k₂, l₁ + [symbol] | 8, 9, 10, 11 | | |
| 14 | 24 | 1, 0.5 | CDM4 | (k₀, l₀), (k₁, l₀), (k₂, l₀), (k₀, l₁), | 0, 1, 2, 3, | 0, 1 | 0, 1 |
| | | | (FD2, TD2) | (k₁, l₁), (k₂, l₁) | 4, 5 | | |
| 15 | 24 | 1, 0.5 | CDM8 | (k₀, l₀), (k₁, l₀), (k₂, l₀) | 0, 1, 2 | 0, 1 | 0, 1, |
| | | | (FD2, TD4) | | | | 2, 3 |
| 16 | 32 | 1, 0.5 | FD- | (k₀, l₀), (k₁, l₀), (k₂, l₀), (k₃, l₀), | 0, 1, 2, 3, | 0, 1 | 0, 1, |
| | | | CDM2 | (k₀, l₀ + 1), (k₁, l₀ + 1), (k₂, l₀ + 1), | 4, 5, 6, 7, | | |
| | | | | (k₃, l₀ + 1), (k₀, l₁), (k₁, l₁), (k₂, l₁), | 8, 9, 10, 11, | | |
| | | | | (k₃, l₁), (k₀, l₁ + 1), (k₁, l₁ + 1), | 12, 13, 14, 15 | | |
| | | | | (k₂, l₁ + 1), (k₃, l₁ + 1) | | | |
| 17 | 32 | 1, 0.5 | CDM4 | (k₀, l₀), (k₁, l₀), (k₂, l₀), (k₃, l₀), (k₀, l₁), | 0, 1, 2, 3, 4, 5, | 0, 1 | 0, 1 |
| | | | (FD2, TD2) | (k₁, l₁), (k₂, [symbol] | 6, 7 | | |
| 18 | 32 | 1, 0.5 | CDM8 | (k₀, l₀), (k₁, l₀), (k₂, l₀), (k₃, l₀) | 0, 1, 2, 3 | 0, 1 | 0, 1, |
| | | | (FD2, TD4) | | | | 2, 3 |

[symbol]

indicates data missing or illegible when filed

[Table 7] shows the frequency resource density, the CDM type, the frequency-axis and time-axis start positions (k̅,l̅) of the CSI-RS component RE pattern, the number of frequency-axis REs (k′) and the number of time-axis REs (l′) of the CSI-RS component RE pattern that may be configured according to the number of CSI-RS ports (X). The aforementioned CSI-RS component RE pattern may be a basic unit that constitutes a CSI-RS resource. Through Y=1+max(k′) REs on the frequency axis and Z=1+max(l′) REs on the time axis, the CSI-RS component RE pattern can be constituted by YZ REs. When the number of CSI-RS ports is 1 port, the CSI-RS RE position may be specified without limitation of subcarriers in a physical resource block (PRB), and the CSI-RS RE position may be specified by a 12-bit bitmap. When the number of CSI-RS ports is {2, 4, 8, 12, 16, 24, 32} ports and Y=2, CSI-RS RE position may be specified for every two subcarriers in a PRB, and the CSI-RS RE position may be specified by a 6-bit bitmap. When the number of CSI-RS ports is 4 ports and Y=4, CSI-RS RE position may be specified for every four subcarriers in a PRB, and the CSI-RS RE position may be specified by a 3-bit bitmap. Similarly, time-axis RE positions may be specified by a bitmap of a total of 14 bits.

### [CSI Report Configuration]

According to an embodiment of the disclosure, a report setting may have a connection relationship with a resource setting by referencing at least one ID of the resource setting, and the resource setting(s) having a connection relationship with the report setting provide configuration information including information on a reference signal for measuring channel information. When the resource setting(s) having a connection relationship with the report setting are used for measuring channel information, the measured channel information may be used for reporting channel information according to a reporting method configured in the report setting having the connection relationship.

According to an embodiment of the disclosure, the report setting may include configuration information related to a CSI reporting method. For example, a base station and a UE may exchange signaling information such as [Table 8] in order to transfer information about the report setting.

TABLE 8
-- ASN1START
-- TAG-CSI-REPORTCONFIG-START

| CSI-ReportConfig ::= | SEQUENCE { | |
|---|---|---|
| reportConfigId | CSI-ReportConfigId, | |
| carrier | ServCellIndex | OPTIONAL, -- Need S |
| resourcesForChannelMeasurement | | CSI-ResourceConfigId, |
| csi-IM-ResourcesForInterference | CSI-ResourceConfigId | OPTIONAL, -- Need R |
| nzp-CSI-RS-ResourcesForInterference | CSI-ResourceConfigId | OPTIONAL, -- Need R |

| | |
|---|---|
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUSCH | SEQUENCE { |
| reportSlotConfig | ENUMERATED {sl5, sl10, sl20, sl40, sl80, sl160, sl320}, |
| reportSlotOffsetList | SEQUENCE (SIZE (1..maxNrofUL-Allocations)) OF |
| INTEGER(0..32), | |
| p0alpha | P0-PUSCH-AlphaSetId |

},

| | |
|---|---|
| aperiodic | SEQUENCE { |
| reportSlotOffsetList | SEQUENCE (SIZE (1..maxNrofUL-Allocations)) OF |

```
INTEGER(0..32)
    }
  },
```

| reportQuantity | CHOICE { | |
|---|---|---|
| none | NULL, | |
| cri-RI-PMI-CQI | NULL, | |
| cri-RI-i1 | NULL, | |
| cri-RI-i1-CQI | SEQUENCE { | |
| pdsch-BundleSizeForCSI | ENUMERATED {n2, n4} | OPTIONAL -- Need |

S
},

| | |
|---|---|
| cri-RI-CQI | NULL, |
| cri-RSRP | NULL, |
| ssb-Index-RSRP | NULL, |
| cri-RI-LI-PMI-CQI | NULL |

},

| | |
|---|---|
| reportFreqConfiguration | SEQUENCE { |
| cqi-FormatIndicator | ENUMERATED { widebandCQI, subbandCQI } |

OPTIONAL, -- Need R

| | |
|---|---|
| pmi-FormatIndicator | ENUMERATED { widebandPMI, subbandPMI } |

OPTIONAL, -- Need R

| | |
|---|---|
| csi-ReportingBand | CHOICE { |
| subbands3 | BIT STRING(SIZE(3)), |
| subbands4 | BIT STRING(SIZE(4)), |
| subbands5 | BIT STRING(SIZE(5)), |
| subbands6 | BIT STRING(SIZE(6)), |
| subbands7 | BIT STRING(SIZE(7)), |
| subbands8 | BIT STRING(SIZE(8)), |
| subbands9 | BIT STRING(SIZE(9)), |
| subbands10 | BIT STRING(SIZE(10)), |
| subbands11 | BIT STRING(SIZE(11)), |
| subbands12 | BIT STRING(SIZE(12)), |
| subbands13 | BIT STRING(SIZE(13)), |
| subbands14 | BIT STRING(SIZE(14)), |
| subbands15 | BIT STRING(SIZE(15)), |
| subbands16 | BIT STRING(SIZE(16)), |
| subbands17 | BIT STRING(SIZE(17)), |
| subbands18 | BIT STRING(SIZE(18)), |

...

| | |
|---|---|
| subbands19-v1530 | BIT STRING(SIZE(19)) |

} OPTIONAL -- Need S

| } | OPTIONAL, -- Need R | |
|---|---|---|
| timeRestrictionForChannelMeasurements | ENUMERATED {configured, notConfigured}, | |
| timeRestrictionForInterferenceMeasurements | ENUMERATED {configured, notConfigured}, | |
| codebookConfig | CodebookConfig | OPTIONAL, -- Need R |
| dummy | ENUMERATED {n1, n2} | OPTIONAL, -- Need R |
| groupBasedBeamReporting | CHOICE { | |
| enabled | NULL, | |
| disabled | SEQUENCE { | |
| nrofReportedRS | ENUMERATED {n1, n2, n3, n4} | OPTIONAL -- Need S |

```
    }
  },
```

| | | |
|---|---|---|
| cqi-Table | ENUMERATED {table1, table2, table3, spare1} | OPTIONAL, -- |

Need R

| | |
|---|---|
| subbandSize | ENUMERATED {value1, value2}, |
| non-PMI-PortIndication | SEQUENCE (SIZE (1..maxNrofNZP-CSI-RS-ResourcesPerConfig)) |
| OF PortIndexFor8Ranks | OPTIONAL, -- Need R |

```
  ...,
  [[
```

| | |
|---|---|
| semiPersistentOnPUSCH-v1530 | SEQUENCE { |
| reportSlotConfig-v1530 | ENUMERATED {sl4, sl8, sl16} |
| } | OPTIONAL -- Need R |

]]
}

In [Table 8], the signaling information CSI-ReportConfig includes information about each report setting. The information included in the signaling information CSI-ReportConfig may have the following meanings:
reportConfigId: report setting index;
carrier: serving cell index;
resourcesForChannelMeasurement: resource setting index for channel measurement that has a connection relationship with report setting;
csi-IM-ResourcesForInterference: resource setting index that has CSI-IM resources for interference measurement that has a connection relationship with report setting;
nzp-CSI-RS-ResourcesForInterference: resource setting index that has CSI-RS resources for interference measurement that has a connection relationship with report setting;
reportConfigType: Indicates the time-axis transmission configuration and transmission channel of channel report, and may have aperiodic transmission or semi-persistent Physical Uplink Control Channel (PUCCH) transmission or semi-periodic PUSCH transmission or periodic transmission configuration;
reportQuantity: Indicates the type of the reported channel information, and may have the types of channel information when channel report is transmitted (“cri-RI-PMI-CQI,” “cri-RI-i1,” “cri-RI-i1-CQI,” “cri-RI-CQI,” “cri-RSRP,” “ssb-Index-RSRP,” “cri-RI-LI-PMI-CQI”) and when no channel report is transmitted (“none”). Here, the elements included in the types of channel information mean Channel Quality Indicator (CQI), Precoding Matric Indicator (PMI), CSI-RS Resource Indicator (CRI), SS/PBCH block Resource Indicator (SSBRI), Layer Indicator (LI), Rank Indicator (RI), and/or L1-Reference Signal Received Power (RSRP);
reportFreqConfiguration: Indicates whether the reported channel information includes only information about the entire band (wideband) or information about each subband, and may have configuration information about the subband that includes the channel information when the configuration includes information about each subband;
timeRestrictionForChannelMeasurements: Whether the reference signal for channel measurement is time-axis constrained among the reference signals referenced by the channel information being reported;
timeRestrictionForInterferenceMeasurements: Whether the reference signal for interference measurement is time-axis constrained among the reference signals referenced by the channel information being reported;
codebookConfig: Codebook information referenced by the channel information being reported;
groupBasedBeamReporting: Whether to group beams for channel reporting;
cqi-Table: CQI table index referenced by the channel information being reported;
subbandSize: Index indicating the subband size of the channel information; and
non-PMI-PortIndication: Port mapping information referenced when reporting non-PMI channel information.

When the base station indicates channel information reporting through higher layer signaling or L1 signaling, the UE may perform channel information reporting by referring to the above-mentioned configuration information included in the indicated report setting.

The base station may indicate the UE to report channel state information (CSI) through higher layer signaling including radio resource control (RRC) signaling or medium access control (MAC) control element (CE) signaling, or L1 signaling (e.g., common DCI, group-common DCI, UE-specific DCI).

For example, the base station may indicate the UE to perform an aperiodic channel information report (CSI report), through higher layer signaling or DCI using DCI format 0_1. The base station configures parameters for the aperiodic CSI report by the UE, or multiple CSI report trigger states including parameters for the CSI report, through higher layer signaling. The parameters for the CSI report or the CSI report trigger states may include a slot interval or a set including possible slot intervals between a PDCCH including the DCI and a PUSCH including the CSI report, a reference signal ID for channel state measurement, a type of channel information included, etc. When the base station indicates some of the multiple CSI report trigger states to the UE through the DCI, the UE reports channel information according to the CSI report configuration of the report settings configured in the indicated CSI report trigger states. The channel information report may be performed through a PUSCH scheduled with DCI format 0_1. The time axis resource allocation of the PUSCH including the CSI report by the UE may be done through slot interval with PDCCH indicated through DCI, start symbol and symbol length indication within a slot for time axis resource allocation of PUSCH, etc. For example, it is possible that the position of the slot in which the PUSCH including the CSI report by the UE is transmitted is indicated through slot interval with PDCCH indicated through DCI, and the start symbol and symbol length within the slot is indicated through the time domain resource assignment field of the DCI described above.

For example, a base station may indicate a UE to perform a semi-persistent CSI report transmitted on a PUSCH, through DCI using DCI format 0_1. The base station may activate or deactivate the semi-persistent CSI report transmitted on the PUSCH, through DCI scrambled with SP-CSI-RNTI. If the semi-persistent CSI report is activated, the UE may periodically report channel information according to a configured slot interval. If the semi-persistent CSI report is deactivated, the UE may stop the activated periodic channel information reporting. The base station configures parameters for the semi-persistent CSI report by the UE or multiple CSI report trigger states including parameters for the semi-persistent CSI report through higher layer signaling. Parameters for a CSI report, or a CSI report trigger state, may include a slot interval or a set including possible slot intervals between a PDCCH including DCI indicating a CSI report and a PUSCH including the CSI report, a slot interval between a slot in which higher layer signaling indicating a CSI report is activated and a PUSCH including the CSI report, a slot interval period of the CSI report, a type of channel information included, etc.

When a base station activates some of multiple CSI report trigger states or some of multiple report settings to a UE through higher layer signaling or DCI, the UE may report channel information according to a CSI report configuration configured in the report setting included in the indicated CSI report trigger state or configured in the activated report setting. The channel information report may be performed through a PUSCH semi-persistently scheduled with DCI format 0_1 scrambled with SP-CSI-RNTI. The time axis resource allocation of the PUSCH including the CSI report by the UE may be done through the slot interval period of the CSI report, the slot interval with respect to the slot in which higher layer signaling is activated, the slot interval with respect to the PDCCH indicated through DCI, the start symbol and symbol length indication within the slot for the time axis resource allocation of the PUSCH, etc. For example, the position of the slot in which the PUSCH including the CSI report by the UE is transmitted may be indicated through the slot interval with respect to the PDCCH indicated through DCI, and the start symbol and symbol length within the slot may be indicated through the time domain resource assignment field of the DCI format 0_1 described above.

For example, a base station may indicate a UE to perform a semi-persistent CSI report transmitted on a PUCCH, through higher layer signaling such as MAC-CE. Through the MAC-CE signaling, the base station may activate or deactivate the semi-persistent CSI report transmitted on the PUCCH. When the semi-persistent CSI report is activated, the UE may periodically report channel information according to a configured slot interval. When the semi-persistent CSI report is deactivated, the UE may stop the activated periodic channel information reporting. The base station configures parameters for the semi-persistent CSI report by the UE through higher layer signaling. The parameters for the CSI report may include a PUCCH resource through which the CSI report is transmitted, a slot interval period of the CSI report, the type of channel information included, etc. The UE may transmit the CSI report through a PUCCH. Alternatively, in the case that the PUCCH for the CSI report overlaps with a PUSCH, the CSI report may be transmitted on the PUSCH. It is possible that the position of the PUCCH transmission slot including the CSI report is indicated through the slot interval period of the CSI report configured through higher layer signaling, the slot interval between the slot in which the higher layer signaling is activated and the PUCCH including the CSI report, and the start symbol and symbol length within the slot is indicated through the start symbol and symbol length to which the PUCCH resource configured through higher layer signaling is allocated.

For example, a base station may indicate a UE to perform a periodic CSI report, through higher layer signaling. The base station may activate or deactivate the periodic CSI report through higher layer signaling including RRC signaling. When the periodic CSI report is activated, the UE may periodically report channel information according to a configured slot interval. When the periodic CSI report is deactivated, the UE may stop the activated periodic channel information reporting. The base station configures a report setting including parameters for the periodic CSI report by the UE through higher layer signaling. The parameters for the CSI report may include PUCCH resource configuration for the CSI report, a slot interval between a slot in which higher layer signaling indicating the CSI report is activated and a PUCCH including the CSI report, a slot interval period of the CSI report, a reference signal ID for channel state measurement, a type of the channel information included, etc. The UE may transmit the CSI report through the PUCCH.

Alternatively, in the case that the PUCCH for the CSI report overlaps with a PUSCH, the CSI report may be transmitted on the PUSCH. It is possible that the position of the slot in which the PUCCH including the CSI report is transmitted is indicated through the slot interval period of the CSI report configured through higher layer signaling, the slot interval between the slot in which the higher layer signaling is activated and the PUCCH including the CSI report, and the start symbol and the symbol length within the slot is indicated through the start symbol and the symbol length to which the PUCCH resource configured through higher layer signaling is allocated.

For the aforementioned CSI report setting (CSI-ReportConfig), each report setting CSI-ReportConfig may be associated with one downlink (DL) bandwidth part identified by the higher layer parameter bandwidth part identifier (bwp-id) given by the CSI resource setting, CSI-ResourceConfig, associated with the corresponding report setting. For the time domain reporting operation for each report setting CSI-ReportConfig, “aperiodic,” “semi-persistent,” and “periodic” schemes are supported, and these may be configured by the base station to the UE through the parameter reportConfigType configured from the higher layer. The semi-persistent CSI reporting method supports “PUCCH-based semi-persistent (semi-PersistentOnPUCCH)” and “PUSCH-based semi-persistent (semi-PersistentOnPUSCH).” In the case of periodic or semi-permanent CSI reporting methods, the UE may be configured with PUCCH or PUSCH resources to transmit CSI from the base station through higher layer signaling. The periodicity and slot offset of the PUCCH or PUSCH resources to transmit CSI may be given by the numerology of the uplink (UL) bandwidth part where the CSI report is configured to be transmitted. In the case of aperiodic CSI reporting methods, the UE may be scheduled with PUSCH resources to transmit CSI from the base station through LI signaling (the aforementioned DCI format 0_1).

For the aforementioned CSI resource setting (CSI-ResourceConfig), each CSI resource setting CSI-ReportConfig may include S (≥1) CSI resource sets (given by the higher layer parameter csi-RS-ResourceSetList). The CSI resource set list may be constituted by a non-zero power (NZP) CSI-RS resource set and a SS/PBCH block set, or may be constitute by a CSI-interference measurement (CSI-IM) resource set. Each CSI resource setting may be located in a downlink (DL) bandwidth part identified by the higher layer parameter bwp-id, and the CSI resource setting may be connected to a CSI report setting of the same downlink bandwidth part. The time domain operation of the CSI-RS resource in the CSI resource setting may be configured as one of “aperiodic,” “periodic,” or “semi-persistent” from the higher layer parameter resourceType. For periodic or semi-persistent CSI resource setting, the number of CSI-RS resource sets may be limited to S=1, and the configured period and slot offset may be given as a numerology of a downlink bandwidth part identified by bwp-id. The UE may be configured with one or more CSI resource settings for channel or interference measurement from the base station through higher layer signaling, which may include, for example, the following CSI resources:
CSI-IM resources for interference measurements;
NZP CSI-RS resource for interference measurements; and
NZP CSI-RS resource for channel measurements.

For CSI-RS resource sets associated with resource settings where the higher layer parameter resourceType is set to “aperiodic,” “periodic,” or “semi-persistent,” the trigger state for CSI report settings where reportType is set to “aperiodic” and the resource settings for channel or interference measurements for one or more component cells (CCs) may be configured by the higher layer parameter CSI-AperiodicTriggerStateList.

Aperiodic CSI reporting by a UE may utilize PUSCH, periodic CSI reporting may utilize PUCCH, and semi-persistent CSI reporting may be performed using PUSCH when triggered or activated by DCI, and PUCCH after being activated by MAC control element (MAC CE). As described above, CSI resource settings may also be configured as aperiodic, periodic, or semi-persistent. Combinations between CSI report settings and CSI resource settings may be supported based on [Table 9] below.

TABLE 9
Table 5.2.1.4-1: Triggering/Activation of CSI Reporting for the possible CSI-RS Configurations.

| CSI-RS | Periodic CSI | | Aperiodic CSI |
|---|---|---|---|
| Configuration | Reporting | Semi-Persistent CSI Reporting | Reporting |
| Periodic CSI- | No dynamic | For reporting on PUCCH, the UE | Triggered by DCI; |
| RS | triggering/activation | receives an activation command [10, | Additionally, activation |
| | | TS 38.321]; for reporting on | command [10, TS |
| | | PUSCH, the UE receives triggering | 38.321] possible as |
| | | on DCI | defined in Subclause |
| | | | 5.2.1.5.1. |
| Semi-Persistent | Not Supported | For reporting on PUCCH, the UE | Triggered by DCI; |
| CSI-RS | | receives an activation command [10, | Additionally, activation |
| | | TS 38.321]; for reporting on | command [10, TS |
| | | PUSCH, the UE receives triggering | 38.321] possible as |
| | | on DCI | defined in Subclause |
| | | | 5.2.1.5.1. |
| Aperiodic CSI- | Not Supported | Not Supported | Triggered by DCI; |
| RS | | | Additionally, activation |
| | | | command [10, TS |
| | | | 38.321] possible as |
| | | | defined in Subclause |
| | | | 5.2.1.5.1. |

Aperiodic CSI reporting may be triggered by the “CSI request” field of the aforementioned DCI format 0_1 corresponding to the scheduling DCI for PUSCH. The UE may monitor the PDCCH, obtain the DCI format 0_1, and may obtain scheduling information for PUSCH and CSI request indicator. The CSI request indicator may be set to NTS (=0, 1, 2, 3, 4, 5, or 6) bits and may be determined by higher layer signaling (reportTriggerSize). One trigger state among one or multiple aperiodic CSI report trigger states that may be configured by higher layer signaling (CSI-AperiodicTriggerStateList) may be triggered by the CSI request indicator.
When all bits in the CSI request field are 0, this may mean that no CSI reporting is requested.
When the number of CSI trigger states (M) in the configured CSI-AperiodicTriggerStateList is greater than 2NTs−1, then according to the predefined mapping relationship, the M CSI trigger states may be mapped to 2NTs−1, and one of the 2NTs−1 trigger states may be indicated by the CSI request field.
When the number of CSI trigger states (M) in the configured CSI-AperiodicTriggerStateList is less than or equal to 2NTs−1, one of the M CSI trigger states may be indicated by the CSI request field.

The following [Table 10] shows an example of the relationship between a CSI request indicator and a CSI trigger state that may be indicated by the corresponding indicator.

TABLE 10

| CSI request | | CSI- | CSI- |
|---|---|---|---|
| field | CSI trigger state | ReportConfigId | ResourceConfigId |
| 00 | no CSI request | N/A | N/A |
| 01 | CSI trigger state#1 | CSI report#1 | CSI resource#1, |
| | | CSI report#2 | CSI resource#2 |
| 10 | CSI trigger state#2 | CSI report#3 | CSI resource#3 |
| 11 | CSI trigger state#3 | CSI report#4 | CSI resource#4 |

A UE may perform measurement on a CSI resource within a CSI trigger state triggered by a CSI request field, and generate CSI (including at least one of the aforementioned CQI, PMI, CRI, SSBRI, LI, RI, or L1-RSRP, etc.) therefrom. The UE may transmit the acquired CSI using a PUSCH scheduled by the corresponding DCI format 0_1. When one bit corresponding to an uplink data indicator (UL-SCH indicator) in the DCI format 0_1 indicates “1,” uplink data (UL-SCH) and the acquired CSI may be multiplexed and transmitted on a PUSCH resource scheduled by the DCI format 0_1. When one bit corresponding to the uplink data indicator (UL-SCH indicator) in DCI format 0_1 indicates “0,” only CSI may be mapped and transmitted without uplink data (UL-SCH) on the PUSCH resource scheduled by DCI format 0_1.

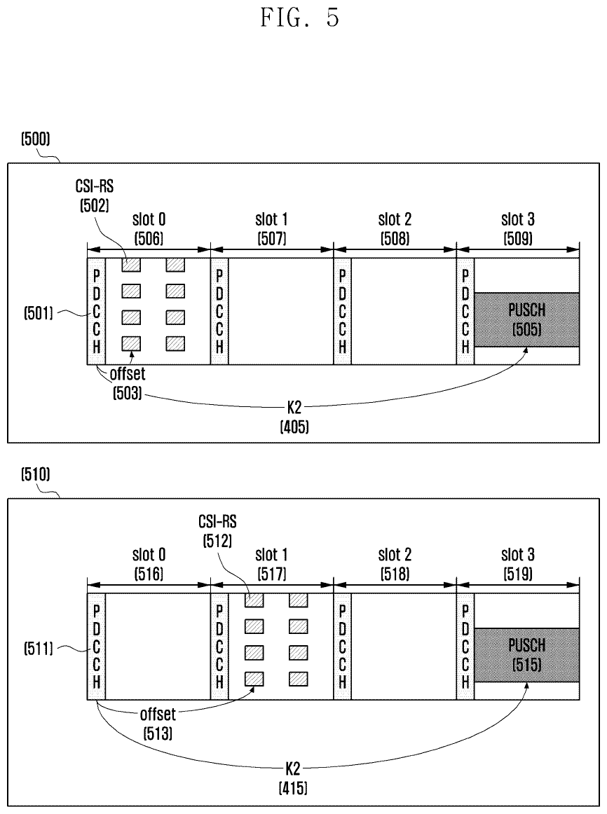

FIG. 5 illustrates an example of an aperiodic CSI reporting method.

In an example 500 of FIG. 5, a UE may monitor the PDCCH 501 to acquire DCI format 0_1, and may acquire scheduling information for the PUSCH 505 and CSI request information therefrom. The UE may acquire resource information for the CSI-RS 502 to be measured from the received CSI request indicator. The UE may determine at which time point the UE may perform measurement on the transmitted CSI-RS 502 resource, based on the time point at which the DCI format 0_1 is received and the parameter (aperiodicTriggeringOffset described above) for offset in the CSI resource set configuration (e.g., NZP CSI-RS resource set configuration (NZP-CSI-RS-ResourceSet)). More specifically, the UE may be configured with an offset value X of the parameter aperiodicTriggeringOffset in the NZP-CSI-RS resource set configuration from the base station through higher layer signaling, and the configured offset value X may mean an offset between a slot in which a DCI triggering aperiodic CSI reporting is received and a slot in which the CSI-RS resource is transmitted. For example, the value of the parameter aperiodicTriggeringOffset and the offset value X may have the mapping relationship described in [Table 11] below.

TABLE 11

| aperiodicTriggeringOffset | Offset X | |
|---|---|---|
| 0 | 0 | slot |
| 1 | 1 | slot |
| 2 | 2 | slots |
| 3 | 3 | slots |
| 4 | 4 | slots |
| 5 | 16 | slots |
| 6 | 24 | slots |

An example 500 of FIG. 5 shows an example in which the aforementioned offset value is set to X=0. In this case, the UE may receive a CSI-RS 502 in a slot (corresponding to slot 0 506 of FIG. 5) in which DCI format 0_1 triggering aperiodic CSI reporting is received, and may report the measured CSI information with the received CSI-RS to the base station through PUSCH 505. The UE may acquire scheduling information (information corresponding to each field of the aforementioned DCI format 0_1) for the PUSCH 505 for CSI reporting from the DCI format 0_1. As an example, the UE may acquire information on a slot in which the PUSCH 505 is to be transmitted from the aforementioned time domain resource assignment information for the PUSCH 505 from the DCI format 0_1. In an example 500 of FIG. 5, the UE acquires the value K2 corresponding to the slot offset value for PDCCH-to-PUSCH as 3, and accordingly, PUSCH 505 may be transmitted in slot 3 509, which is 3 slots away from slot 0 506, at a timepoint when PDCCH 501 is received.

In an example 510 of FIG. 5, the UE may monitor the PDCCH 511 to acquire DCI format 0_1, and may acquire scheduling information for the PUSCH 515 and CSI request information therefrom. The UE may acquire resource information for the CSI-RS 512 to be measured from the received CSI request indicator. An example 510 of FIG. 5 shows an example in which the offset value for the aforementioned CSI-RS is set to X=1. In this case, the UE may receive the CSI-RS 512 in a slot in which the DCI format 0_1 that triggers the aperiodic CSI report is received (corresponding to slot 0 516 of FIG. 5), and may report the measured CSI information with the received CSI-RS to the base station through the PUSCH 515.

An aperiodic CSI report may include at least one or both of CSI part 1 and CSI part 2, and when the aperiodic CSI report is transmitted through a PUSCH, the CSI report may be multiplexed with a transport block. For multiplexing, a CRC is inserted into the input bits of the aperiodic CSI, and then encoded and rate matched, and then mapped to a resource element in the PUSCH in a specific pattern and transmitted. The above CRC insertion may be omitted depending on the coding method or the length of the input bits. The number of modulation symbols calculated for rate matching when multiplexing CSI Part 1 or CSI part 2 included in the aperiodic CSI report may be calculated as shown in [Table 12] below.

```
TABLE 12
For CSI part 1 transmission on PUSCH not using repetition type B with UL-SCH, the number of
coded modulation symbols per layer for CSI part 1 transmission, denoted as Q_{CSI-part1}′, is
determined as follows:
${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , nominal}^{PUSCH} - 1} {M}_{sc}^{UCI} ( l )}{{\sum }_{r = 0}^{{C}_{UL - SCH - 1}} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{\frac{ACK}{CG} - UCI}^{′} \}$
. . .
For CSI part 1 transmission on an actual repetition of a PUSCH with repetition Type B with UL-
SCH, the number of coded modulation symbols per layer for CSI part 1 transmission, denoted as
Q_{CSI-part1}′, is determined as follows:
${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH - 1}} {K}_{r}} ⌉ , ⌈ α \cdot {\sum }_{l = 0}^{{N}_{symb , nominal}^{PUSCH} - 1} {M}_{sc , nominal}^{UCI} ( l ) ⌉ - {Q}_{\frac{ACK}{CG} - UCI}^{′} , {\sum }_{l = 0}^{{N}_{symb , nominal}^{PUSCH} - 1} {M}_{sc , nominal}^{UCI} ( l ) - {Q}_{\frac{ACK}{CG} - UCI}^{′} \}$
. . .
For CSI part 1 transmission on PUSCH without UL-SCH, the number of coded modulation
symbols per layer for CSI part 1 transmission, denoted as Q_{CSI-part1}′, is determined as follows:
if there is CSI part 2 to be transmitted on the PUSCH,
    ${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{\frac{ACK}{CG} - UCI}^{′} \}$
else
      ${Q}_{CSI - 1}^{′} = {\sum }_{l = 0}^{{N}_{symb , all}^{PUSCH} - 1} {M}_{sc}^{UCI} ( l ) - {Q}_{ACK}^{′}$
end if
. . .
For CSI part 2 transmission on PUSCH not using repetition type B with UL-SCH, the number of
coded modulation symbols per layer for CSI part 2 transmission, denoted as Q_{CSI-part2}′, is
determined as follows:
${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH - 1}} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{\frac{ACK}{CG} - UCI}^{′} - {Q}_{CSI - 1}^{′}$
For CSI part 2 transmission on an actual repetition of a PUSCH with repetition Type B with UL-
SCH, the number of coded modulation symbols per layer for CSI part 2 transmission, denoted as
Q_{CSI-part2}′, is determined as follows:
${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH - 1}} {K}_{r}} ⌉ , ⌈ α \cdot {\sum }_{l = 0}^{{N}_{symb , nominal}^{PUSCH} - 1} {M}_{sc , nominal}^{UCI} ( l ) ⌉ - {Q}_{\frac{ACK}{CG} - UCI}^{′} - {Q}_{CSI - 1}^{′} , {\sum }_{l = 0}^{{N}_{symb , actual}^{PUSCH} - 1} {M}_{sc , actual}^{UCI} ( l ) - {Q}_{\frac{ACK}{CG} - UCI}^{′} - {Q}_{CSI - 1}^{′} \}$
. . .
For CSI part 2 transmission on PUSCH without UL-SCH, the number of coded modulation
symbols per layer for CSI part 2 transmission, denoted as Q_{CSI-part2}′, is determined as follows:
    ${Q}_{CSI - 2}^{′} = {\sum }_{l = 0}^{{N}_{symb , all}^{PUSCH} - 1} {M}_{sc}^{UCI} ( l ) - {Q}_{ACK}^{′} - {Q}_{CSI - 1}^{′}$
```

In particular, in the case of PUSCH repetition transmission schemes A and B, the UE may transmit the aperiodic CSI report by multiplexing the CSI only on the first repetition transmission among the PUSCH repetition transmissions. This is because the aperiodic CSI report information to be multiplexed is encoded in a polar code scheme, and in order to be multiplexed on multiple PUSCH repetitions, each PUSCH repetition should have the same frequency and time resource allocation. In particular, in the case of PUSCH repetition type B, each actual repetition may have a different OFDM symbol length, and therefore the aperiodic CSI report may be multiplexed and transmitted only on the first PUSCH repetition.

In addition, for PUSCH repetition transmission scheme B, when a UE schedules aperiodic CSI reporting without scheduling for a transport block or receives a DCI activating semi-persistent CSI reporting, the value of the nominal repetition may be assumed to be 1 even if the number of PUSCH repetition transmissions configured by higher layer signaling is greater than 1. In addition, when the UE schedules or activates aperiodic or semi-persistent CSI reporting without scheduling for a transport block based on PUSCH repetition transmission scheme B, the UE may expect that the first nominal repetition will be the same as the first actual repetition. For a PUSCH transmitted including semi-persistent CSI based on PUSCH repetition transmission scheme B without scheduling for a DCI after semi-persistent CSI reporting is activated by the DCI, if the first nominal repetition is different from the first actual repetition, the transmission for the first nominal repetition may be ignored.

### [CSI Computation Time]

When a base station indicates an aperiodic CSI report or a semi-persistent CSI report to a UE through DCI, the UE may determine whether a valid channel report can be performed through the indicated CSI report based on a channel computation time required for the CSI report (CSI computation time). For the aperiodic CSI report or the semi-persistent CSI report indicated through DCI, the UE may perform the valid CSI report from an uplink symbol after Z symbols from the end of the last symbol included in the PDCCH including DCI indicating the CSI report, and the aforementioned Z symbols may vary depending on numerology of a downlink bandwidth part corresponding to the PDCCH including DCI indicating the CSI report, numerology of an uplink bandwidth part corresponding to the PUSCH transmitting the CSI report, and a type or a characteristic of channel information reported in the CSI report (report quantity, frequency band granularity, the number of ports of reference signals, a codebook type, and the like). In other words, in order for a CSI report to be determined to be a valid CSI report (in order for the corresponding CSI report to be a valid CSI report), uplink transmission of the corresponding CSI report may not be performed earlier than a symbol Zref, including timing advance.

In this case, the symbol Zref is an uplink symbol starting a cyclic prefix (CP) after a time T_{proc,CSI}=(Z) (2048+144)·κ2^{-μ}·T_{C} from the moment the last symbol of the above triggering PDCCH ends. Here, the detailed value of Z is as described below, and

$${T}_{c} = \frac{1}{Δ {f}_{max} \cdot {N}_{f}} {f}_{max} = 480 \cdot {10}^{3} Hz = 4096 , κ = 64 ,$$

and μ is numerology. In this case u may be appointed to use a value that causes the largest T_{proc,CSI} value among (μ_{PDCCH}, μ_{CSI-RS}, μ_{UL}), μ_{PDCCH} may denote subcarrier spacing used for the PDCCH transmission, μ_{CSI-RS} may denote subcarrier spacing used for CSI-RS transmission, and μ_{UL} may denote subcarrier spacing of the uplink channel used for Uplink control information (UCI) transmission for CSI reporting. As another example, u may be appointed to use a value that causes the largest T_{proc,CSI} value among (μ_{PDCCH}, μ_{UL}). The definitions of μ_{PDCCH} and μ_{UL} refer to the above description. For convenience of later description, satisfying the above conditions is referred to as satisfying CSI reporting validity condition 1.

In addition, when the reference signal for channel measurement for the aperiodic CSI report indicated to the UE through DCI is an aperiodic reference signal, the UE may perform the valid CSI report from an uplink symbol after Z′ symbols from the end of the last symbol including the reference signal, and the aforementioned Z′ symbols may vary depending on numerology of a downlink bandwidth part corresponding to the PDCCH including DCI indicating the CSI report, numerology of a bandwidth part corresponding to a reference signal for channel measurement for the CSI report, numerology of an uplink bandwidth part corresponding to the PUSCH transmitting the CSI report, and a type or a characteristic of channel information reported in the CSI report (report quantity, frequency band granularity, the number of ports of reference signals, codebook type, and the like). In other words, in order for a CSI report to be determined to be a valid CSI report (in order for the CSI report to be a valid CSI report), uplink transmission of the corresponding CSI report may not be performed earlier than a symbol Zref′, including timing advance.

In this case, the Zref′ is an uplink symbol starting a cyclic prefix (CP) after a time T_{proc,CSI}′=(Z′)(2048+144)·κ2^{-μ}·T_{C} from the moment the last symbol of the aperiodic CSI-RS or aperiodic CSI-IM triggered by the triggering PDCCH ends. A detailed value of Z′ follows the description below, and

$${T}_{c} = \frac{1}{Δ {f}_{max} \cdot {N}_{f}} {f}_{max} = 480 \cdot {10}^{3} Hz = 4096 , κ = 64 ,$$

and μ is numerology. In this case μ may be appointed to use a value that causes the largest T_{proc,CSI} value among (μ_{PDCCH}, μ_{CSI-RS}, μ_{UL}), μ_{PDCCH} may denote subcarrier spacing used for triggering PDCCH transmission, μ_{CSI-RS} may denote subcarrier spacing used for CSI-RS transmission, and μ_{UL} may denote subcarrier spacing of the uplink channel used for Uplink control information (UCI) transmission for CSI reporting. As another example, μ may be appointed to use a value that causes the largest T_{proc,CSI} value among (μ_{PDCCH}, μ_{UL}). In this case, the definitions of μ_{PDCCH} and μ_{UL} refer to the above description. For the convenience of later description, satisfying the above condition is referred to as satisfying the CSI reporting validity condition 2.

When the base station indicates the aperiodic CSI report for the aperiodic reference signal to the UE through DCI, the UE may perform the valid CSI report from a first uplink symbol satisfying both a time point after Z symbols after the end of the last symbol included in the PDCCH including DCI indicating the CSI report and a time point after Z′ symbols after the end of the last symbol including the reference signal. That is, only when CSI reporting validity conditions 1 and 2 are both satisfied, the aperiodic CSI reporting based on the aperiodic reference signal may be determined as the valid CSI report.

When the CSI report time point indicated by the base station does not satisfy a CSI computation time requirement, the UE may determine that the corresponding CSI report is not valid and may not consider an update of the channel information state for the CSI report.

The aforementioned Z and Z′ symbols for calculating the CSI computation time follow [Table 13] and [Table 14] below. For example, when channel information reported in the CSI report includes only wideband information, the number of ports of the reference signal is equal to or less than 4, the number of reference signal resources is 1, and the codebook type is “typeI-SinglePanel” or the type of the reported channel information (report quantity) is “cri-RI-CQI,” the Z and Z′ symbols follow the values Z₁, Z₁ in [Table 14]. Hereafter, this will be named as delay requirement 2. In addition, when the PUSCH including the CSI report does not include TB or HARQ-ACK and the CPU occupation of the UE is 0, the Z, Z′ symbols follow the values Z₁, Z₁′ in [Table 13] and this will be named as delay requirement 1. The CPU occupation mentioned above is described in detail below. In addition, when the report quantity is “cri-RSRP” or “ssb-Index-RSRP,” the Z, Z′ symbols follow the values Z₃, Z₃′ in [Table 14]. X1, X2, X3, X4 in [Table 14] represent the UE capability for the beam reporting time, and KB1, KB2 in [Table 14] represent the UE capability for the beam change time. When the symbols do not correspond to the type or characteristic of the channel information reported in the aforementioned CSI report, the Z, Z′ symbols follow the values Z₂, Z₂′ in [Table 14].

TABLE 13

Z₁ [symbols]

| μ | Z₁ | Z′₁ |
|---|---|---|
| 0 | 10 | 8 |
| 1 | 13 | 11 |
| 2 | 25 | 21 |
| 3 | 43 | 36 |

TABLE 14

| | Z₁ [symbols] | | Z₂ [symbols] | | Z₃[symbols] | |
|---|---|---|---|---|---|---|
| μ | Z₁ | Z₁^{′} | Z₂ | Z₂^{′} | Z₃ | Z₃^{′} |
| 0 | 22 | 16 | 40 | 37 | 22 | X₁ |
| 1 | 33 | 30 | 72 | 69 | 33 | X₂ |
| 2 | 44 | 42 | 141 | 140 | min(44, X₃ + KB₁) | X₃ |
| 3 | 97 | 85 | 152 | 140 | min(97, X₄ + KB₂) | X₄ |

### [CSI Reference Resource]

When a base station indicates a UE to perform an aperiodic/semi-persistent/periodic CSI report, the base station may configure a CSI reference resource to determine a reference time and frequency for a channel to be reported in the CSI report. The frequency of the CSI reference resource may be information on a carrier and subband to measure CSI, which are indicated in the CSI report configuration, and these may correspond to the carrier and reportFreqConfiguration in CSI-ReportConfig, which are higher layer signaling, respectively. The time of the CSI reference resource may be defined based on the time at which the CSI report is transmitted.

For example, when indicating to transmit CSI report #X in the uplink slot n′ of the carrier and BWP where the CSI report is to be transmitted, the time of the CSI reference resource of the CSI report #X may be defined as the downlink slot n-nCSI-ref of the carrier and BWP where the CSI is measured. The downlink slot n is calculated as n=└n′·2^{μ}^{_{DL}}/2^{μ}^{_{UL}}┘ where the numerology of the carrier and BWP measuring CSI is named as μDL, and the numerology of the carrier and BWP transmitting CSI report #X is named as μUL. When the CSI report #X transmitted in the uplink slot n′ is a semi-persistent or periodic CSI report, nCSI-ref, that is the slot interval between the downlink slot n and the CSI reference signal, follows n_{CSI-ref}=4·2^{μ}^{_{DL}} in the case where a single CSI-RS/SSB resource is connected to the corresponding CSI report according to the number of CSI-RS/SSB resources for channel measurement, and follows n_{CSI-ref}=5·2^{μ}^{_{DL}} in the case where multiple CSI-RS/SSB resources are connected to the corresponding CSI report. When the CSI report #X transmitted in the uplink slot n′ is an aperiodic CSI report, the CSI report is calculated as n_{CSI-ref}=5·2^{μ}^{_{DL}} considering the CSI computation time Z′ for channel measurement. The aforementioned N_{symb}^{slot} is the number of symbols included in one slot, and in NR, N_{symb}^{slot}=14 is assumed.

When a base station indicates a UE to transmit a CSI report in uplink slot n′ through higher layer signaling or DCI, the UE may report CSI by performing channel measurement or interference measurement on a CSI-RS resource, CSI-IM resource, or SSB resource that is transmitted no later than the CSI reference resource slot of the CSI report transmitted in uplink slot n′ among the CSI-RS resources, CSI-IM, or SSB resources associated with the corresponding CSI report. The CSI-RS resource, CSI-IM resource, or SSB resource associated with the above-mentioned corresponding CSI report may denote a CSI-RS resource, CSI-IM resource, or SSB resource included in a resource set configured in a resource setting referenced by a report setting for a CSI report of a UE configured through higher layer signaling, or a CSI-RS resource, CSI-IM resource, or SSB resource referenced by a CSI report trigger state including parameters for the corresponding CSI report, or a CSI-RS resource, CSI-IM resource, or SSB resource indicated by an ID of a reference signal (RS) set.

In the embodiments of the disclosure, a CSI-RS/CSI-IM/SSB occasion denotes a transmission time point of CSI-RS/CSI-IM/SSB resource(s) determined by a higher layer configuration or a combination of the higher layer configuration and DCI triggering. For example, for a semi-persistent or periodic CSI-RS resource, a slot to be transmitted is determined according to a slot periodicity and slot offset configured by higher layer signaling, and the transmission symbol(s) within the slot are determined according to resource mapping information (resourceMapping). As another example, for an aperiodic CSI-RS resource, a slot to be transmitted is determined according to a slot offset from a PDCCH including a DCI indicating channel reporting configured by higher layer signaling, and the transmission symbol(s) within the slot are determined according to resourceMapping information.

The above-mentioned CSI-RS occasion may be determined by independently considering the transmission time point of each CSI-RS resource or by comprehensively considering the transmission timepoint of one or more CSI-RS resource(s) included in the resource set, and accordingly, the following two interpretations are possible for the CSI-RS occasion according to each resource set configuration.
Interpretation 1-1: from a start time point of the earliest symbol to an end time point of the latest symbol in which a specific resource among one or more CSI-RS resources included in the resource set(s) configured in the resource setting referenced by the report setting configured for the CSI report is transmitted.
Interpretation 1-2: from a start time point of the earliest symbol in which CSI-RS resources transmitted at the earliest time point are transmitted to an end time point of the latest symbol in which CSI-RS resources transmitted at the latest time point are transmitted among all CSI-RS resources included in resource set(s) configured in the resource setting referenced by the report setting configured for the CSI report.

In the embodiments of the disclosure below, it is possible to consider both interpretations of the CSI-RS occasion and apply them separately. In addition, it is possible to consider both interpretations of the CSI-IM occasion and the SSB occasion like the CSI-RS occasion, while since the principle is similar to the description above, the redundant description will be omitted below.

In the embodiments of the disclosure, a “CSI-RS/CSI-IM/SSB occasion for CSI report #X transmitted in uplink slot n” denotes a set of CSI-RS occasions, CSI-IM occasions, and SSB occasions that are not later than the CSI reference resource of CSI report #X transmitted in uplink slot n′ among CSI-RS occasions, CSI-IM occasions, and SSB occasions of the CSI-RS resources, CSI-IM resources, and SSB resources included in a resource set configured in a resource setting referenced by a report setting configured for CSI report #X.

In the embodiments of the disclosure, “the latest CSI-RS/CSI-IM/SSB occasion among the CSI-RS/CSI-IM/SSB occasions for CSI report #X transmitted in uplink slot n” can be interpreted in the following two ways.
Interpretation 2-1: A set of occasions including the latest CSI-RS occasion among the CSI-RS occasions for CSI report #X transmitted in uplink slot n′, the latest CSI-IM occasion among the CSI-RS occasions for CSI report #X transmitted in uplink slot n′, and the latest SSB occasion among the SSB occasions for CSI report #0 transmitted in uplink slot n′.
Interpretation 2-2: The latest occasion among all CSI-RS occasions, CSI-IM occasions, and SSB occasions for CSI report #X transmitted in uplink slot n′.

In the embodiments of the disclosure below, it is possible to individually apply the two interpretations of the “latest CSI-RS/CSI-IM/SSB occasion among the CSI-RS/CSI-IM/SSB occasions for CSI report #X transmitted in uplink slot n′” by considering them together. In addition, considering the above-mentioned two interpretations (Interpretation 1-1, Interpretation 1-2) for the CSI-RS occasion, CSI-IM occasion, and SSB occasion, in the embodiments of the disclosure, it is possible to apply the “latest CSI-RS/CSI-IM/SSB occasion among the CSI-RS/CSI-IM/SSB occasions for CSI report #X transmitted in uplink slot n′” individually by considering all of four different interpretations (applying Interpretation 1-1 and Interpretation 2-1, applying Interpretation 1-1 and Interpretation 2-2, applying Interpretation 1-2 and Interpretation 2-1, and applying Interpretation 1-2 and Interpretation 2-2).

The base station may instruct the CSI report by considering the amount of channel information that may be simultaneously calculated by the UE for the CSI report, i.e., the number of channel information computation units (CSI processing units, CPUs) of the UE. When the number of channel information computation units that may be simultaneously calculated by the UE is N_{CPU}, the UE may not expect a CSI report instruction from the base station that requires more channel information computation than N_{CPU}, or may not consider an update of channel information that requires more channel information computation than N_{CPU}. N_{CPU} may be reported by the UE to the base station through higher layer signaling, or may be configured by the base station through higher layer signaling.

Assume that the CSI report instructed by the base station to the UE occupies part or all of the CPU for channel information computation among the total number N_{CPU} pieces of channel information that may be simultaneously calculated by the UE. For each CSI report, for example, when the number of channel information computation units required for the CSI report n (n=0, 1, . . . , N−1) is O_{CPU}⁽ⁿ⁾, the number of channel information computation units required for a total of N CSI reports may be Σₙ₌₀^{N-1}O_{CPU}⁽ⁿ⁾. The channel information computation units required for each reportQuantity configured in the CSI report may be configured as shown in the following [Table 15].

TABLE 15

| | |
|---|---|
| - | O_{CPU}⁽ⁿ⁾ = 0: when the reportQuantity configured in the CSI report is set to “none” and trs-Info is |
| | configured in the CSI-RS resource set associated with the CSI report. |
| - | O_{CPU}⁽ⁿ⁾ = 1: when the reportQuantity configured in the CSI report is set to “none,” “cri-RSRP,” or |
| | “ssb-Index-RSRP,” and trs-Info is not configured in the CSI-RS resource set associated with the |
| | CSI report. |
| - | When the reportQuantity configured in the CSI report is set to “cri-RI-PMI-CQI,” “cri-RI-il,” |
| | “cri-RI-i1-CQI,” “cri-RI-CQI,” or “cri-RI-LI-PMI-CQI” |
| >> | O_{CPU}⁽ⁿ⁾ = N_{CPU}: when an aperiodic CSI report is triggered and the corresponding CSI report is |
| | not multiplexed with one or both of TB/HARQ-ACK. The corresponding CSI report is |
| | wideband CSI, corresponds to up to 4 CSI-RS ports, corresponds to a single resource |
| | without a CRI report, and has codebookType of “typeI-SinglePanel” or reportQuantity of |
| | “cri-RI-CQI” |
| | (this case corresponds to the delay requirement 1 described above, and can be regarded as a |
| | case where the UE quickly calculates CSI by using all available CPUs and reports the |
| | same). |
| >> | O_{CPU}⁽ⁿ⁾ = Ks: all other cases except the above. Kₛ denotes the number of CSI-RS resources in the |
| | CSI-RS resource set for channel measurement. |

When the number of channel information computations required by a UE for multiple CSI reports at a specific time point is greater than the number N_{CPU} of channel information computation units that may be simultaneously calculated by the UE, the UE may not consider an update of channel information for some CSI reports. Among the multiple indicated CSI reports, the CSI reports for which the update of channel information is not considered are determined at least by considering a time during which the channel information computation required for the CSI report occupies the CPU and the priority of the channel information to be reported. For example, the update of channel information for a CSI report for which the time during which channel information computation required for the CSI report occupies the CPU starts at the latest time point may not be considered, and it is possible to preferentially not consider updating channel information for a CSI report whose channel information priority is low.

The priority of the above channel information may be determined by referring to [Table 16] below.

TABLE 16
CSI priority value Pri_{iCSI}?(y, k, c, s) = 2 · N_{cells} · Mₛ · y + N_{cells} · Mₛ · k + Mₛ · c + s,

| | |
|---|---|
| - | y = 0 for an aperiodic CSI report transmitted through PUSCH, y = 1 for a semi-persistent |
| | CSI report transmitted through PUSCH,y = 2 for a semi-persistent CSI report transmitted |
| | through PUCCH, y = 3 for a periodic CSI report transmitted through PUCCH; |
| - | k = 0 when the CSI report includes L1-RSRP; k = 1when the CSI report does not include |
| | L1-RSRP; |
| - | c: serving cell index , N_{cells}: maximum number of serving cells configured through higher |
| | layer signaling (maxNrofServingCells) ; |
| - | s: CSI report configuration index (reportConfigID), Mₛ: maximum number of CSI report |
| | configurations configured through higher layer signaling (maxNrofCSI- |
| | ReportConfigurations) . |

The CSI priority for a CSI report is determined through the priority value PriiCSI (y, k, c, s) in [Table 16]. Referring to [Table 16], the CSI priority value is determined through a type of channel information included in the CSI report, a time axis reporting characteristics of the CSI report (aperiodic, semi-persistent, periodic), the channel through which the CSI report is transmitted (PUSCH, PUCCH), the serving cell index, and the CSI report configuration index. The CSI priority for a CSI report is determined by comparing the priority values PriiCSI (y, k, c, s) and determining that the CSI priority for the CSI report with a smaller priority value is higher.

When a time during which the channel information computation required for the CSI report indicated by the base station to the UE occupies the CPU is referred to as CPU occupation time, the CPU occupation time is determined by considering the type of channel information included in the CSI report (report quantity), the time axis characteristics of the CSI report (aperiodic, semi-persistent, periodic), the slot or symbol occupied by the higher layer signaling or DCI indicating the CSI report, and part or all of the slot or symbol occupied by a reference signal for channel status measurement.

### [PDCCH: DCI Related]

Next, downlink control information (DCI) in a 5G system will be described in detail.

In a 5G system, scheduling information on uplink data (or physical uplink data channel (physical uplink shared channel, PUSCH)) or downlink data (or physical downlink data channel (physical downlink shared channel, PDSCH)) is transferred from a base station to a UE through DCI. The UE may monitor a fallback DCI format and a non-fallback DCI format for a PUSCH or PDSCH. The fallback DCI format may be constituted with a fixed field pre-defined between the base station and the UE, and the non-fallback DCI format may include a configurable field.

DCI may undergo a channel coding and modulation process, and then be transmitted through a physical downlink control channel (PDCCH) that is a physical downlink control channel. A cyclic redundancy check (CRC) may be attached to a DCI message payload, and the CRC may be scrambled by a radio network temporary identifier (RNTI) corresponding to the identity of the UE. Different RNTIs may be used according to the purpose of a DCI message, for example, UE-specific data transmission, a power control command, a random access response, or the like. That is, an RNTI is not explicitly transmitted, and is transmitted after being included in a CRC calculation process. If the UE receives a DCI message transmitted on a PDCCH, the UE may identify a CRC by using an assigned RNTI, and if a CRC identification result is correct, the UE may identify that the corresponding message has been transmitted to the UE.

For example, DCI scheduling a PDSCH for system information (SI) may be scrambled by a SI-RNTI. DCI scheduling a PDSCH for a random access response (RAR) message may be scrambled by an RA-RNTI. DCI scheduling a PDSCH for a paging message may be scrambled by a P-RNTI. DCI notifying of a slot format indicator (SFI) may be scrambled by an SFI-RNTI. DCI notifying of a transmit power control (TPC) may be scrambled by a TPC-RNTI. DCI scheduling a UE-specific PDSCH or PUSCH may be scrambled by a cell RNTI (C-RNTI).

DCI format 0_0 may be used as fallback DCI scheduling a PUSCH, and in this case, a CRC may be scrambled by a C-RNTI. DCI format 0_0 having a CRC scrambled by a C-RNTI may include, for example, the pieces of information in [Table 17] below.

```
TABLE 4
  Identifier for DCI formats (DCI format identifier) - [1] bit
  Frequency domain resource assignment (frequency domain resource assignment)
$[ ⌈ {log}_{2} ( \frac{{N}_{RB}^{UL , BWP} ( {N}_{RB}^{UL , BWP} + 1 )}{2} ) ⌉ s$
  Time domain resource assignment (Time domain resource assignment) - X bits
  Frequency hopping flag (Frequency hopping flag) - 1 bit.
  Modulation and coding scheme (Modulation and coding scheme) - 5 bits
  New data indicator (New data indicator) - 1 bit
  Redundancy version (Redundancy version) - 2 bits
  HARQ process number (HARQ process number) - 4 bits
  TPC command for scheduled PUSCH (Transmit power control (TPC) command for
scheduled PUSCH - [2] bits
  UL/SUL indicator (Uplink (UL)/supplementary UL (SUL) indicator) -
0 or 1 bit
```

DCI format 0_1 may be used as non-fallback DCI scheduling a PUSCH, and in this case, a CRC may be scrambled by a C-RNTI. DCI format 0_1 having a CRC scrambled by a C-RNTI may include, for example, the pieces of information shown in [Table 18] below.

```
TABLE 5
  Carrier indicator (Carrier indicator) - 0 or 3 bits
  UL/SUL indicator - 0 or 1 bit
  Identifier for DCI formats - [1] bits
  Bandwidth part indicator (Bandwidth part indicator) - 0, 1 or 2 bits
  Frequency domain resource assignment
    For resource allocation type 0(For resource allocation type 0),
    $⌈ \frac{{N}_{RB}^{UL , BWP}}{P} ⌉ bits$
    For resourceallocation type 1(For resource allocation type 1),
    $⌈ {log}_{2} ( \frac{{N}_{RB}^{UL , BWP} ( {N}_{RB}^{UL , BWP} + 1 )}{2} ) ⌉$
  Time domain resource assignment −1, 2, 3, or 4 bits
  VRB-to-PRB mapping (virtual resource block-to-physical resource block mapping) - 0 or 1
bit, only for resource allocation type 1.
    0 bit if only resource allocation type 0 is configured;
    1 bit otherwise.
  Frequency hopping flag - 0 or 1 bit, only for resource allocation type 1.
    0 bit if only resource allocation type 0 is configured;
    1 bit otherwise.
  Modulation and coding scheme - 5 bits
  New data indicator - 1 bit
  Redundancy version - 2 bits
  HARQ process number - 4 bits
  1st downlink assignment index (1st downlink assignment index)- 1 or 2 bits
    1 bit for semi-static HARQ-ACK codebook (for semi-static HARQ-ACK
    codebook);
    2 bits for dynamic HARQ-ACK codebook with single HARQ-ACK codebook (for
    dynamic HARQ-ACK codebook with single HARQ-ACK codebook).
  2nd downlink assignment index (2nd downlink assignment index) - 0 or 2 bits
    2 bits for dynamic HARQ-ACK codebook with two HARQ-ACK sub-codebooks
    (for dynamic HARQ-ACK codebook with two HARQ-ACK sub-codebooks);
    0 bit otherwise.
  TPC command for scheduled PUSCH - 2 bits
  SRS resource indicator (S [symbol] [symbol]     resource indicator) - ┌ [symbol]   log [symbol]  _2(Σ_(k =
1)\hat{ }(L_(maxΣ)) [symbol]  (▪(N_“SRS” @k))(┤)) [symbol] [symbol]     g [symbol]  _2(N_“SRS”) ┐ bits
    $⌈ {log}_{2} ( {\sum }_{k = 1}^{{L}_{max \sum }} ( \begin{matrix}{N}_{SRS} \\ k\end{matrix} ) ( ) ) ⌉$
    n-codebook based PUSCH transmission (for non-codebook based PUSCH transmission);
    ┌log₂(N_{SRS})┐ for codebook based PUSCH transmission (for codebook based
    PUSCH transmission).
  Precoding information and number of layers (Precoding information and number of layers)-
up to 6 bits
  Antenna ports (Antenna ports)- up to 5 bits
  SRS request (SRS request)- 2 bits
  CSI request (Channel state information request) - 0, 1, 2, 3, 4, 5, or 6 bits
  CBG transmission information (code block group transmission information)- 0, 2, 4, 6, or 8
bits
  PTRS-DMRS association (Phase tracking reference signal-demodulation reference signal
relationship)- 0 or 2 bits.
  beta_offset indicator (beta_offset indicator)- 0 or 2 bits
  DMRS sequence initialization (Demodulation reference signal sequence initialization)- 0 or
1 bit
```

DCI format 1_0 may be used as fallback DCI scheduling a PDSCH, and in this case, a CRC may be scrambled by a C-RNTI. DCI format 1_0 having a CRC scrambled by a C-RNTI may include, for example, the pieces of information shown in [Table 19] below.

```
TABLE 6
  Identifier for DCI formats - [1] bit
  Frequency domain resource assignment
  $- [ ⌈ {log}_{2} ( \frac{{N}_{RB}^{UL , BWP} ( {N}_{RB}^{UL , BWP} + 1 )}{2} ) ⌉ s$
  Time domain resource assignment - X bits
  VRB-to-PRB mapping - 1 bit.
  Modulation and coding scheme - 5 bits
  New data indicator - 1 bit
  Redundancy version - 2 bits
  HARQ process number - 4 bits
  Downlink assignment index - 2 bits
  TPC command for scheduled PUCCH - [2] bits
  PUCCH resource indicator (PUCCH (physical uplink control channel) resource indicator-
3 bits
  PDSCH-to-HARQ feedback timing indicator (PDSCH-to-HARQ feedback timing
indicator)- [3] bits
```

DCI format 1_1 may be used as non-fallback DCI scheduling a PDSCH, and in this case, a CRC may be scrambled by a C-RNTI. DCI format 1_1 having a CRC scrambled by a C-RNTI may include, for example, the pieces of information shown in [Table 20] below.

```
TABLE 207
  Carrier indicator - 0 or 3 bits
  Identifier for DCI formats - [1] bits
  Bandwidth part indicator - 0, 1 or 2 bits
  Frequency domain resource assignment
    For resource allocation type 0, NRB
    $⌈ \frac{{N}_{RB}^{DL , BWP}}{P} ⌉ bits$
    For resource allocation type 1,
    $⌈ {log}_{2} ( \frac{{N}_{RB}^{UL , BWP} ( {N}_{RB}^{UL , BWP} + 1 )}{2} ) ⌉$
  Time domain resource assignment -1, 2, 3, or 4 bits
  VRB-to-PRB mapping - 0 or 1 bit, only for resource allocation type 1.
    0 bit if only resource allocation type 0 is configured;
    1 bit otherwise.
  PRB bundling size indicator (PRB bundling size indicator) - 0 or 1 bit
  Rate matching indicator (Rate matching indicator) - 0, 1, or 2 bits
  ZP CSI-RS trigger (ZP CSI-RS trigger) - 0, 1, or 2 bits
For transport block 1 (For transport block 1):
  Modulation and coding scheme - 5 bits
  New data indicator - 1 bit
  Redundancy version - 2 bits
For transport block 2(For transport block 2):
  Modulation and coding scheme - 5 bits
  New data indicator - 1 bit
  Redundancy version - 2 bits
  HARQ process number - 4 bits
  Downlink assignment index - 0 or 2 or 4 bits
  TPC command for scheduled PUCCH - 2 bits
  PUCCH resource indicator - 3 bits
  PDSCH-to-HARQ_feedback timing indicator - 3 bits
  Antenna ports - 4, 5 or 6 bits
  Transmission configuration indication (Transmission configuration indication)- 0 or 3 bits
  SRS request - 2 bits
  CBG transmission information - 0, 2, 4, 6, or 8 bits
  CBG flushing out information (Code block group flushing out information) - 0 or 1 bit
  DMRS sequence initialization - 1 bit
```

### [PDCCH: CORESET, REG, CCE, Search Space]

Below, the downlink control channel in a 5G communication system will be described in more detail with reference to the drawings.

FIG. 5 illustrates an example of an aperiodic CSI reporting method. (a35)

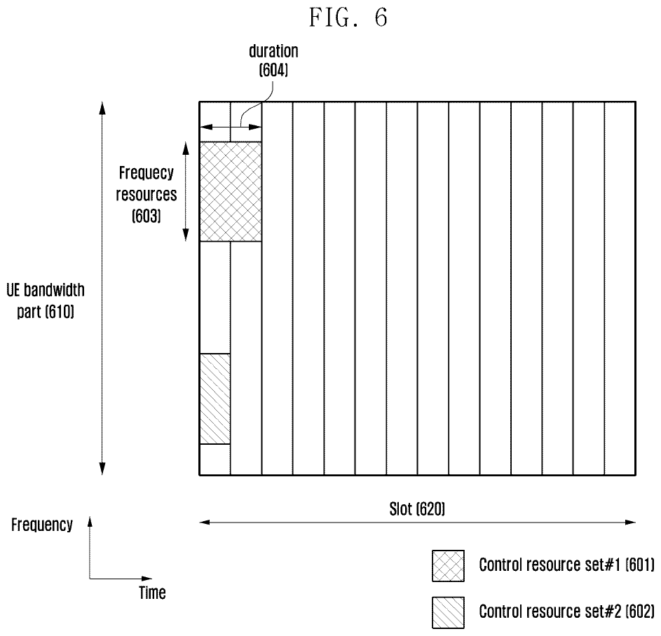

FIG. 6 illustrates an example of a control resource set (CORESET) in which a downlink control channel is transmitted in a 5G wireless communication system. FIG. 5 illustrates an example of an aperiodic CSI reporting method. (a35)

FIG. 6 illustrates an example in which two control resource sets (control resource set #1 601, control resource set #2 602) are configured within a UE bandwidth part 610 on the frequency axis and within one slot 520 on the time axis. The control resource sets 601, 602 may be configured to specific frequency resources 603 within the entire UE bandwidth part 610 on the frequency axis. They may be configured to one or plurality of OFDM symbols on the time axis, and this can be defined as the control resource set length (Control resource set duration, 604). FIG. 5 illustrates an example of an aperiodic CSI reporting method. (a35)

Referring to the example illustrated in FIG. 6, control resource set #1 601 is configured to have a control resource set length of 2 symbols, and control resource set #2 (602) is configured to have a control resource set length of 1 symbol.

The control resource set in the aforementioned 5G may be configured by a base station to a UE through higher layer signaling (e.g., system information, Master Information Block (MIB), radio resource control (RRC) signaling). Configuring a control resource set to a UE means providing information such as the control resource set identifier (Identity), the frequency position of the control resource set, the symbol length of the control resource set, and the like. For example, the information in [Table 21] below may be included.

TABLE 21

| | |
|---|---|
| ControlResourceSet ::= | SEQUENCE { |

-- Corresponds to L1 parameter “CORESET-ID”

| | |
|---|---|
| controlResourceSetId | ControlResourceSetId, |

(Control resource set Identifier (Identity))

| | |
|---|---|
| frequencyDomainResources | BIT STRING (SIZE (45)), |

(Frequency Axis Resource Allocation Information)

| | |
|---|---|
| duration | INTEGER (1..maxCoReSetDuration), |

(Time Axis Resource Allocation Information)

| | |
|---|---|
| cce-REG-MappingType | CHOICE { |

(CCE-to-REG Mapping Scheme)

| | |
|---|---|
| interleaved | SEQUENCE { |
| reg-BundleSize | ENUMERATED {n2, n3, n6}, |

(REG Bundle Size)

| | |
|---|---|
| precoderGranularity | ENUMERATED { same AsREG-bundle, |

allContiguousRBs},

| | |
|---|---|
| interleaverSize | ENUMERATED {n2, n3, n6} |

```
          (Interleaver Size)
          shiftIndex
          INTEGER(0..maxNrofPhysicalResourceBlocks-1)
          OPTIONAL
        (Interleaver Shift)
    },
```

| | |
|---|---|
| non Interleaved | NULL |

},

| | |
|---|---|
| tci-StatesPDCCH | SEQUENCE(SIZE (1..maxNrofTCI- |
| StatesPDCCH)) OF TCI-StateId | OPTIONAL, |

(QCL Configuration Information)

| | |
|---|---|
| tci-PresentInDCI | ENUMERATED {enabled} |
| | OPTIONAL, -- Need S |

}

In [Table 21], the configuration information tci-StatesPDCCH (simply named Transmission Configuration Indication (TCI) state) may include information on one or more Synchronization Signal (SS)/Physical Broadcast Channel (PBCH) block indices or Channel State Information Reference Signal (CSI-RS) indices that are in a Quasi Co Located (QCL) relationship with the DMRS transmitted in the corresponding control resource set.

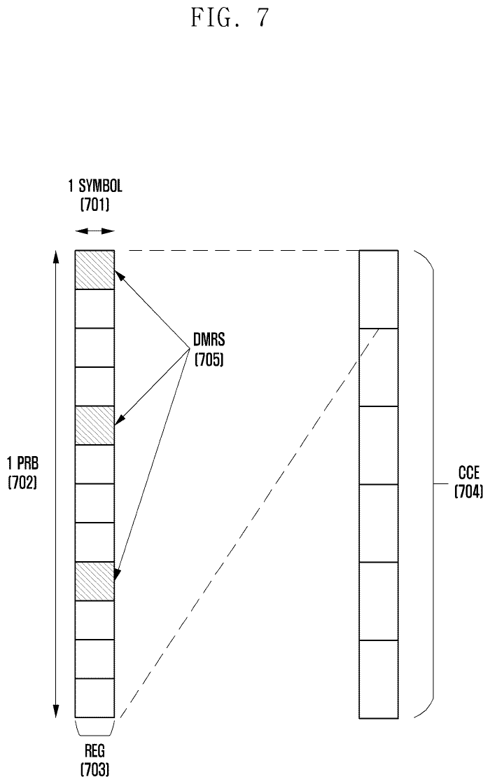

FIG. 7 illustrates an example of a basic unit of time and frequency resources constituting a downlink control channel that may be used in 5G. According to FIG. 7, a basic unit of time and frequency resources constituting a control channel may be referred to as a resource element group (REG) 703, and a REG 703 may be defined as one OFDM symbol 701 on the time axis and one physical resource block (PRB) 702 on the frequency axis, that is, 12 subcarriers. A base station may constitute a downlink control channel allocation unit by connecting REGs 703.

As illustrated in FIG. 7, when the basic unit to which a downlink control channel is allocated in 5G is referred to as a control channel element (CCE) 704, one CCE 704 may be constituted by multiple REGs 703. Taking the REG 703 illustrated in FIG. 7 as an example, a REG 703 may be constituted by 12 REs, and when one CCE 704 is constituted by 6 REGs 703, one CCE 704 may be constituted by 72 REs. When a downlink control resource set is configured, the region may be constituted by multiple CCEs 704, and a specific downlink control channel may be mapped to one or plurality of CCEs 704 and transmitted depending on the aggregation level (AL) within the control resource set. CCEs 704 within the control resource set are distinguished by numbers, and here the numbers of the CCEs 704 may be assigned according to a logical mapping scheme.

The basic unit of the downlink control channel illustrated in FIG. 7, that is, REG 703, may include both REs to which DCI is mapped and an area to which DMRS 705, which is a reference signal for decoding the REs, is mapped. As in FIG. 7, three DMRSs 705 may be transmitted in one REG 703. The number of CCEs required to transmit a PDCCH may be 1, 2, 4, 8, or 16 depending on the aggregation level (AL), and different numbers of CCEs may be used to implement link adaptation of the downlink control channel. For example, when AL=L, one downlink control channel may be transmitted through L CCEs. The UE should detect a signal without knowing information about the downlink control channel, and a search space representing a set of CCEs is defined for blind decoding. A search space is a set of downlink control channel candidates, which are constituted by CCEs that a UE may attempt to decode at a given aggregation level, and since there are multiple aggregation levels each forming a single bundle with 1, 2, 4, 8, and 16 CCEs, a UE may have a plurality of search spaces. A search space set may be defined as a set of search spaces at all configured aggregation levels.

The search space may be classified into a common search space and a UE-specific search space. A certain group of UEs or all UEs may search the common search space of the PDCCH to dynamically schedule the system information or to receive cell-common control information such as a paging message. For example, PDSCH scheduling allocation information for transmission of SIB including operator information of the cell may be received by searching the common search space of the PDCCH. In the case of the common search space, it can be defined as a set of pre-agreed CCEs, since a certain group of UEs or all UEs should receive the PDCCH. UE-specific PDSCH or PUSCH scheduling allocation information may be received by searching the UE-specific search space of the PDCCH. The UE-specific search space may be defined UE-specifically as a function of the identity of the UE and various system parameters.

In 5G, parameters for the search space for PDCCH may be configured by the base station to the UE through higher layer signaling (e.g., SIB, MIB, RRC signaling). For example, the base station may configure the number of PDCCH candidates at each aggregation level L, monitoring periodicity for the search space, monitoring occasion in units of symbols in the slot for the search space, a search space type (common search space or UE-specific search space), a combination of DCI format and RNTI to be monitored in the corresponding search space, a control resource set index to be monitored for the search space, etc. to the UE. For example, information in the [Table 22] below may be included.

TABLE 22

| | |
|---|---|
| SearchSpace ::= | SEQUENCE { |

```
    -- Identity of the search space. SearchSpaceId = 0 identifies the SearchSpace configured
        through PBCH (MIB) or ServingCellConfigCommon.
```

| | |
|---|---|
| searchSpaceId | SearchSpaceId, |

(Search Space Identity)

| | |
|---|---|
| controlResourceSetId | ControlResourceSetId, |

(Control resource set Identity)

| | |
|---|---|
| monitoringSlotPeriodicity AndOffset | CHOICE { |

(Monitoring Slot Level Periodicity)

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

}

| | |
|---|---|
| | OPTIONAL, |
| duration(Monitoring Length) | INTEGER (2..2559) |
| monitoringSymbolsWithinSlot | BIT STRING (SIZE (14)) |
| | OPTIONAL, |

(Monitoring Symbol in Sot)

| | |
|---|---|
| nrofCandidates | SEQUENCE { |

(The Number of PDCCH Candidates per Aggregation Level)

| | |
|---|---|
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, |

```
        n8}
    },
```

| | |
|---|---|
| searchSpaceType | CHOICE { |

```
    (Search Space Type)
        -- Configures this search space as common search space (CSS) and DCI formats to
        monitor.
```

| | |
|---|---|
| common | SEQUENCE { |

```
      (Common Search Space)
  }
```

| | |
|---|---|
| ue-Specific | SEQUENCE { |

```
      (UE-Specific Search Space)
          -- Indicates whether the UE monitors in this USS for DCI formats 0-0 and 1-0 or for
        formats 0-1 and 1-1.
```

| | |
|---|---|
| formats | ENUMERATED {formats0-0-And-1-0, |

```
        formats0-1-And-1-1},
          ...
        }
```

The base station may configure one or more search space sets to the UE according to the configuration information. According to some embodiments, the base station may configure search space set 1 and search space set 2 to the UE, in search space set 1, DCI format A scrambled with X-RNTI may be configured to be monitored in a common search space, and in search space set 2, DCI format B scrambled with Y-RNTI may be configured to be monitored in a UE-specific search space.

According to the configuration information, one or more search space sets may exist in the common search space or the UE-specific search space. For example, search space set #1 and search space set #2 may be configured as the common search space, and search space set #3 and search space set #4 may be configured as the UE-specific search space.

In the common search space, the following combinations of DCI formats and RNTIs may be monitored, although they are not limited to the following examples:
DCI format 0_0/1_0 with CRC scrambled by C-RNTI, CS-RNTI, SP-CSI-RNTI, RA-RNTI, TC-RNTI, P-RNTI, SI-RNTI;
DCI format 2_0 with CRC scrambled by SFI-RNTI;
DCI format 2_1 with CRC scrambled by INT-RNTI;
DCI format 2_2 with CRC scrambled by TPC-PUSCH-RNTI, TPC-PUCCH-RNTI; and
DCI format 2_3 with CRC scrambled by TPC-SRS-RNTI.

In the UE-specific search space, the following combinations of DCI formats and RNTIs can be monitored, although they are not limited to the following examples:
DCI format 0_0/1_0 with CRC scrambled by C-RNTI, CS-RNTI, TC-RNTI; and
DCI format 1_0/1_1 with CRC scrambled by C-RNTI, CS-RNTI, TC-RNTI.

The specified RNTIs may follow the following definitions and uses:
C-RNTI (Cell RNTI): used for UE-specific PDSCH scheduling;
TC-RNTI (Temporary Cell RNTI): used for UE-specific PDSCH scheduling;
CS-RNTI (Configured Scheduling RNTI): used for semi-statically configured UE-specific PDSCH scheduling;
RA-RNTI (Random Access RNTI): used for PDSCH scheduling in a random access process;
P-RNTI (Paging RNTI): used for scheduling a PDSCH on which paging is transmitted;
SI-RNTI (System Information RNTI): used for scheduling a PDSCH on which system information is transmitted;
INT-RNTI (Interruption RNTI): used for notifying whether to puncture the PDSCH;
TPC-PUSCH-RNTI (Transmit Power Control for PUSCH RNTI): used for indicating power control command for a PUSCH;
TPC-PUCCH-RNTI (Transmit Power Control for PUCCH RNTI): used for indicating power control command for a PUCCH; and
TPC-SRS-RNTI (Transmit Power Control for SRS RNTI): used for indicating power control command for an SRS.

The aforementioned specified DCI formats may follow the definitions in [Table 23] below.

TABLE 23

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) |
| | where UE may assume no transmission is intended for the UE |
| 2_2 | Transmission of TPC commands for PUCCH and PUSCH |
| 2_3 | Transmission of a group of TPC commands for SRS |
| | transmissions by one or more UEs |

In 5G, the search space at aggregation level Lin the control domain p and the search space set s may be expressed as in the following equation 1.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + iLggregation Level ; \qquad [ Equation 1 ]$$

n_{CI}: Carrier Index;
N_{CCE,p}: total number of CCEs existing in Control resource set p;
n_{s,f}^{μ}: Slot Index;
M_{s,max}^{(L)}er of PDCCH candidates for Aggregation Level L;
m_{s,n}_{_{CI}}=0, . . . , M_{s,max}^{(L)}DCCH Candidate Index for Aggregation Level L;
i=0, . . . , L−1;
Y_{p,n}_{_{s,f}}_{^{μ}}=(Aₚ·Y_{p,n}_{_{s,f}}_{^{μ}}₋₁) mod D, Y_{p,-1}=n_{RNTI}≠0, Aₚ=39827 for p mod 3=0, Aₚ=39829 for p mod 3=1, Aₚ=39839 for p mod 3=2, D=65537; and
n_{RNTI}: UE Identifier.

The value Y_{p,n}_{_{s,f}}_{^{μ}} may correspond to 0 for a common search space.

The value Y_{p,n}_{_{s,f}}_{^{μ}} may correspond to a value that changes depending on the UE's identity (C-RNTI or ID configured by the base station to the UE) and the time index for a UE-specific search space.

In 5G, since a plurality of search space sets may be configured with different parameters (e.g., the parameters in [Table 22]), the set of search space sets monitored by the UE at each point in time may be different. For example, when search space set #1 is configured to an X-slot periodicity and search space set #2 is configured to a Y-slot periodicity and X and Y are different, the UE may monitor both search space set #1 and search space set #2 in a specific slot, and may monitor one of search space set #1 and search space set #2 in a specific slot.

### [Regarding UE Capability Report]

In an LTE and NR, the UE may perform a procedure of reporting a capability supported by a UE to a corresponding base station in a state in which the UE is connected to a serving base station. In the following description, this is referred to as a UE capability report.

The base station may transmit a UE capability enquiry message that makes a request for a capability report to the UE in the connected state. The message may include a UE capability request for each radio access technology (RAT) type of the base station. The request for each RAT type may include supported frequency band combination information. In addition, in the case of the UE capability enquiry message, UE capability for each of a plurality of RAT types may be requested through one RRC message container transmitted by the base station or the base station may include the UE capability enquiry message including the UE capability request for each RAT type multiple times and transmit the same to the UE. That is, the UE capability enquiry is repeated multiple times within one message and the UE may constitute a UE capability information message corresponding thereto and report the same multiple times. In the next-generation mobile communication system, a UE capability request for NR, LTE, E-UTRA-NR dual connectivity (EN-DC), and multi-RAT dual connectivity (MR-DC) may be made. In addition, the UE capability enquiry message is generally transmitted initially after the UE is connected to the base station, but may be requested at any time when the base station needs the same.

The UE that has received the UE capability report request from the base station in the above operation constitutes UE capability according to RAT type and band information requested by the base station. Hereinafter, a method by which the UE constitutes the UE capability in the NR system is summarized.

1. When the UE receives a list of LTE and/or NR bands from the base station through a UE capability request, the UE constitutes a band combination (BC) for EN-DC and NR stand alone (SA). That is, the UE constitutes a candidate list of BCs for EN-DC and NR SA on the basis of bands in FreqBandList requested to the base station. In addition, the bands sequentially have priorities as stated in FreqBandList.

2. When the base station sets a “eutra-nr-only” flag or a “eutra” flag and makes a request for the UE capability report, the UE completely removes NR SA BCs from the constituted candidate list of BCs. Such an operation may occur only in the case that the LTE base station (eNB) makes a request for a “eutra” capability.

3. Thereafter, the UE removes fallback BCs from the candidate list of BCs constituted in the above operation. The fallback BC refers to a BC which can be acquired by removing a band corresponding to at least one SCell from a predetermined BC, and a BC before the removal of the band corresponding at least one SCell can already cover the fallback BC and thus the fallback BC can be omitted. This operation is applied to MR-DC, that is, LTE bands. BCs left after the operation correspond to a final “candidate BC list.”

4. The UE selects BCs suitable for a requested RAT type in the final “candidate BC list” and selects BCs to be reported. In this operation, the UE constitutes supportedBandCombinationList according to a determined order. That is, the UE constitutes BCs and UE capability to be reported according to an order of a preconfigured rat-Type (nr->eutra-nr->eutra). Further, the UE constitutes featureSetCombination for the constituted supportedBandCombinationList and constitutes a list of “candidate feature set combination” in a candidate BC list from which a list for fallback BCs (including capability at the same or lower stage) is removed. The “candidate feature set combination” may include all feature set combinations for NR and EUTRA-NR BCs, and may be acquired from a feature set combination of UE-NR-Capabilities and UE-MRDC-Capabilities containers.

5. In addition, when the requested rat Type is eutra-nr and influences, featureSetCombinations are included in all of the two containers of UE-MRDC-Capabilities and UE-NR-Capabilities. However, the NR feature set includes only UE-NR-Capabilities.

After the UE capability is constituted, the UE transmits a UE capability information message including the UE capability to the base station. Thereafter, the base station performs scheduling and transmission/reception management suitable for the corresponding UE on the basis of the UE capability received from the UE.

### [Regarding NC-JT]

According to an embodiment of the disclosure, the UE may use non-coherent joint transmission (NC-JT), in order to receive a PDSCH from multiple TRPs.

Unlike the system of the related art, the 5G wireless communication system supports not only a service requiring a high transmission rate but also both a service having a very short transmission delay and a service requiring a high connection density. In a wireless communication network including multiple cells, transmission and reception points (TRPs), or beams, coordinated transmission between respective cells, TRPs, or/and beams may satisfy various service requirements by increasing the strength of a signal received by the UE or efficiently controlling interference between the cells, TRPs, or/and beams.

Joint transmission (JT), as a representative transmission technology for the aforementioned cooperative communication, may increase the strength of a signal received by the UE or throughput by transmitting signals to one UE through different cells, TRPs, or/and beams. In this case, channels between each cell, TRP, or/and beam and the UE may have significantly different characteristics, and particularly, in the case of Non-Coherent Joint Transmission (NC-JT) supporting non-coherent precoding between respective cells, TRPs or/and beams, individual precoding, MCS, resource allocation, TCI indications, etc., may be required depending on the channel characteristics of each link between each cell, TRP or/and beam and the UE.

The aforementioned NC-JT transmission may be applied to at least one of a downlink data channel (PDSCH), a downlink control channel (PDCCH), an uplink data channel (PUSCH), and an uplink control channel (PUCCH). In PDSCH transmission, transmission information, such as precoding, MCS, resource allocation, and TCI, etc., should be indicated through DL DCI, and the above transmission information may be independently indicated for each cell, TRP, or/and beam for the NC-JT transmission. This is a main factor that increases the payload required for DL DCI transmission, which may have a bad influence on reception performance of a PDCCH transmitting the DCI. Accordingly, it is required to carefully design a tradeoff between an amount of DCI information and the reception performance of control information in order to support JT of the PDSCH.

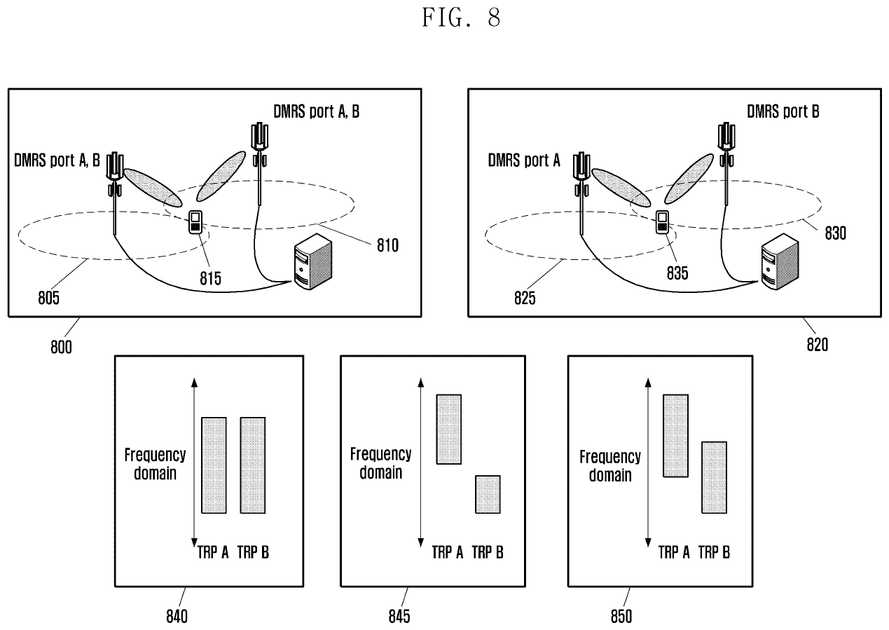

FIG. 8 illustrates a configuration of antenna ports and resource allocation to transmit a PDSCH through cooperative communication in a wireless communication system according to an embodiment of the disclosure.

Referring to FIG. 8, the example for transmitting the PDSCH is described for each of the joint transmission (JT) schemes, and examples for allocating radio resources per TRP are described.

Referring to FIG. 8, an example 800 for coherent joint transmission (C-JT) supporting coherent precoding between respective cells, TRPs, or/and beams is illustrated.

In the case of C-JT, TRP A 805 and TRP B 810 transmit single data (PDSCH) to a UE 815, and multiple TRPs may perform joint precoding. This may mean that TRP A 805 and TPR B 810 transmit DMRSs through the same DMRS ports in order to transmit the same PDSCH. For example, TRP A 805 and TPR B 810 may transmit DMRSs to the UE through DMRS port A and DMRS port B, respectively. In this case, the UE may receive one piece of DCI information for receiving one PDSCH demodulated based on the DMRSs transmitted through DMRS port A and DMRS port B.

FIG. 8 illustrates an example 820 of non-coherent joint transmission (NC-JT) supporting non-coherent precoding between respective cells, TRPs, or/and beams for PDSCH transmission.

In the case of NC-JT, the PDSCH is transmitted to UE 835 for each cell, TRP, or/and beam, and individual precoding may be applied to each PDSCH. Each cell, TRP, or/and beam may transmit different PDSCHs or different PDSCH layers to the UE, thereby improving throughput compared to single cell, TRP, or/and beam transmission. Further, each cell, TRP, or/and beam may repeatedly transmit the same PDSCH to the UE, thereby improving reliability compared to single cell, TRP, or/and beam transmission. For convenience of description, the cell, TRP, or/and beam are commonly referred to as a TRP.

In this case, various radio resource allocations may be considered, such as when the frequency and time resources used by multiple TRPs for PDSCH transmission are all the same (840), when the frequency and time resources used by multiple TRPs do not overlap at all (845), and when some of the frequency and time resources used by multiple TRPs overlap each other (850).

In order to support NC-JT, DCIs of various forms, structures, and relationships may be considered for allocating multiple PDSCHs to a single UE simultaneously.

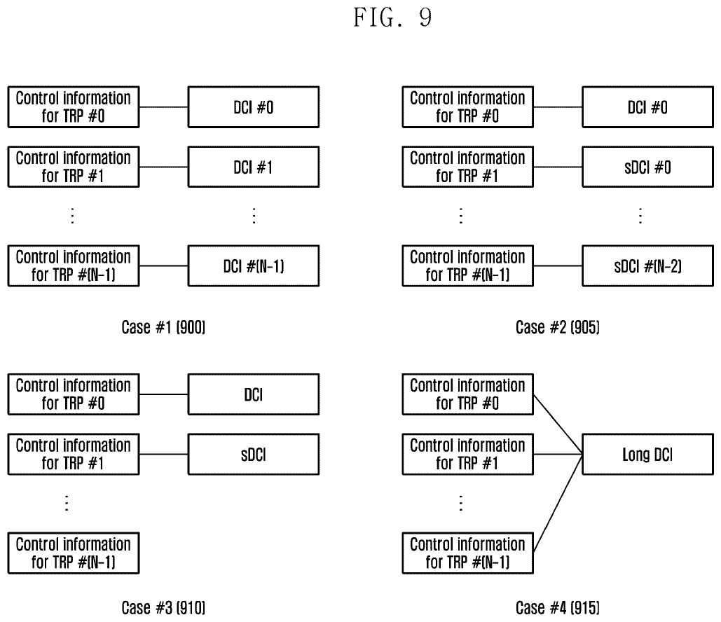

FIG. 9 illustrates an example of a downlink control information (DCI) configuration for NC-JT in which each TRP transmits a different PDSCH or a different PDSCH layer to a UE in a wireless communication system according to an embodiment of the disclosure.

Referring to FIG. 9, case #1 900 is an example in which control information for PDSCHs transmitted from (N−1) additional TRPs (TRP #1 to TRP #(N−1)) other than a serving TRP (TRP #0) used for single PDSCH transmission is transmitted independently from control information for a PDSCH transmitted from the serving TRP in a situation where (N−1) different PDSCHs are transmitted from the (N−1) additional TRPs. That is, the UE may acquire control information for PDSCHs transmitted from different TRPs (TRP #0 to TRP #(N−1)) through independent DCIs (DCI #0 to DCI #(N−1)). Formats between the independent DCIs may be the same as or different from each other, and payload between the DCIs may also be the same as or different from each other. In the aforementioned case #1, a degree of freedom in controlling or allocating each PDSCH can be completely guaranteed, but when each DCI is transmitted in different TRPs, there may be DCI-specific coverage differences, resulting in degraded reception performance.

Case #2 905 show an example in which control information for PDSCHs of (N−1) additional TRPs (TRP #1 to TRP #(N−1)) other than a serving TRP (TRP #0) used for single PDSCH transmission are transmitted respectively and each of these DCIs is dependent on control information for the PDSCH transmitted from the serving TRP in a situation where (N−1) different PDSCHs are transmitted from the (N−1) additional TRPs.

For example, in the case of DCI #0, which is control information for a PDSCH transmitted from the serving TRP (TRP #0), the control information may include all information elements of DCI format 1_0, DCI format 1_1, and DCI format 1_2, while in the case of shortened DCIs (hereinafter, referred to as sDCIs) (sDCI #0 to sDCI #(N−2)), which are control information for PDSCHs transmitted from the cooperative TRPs (TRP #1 to TRP #(N−1)), only some of the information elements of DCI format 1_0, DCI format 1_1, and DCI format 1_2 may be included. Accordingly, in the case of sDCI that transmits control information of PDSCHs transmitted from cooperative TPRs, it is possible to include reserved bits compared to the normal DCI (nDCI) because the payload is smaller than that of nDCI that transmits control information related to the PDSCH transmitted from the serving TRP.

In the aforementioned case #2, a degree of freedom in controlling or allocating each PDSCH may be limited depending on the content of the information elements included in sDCI, but since the reception performance of sDCI is superior to that of nDCI, a probability of coverage differences between DCIs may be reduced.

Case #3 910 shows an example in which one piece of control information for PDSCH of (N−1) additional TRPs (TRP #1 to TRP #(N−1)) other than a serving TRP (TRP #0) used for single PDSCH transmission is transmitted and the DCI is dependent on control information for PDSCH transmitted from the serving TRP in a situation where (N−1) different PDSCHs are transmitted from the (N−1) additional TRPs.

For example, in the case of DCI #0, which is control information for a PDSCH transmitted from the serving TRP (TRP #0), all information elements of DCI format 1_0, DCI format 1_1, and DCI format 1_2 may be included, and in the case of control information for PDSCHs transmitted from cooperative TRPs (TRP #1 to TRP #(N−1)), it is possible to collect and transmit only some of the information elements of DCI format 1_0, DCI format 1_1, and DCI format 1_2 in one “secondary” DCI (sDCI). For example, the above sDCI may include at least one piece of HARQ-related information, such as frequency domain resource assignment, time domain resource assignment, and the MCS of the cooperative TRPs, etc. In addition, information that is not included in the sDCI, such as a bandwidth part (BWP) indicator or a carrier indicator, etc. may follow DCI (DCI #0, normal DCI, nDCI) of the serving TRP.

In case #3 910, a degree of freedom in controlling or allocating each PDSCH may be limited depending on the content of the information elements included in the sDCI, but the reception performance of sDCI can be adjusted, and complexity of DCI blind decoding by the UE may be reduced compared to case #1 900 or case #2 905.

Case #4 915 is an example in which control information for PDSCHs transmitted from (N−1) additional TRPs (TRP #1 to TRP #(N−1)) other than a serving TRP (TRP #0) used for single PDSCH transmission is transmitted in DCI (long DCI) that is the same as that of control information for the PDSCH transmitted from the serving TRP in a situation where different (N−1) PDSCHs are transmitted from the (N−1) additional TRPs. That is, the UE may acquire control information for PDSCHs transmitted from different TRPs (TRP #0 to TRP #(N−1)) through single DCI. For case #4 915, complexity of DCI blind decoding by the UE may not increase, but a degree of freedom in controlling or allocating PDSCHs may be low, such as the number of cooperative TRPs is limited due to the limitation of long DCI payload.

In the following description and embodiments, sDCI may refer to various supplementary DCIs, such as shortened DCI, secondary DCI, or normal DCI (DCI formats 1_0 or 1_1 described above) including PDSCH control information transmitted from the cooperative TRP, and unless specific restriction is mentioned, the corresponding description may be similarly applied to the various supplementary DCIs.

In the following description and embodiments, the aforementioned case #1 900, case #2 905, and case #3 910 where one or more DCIs (or PDCCHs) are used to support NC-JT may be classified as multiple PDCCH-based NC-JT and the aforementioned case #4 915 where single DCI (or PDCCH) is used to support NC-JT may be classified as single PDCCH-based NC-JT. In multiple PDCCH-based PDSCH transmission, a CORESET for which the DCI of the serving TRP (TRP #0) is scheduled and a CORESET for which the DCI of the cooperative TRPs (TRP #1 to TRP #(N−1)) is scheduled may be distinguished. As a method for distinguishing the CORESETs, there may be a method for distinguishing through a higher layer indicator for each CORESET and a method for distinguishing through beam configuration for each CORESET, etc. Further, in single PDCCH-based NC-JT, single DCI schedules a single PDSCH having a plurality of layers instead of scheduling a plurality of PDSCHs, and the aforementioned plurality of layers may be transmitted from multiple TRPs. In this case, association between a layer and a TRP transmitting the corresponding layer may be indicated through a transmission configuration indicator (TCI) indication for the layer.

In embodiments of the disclosure, the “‘cooperative TRP’” may be replaced with various terms, such as a “cooperative panel” or a “cooperative beam,” etc., in practical application.

In embodiments of the disclosure, the expression “when NC-JT is applied” may be variously interpreted depending on the situation, such as “when the UE simultaneously receives one or more PDSCHs in one BWP,” “when the UE simultaneously receives PDSCHs based on two or more transmission configuration indicator (TCI) indications in one BWP,” and “when the PDSCHs received by the UE are associated with one or more DMRS port groups,” but is used in one expression for convenience of description.

In the disclosure, a radio protocol architecture for NC-JT may be variously used depending on the TRP deployment scenario. For example, when there is no or small backhaul delay between cooperative TRPs, a method (CA-like method) using a structure based on MAC layer multiplexing similar to S10 of FIG. 4 is possible. On the other hand, when the backhaul delay between cooperative TRPs is large enough to be ignored (for example, when a time of 2 ms or longer is required for exchanging information, such as CSI, scheduling, and HARQ-ACK, etc., between cooperative TRPs), a method (DC-like method) using an independent structure for each TRP starting from the RLC layer similar to S20 of FIG. 4 to secure delay-robust characteristics is possible.

The UE supporting C-JT or/and NC-JT may receive C-JT or/and NC-JT-related parameters or setting values, etc. from a higher layer configuration and may set RRC parameters of the UE on the basis thereof. For the higher layer configuration, the UE may use a UE capability parameter, for example, tci-StatePDSCH. Here, the UE capability parameter, for example, tci-StatePDSCH may define TCI states for the purpose of the PDSCH transmission, the number of TCI states may be configured as 4, 8, 16, 32, 64, and 128 in FR1 and as 64 and 128 in FR2, and among the configured number, a maximum of 8 states that may be indicated by 3 bits of a TCI field of DCI may be configured through a MAC CE message. A maximum value 128 means a value indicated by maxNumberConfiguredTCIstatesPerCC within the parameter tci-StatePDSCH which is included in capability signaling of the UE. As described above, a series of configuration processes from the higher layer configuration to the MAC CE configuration may be applied to a beamforming indication or a beamforming change command for at least one PDSCH in one TRP.

### [Regarding SBFD (XDD)]

In 5G mobile communication services, additional coverage expansion technology has been introduced compared to LTE communication services, while a TDD system generally suitable for services with a high proportion of downlink traffic may be utilized for 5G mobile communication services in practice. In addition, as the center frequency increases to increase the frequency band, the coverage of base stations and UEs decreases, so coverage enhancement is a key requirement for 5G mobile communication services. In particular, in order to support services where the transmission power of UEs is lower than that of base stations and where downlink traffic has a high proportion, and because the proportion of downlink in the time domain is higher than that of uplink, coverage enhancement of uplink channels is a key requirement for 5G mobile communication services. Physical methods for enhancing the coverage of uplink channels between base stations and UEs include increasing the time resources of uplink channels, lowering the center frequency, or increasing the transmission power of UEs. However, changing the frequency may be constrained because frequency bands are determined by each network operator. Additionally, since the maximum transmission power of UEs is regulated to reduce interference, there may be constraints on increasing the maximum transmission power of UEs to enhance coverage.

Therefore, in order to enhance the coverage of base stations and UEs, in addition to dividing uplink and downlink resources in the time domain according to the traffic proportions of the uplink and downlink as in a TDD system, uplink and downlink resources may be divided in the frequency domain as in an FDD system. In an embodiment, a system that can flexibly divide uplink resources and downlink resources in the time domain and the frequency domain may be referred to as an XDD (cross division duplex) system, a Flexible TDD system, a Hybrid TDD system, a TDD-FDD system, a Hybrid TDD-FDD system, etc., and for convenience of description, it will be described as an XDD system in the disclosure. According to an embodiment, X in XDD may refer to time or frequency.

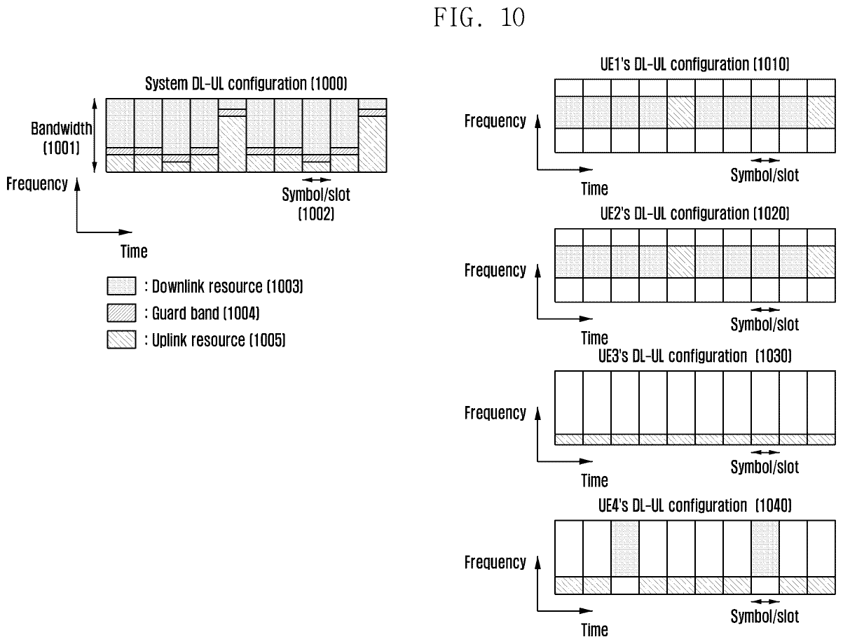

FIG. 10 illustrates an uplink-downlink resource configuration of an XDD system in which uplink and downlink resources are flexibly divided in the time domain and frequency domain according to an embodiment of the disclosure.

Referring to FIG. 10, from the perspective of a base station, in the uplink-downlink configuration 1000 of the overall XDD system, resources may be flexibly allocated for each symbol or slot 1002 according to the traffic proportions of uplink and downlink for the entire frequency band 1001. However, it is merely an example, the unit in which resources are allocated is not limited to a symbol or slot 1002, and resources may be flexibly allocated according to units such as mini slots. In this case, a guard band 1004 may be allocated between the frequency bands between the downlink resources 1003 and the uplink resources 1005. This guard band 1004 may be allocated as a measure to reduce interference applied to uplink channels or signal reception by out-of-band emission that occurs when a base station transmits a downlink channel or signal in downlink resources 1003.

In this case, for example, UE 1 1010 and UE 2 1020, which generally have more downlink traffic than uplink traffic according to the configuration of the base station, may be allocated a resource ratio of 4:1 for downlink to uplink in the time domain. At the same time, UE 3 1030, which operates at the cell edge and has insufficient uplink coverage, may be allocated only uplink resources during a specific time period according to the configuration of the base station. Additionally, UE 4 1040, which operates at the cell edge and has insufficient uplink coverage but relatively large amounts of downlink and uplink traffic, may be allocated many uplink resources in the time domain and many downlink resources in the frequency band for uplink coverage. As in the example described above, there is an advantage in that UEs with high downlink traffic that operate relatively in the cell center may be allocated more downlink resources in the time domain, and UEs with insufficient uplink coverage that operate relatively in the cell edge may be allocated more uplink resources in the time domain.

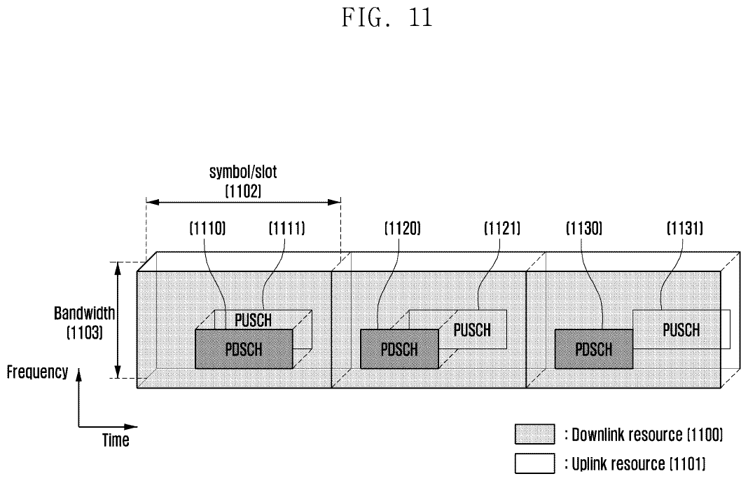

FIG. 11 illustrates an example of an uplink-downlink resource configuration of a full duplex communication system in which uplink and downlink resources are flexibly divided in the time domain and frequency domain according to an embodiment of the disclosure.

According to an example illustrated in FIG. 11, all or part of the downlink resources 1100 and the uplink resources 1101 may be configured to overlap in the time and frequency domains. Downlink transmission from a base station to a UE may be performed in an area configured for downlink resources 1100, and uplink transmission from a UE to a base station may be performed in an area configured for uplink resources 1101.

In an example of FIG. 11, the entirety of the downlink resources 1110 and the uplink resources 1111 may be configured to overlap in the time resources corresponding to the symbol or slot 1102 and the frequency resources corresponding to the bandwidth 1103. In this case, since the downlink resources 1110 and uplink resources 1111 overlap in time and frequency, downlink and uplink transmission and reception of a base station or UE may occur simultaneously in the same time and frequency resources.

In another example of FIG. 11, part of the downlink resource 1120 and the uplink resource 1121 may be configured to overlap in the time resource corresponding to the symbol or slot and the frequency resource corresponding to the bandwidth 1103. In this case, downlink and uplink transmission and reception of a base station or UE may occur simultaneously in some areas where downlink resources 1120 and uplink resources 1121 overlap.

In yet another example of FIG. 11, downlink resources 1130 and uplink resources 1131 may be configured so that they do not overlap in the time resources corresponding to symbols or slots and the frequency resources corresponding to bandwidth 1103.

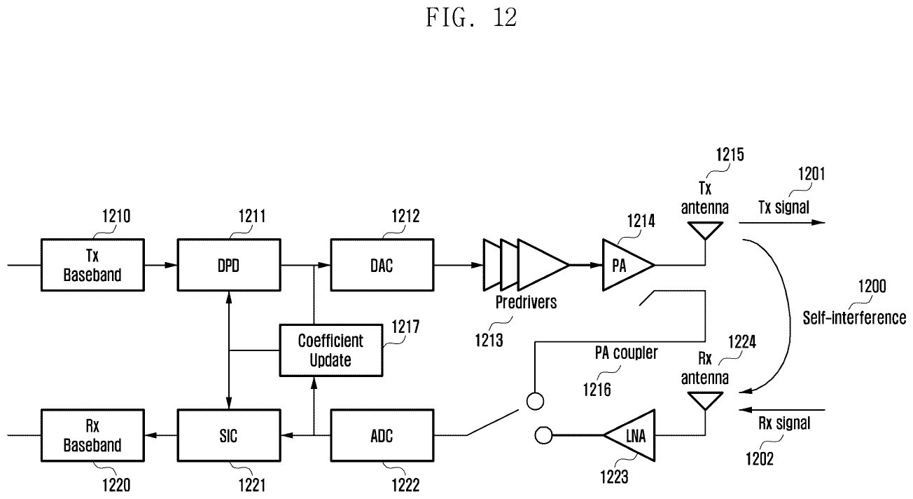

FIG. 12 illustrates a transmission/reception structure for a duplex scheme according to an embodiment of the disclosure.

The transmission/reception structure illustrated in FIG. 12 may be used in a base station device or a terminal device. According to the transmission/reception structure illustrated in FIG. 12, the transmitter may be constituted by blocks such as a transmission baseband block (Tx Baseband) 1210, a digital pre-distortion block (DPD) 1211, a digital-to-analog converter (DAC) 1212, a pre-driver 1213, a power amplifier (PA) 1214, and a transmission antenna (Tx Antenna) 1215, etc. Each block may perform the following functions:

Transmission Baseband Block 1210: Digital processing block for transmission signals;
Digital Pre-Distortion Block 1211: Pre-distortion for digital transmission signals;
Digital to analog converter 1212: Converts digital signals to analog signals;
Pre-driver 1213: Progressive power amplification of analog transmission signals;
Power amplifier 1214: Power amplification of analog transmission signals; and
Transmission antenna 1215: Antenna for signal transmission.

According to the transmission/reception structure illustrated in FIG. 12, the receiver may be constituted by blocks such as a reception antenna (Rx Antenna) 1224, a low noise amplifier (LNA) 1223, an analog-to-digital converter (ADC) 1222, a successive interference canceller 1221, and a reception baseband block (Rx Baseband) 1220, etc. Each block may perform the following functions:
Receiving Antenna 1224: Antenna for signal reception;
Low Noise Amplifier 1223: Amplifies the power of analog reception signals while minimizing the amplification of noise;
Analog to Digital Converter 1222: Converts analog signals to digital signals;
Successive Interference Canceller 1221: Interference canceller for digital signals; and
Receive Baseband Block 1220: Digital processing block for reception signals.

According to the transmission/reception structure illustrated in FIG. 12, a power amplifier coupler (PA Coupler) 1216 and a coefficient update block (Coefficient Update) 1217 may be present for additional signal processing between the transmitter and the receiver. Each block may perform the following functions:
Power Amplifier Coupler 1216: A block for observing the waveform of the transmitted analog signal that has passed through a power amplifier at the reception end; and
Coefficient Update Block 1217: Updates various coefficients required for digital domain signal processing at the transmitter and the receiver. The coefficients calculated here may be used to set various parameters in the DPD 1211 block of the transmitter and the SIC 1221 block of the receiver.

The transmission/reception structure illustrated in FIG. 12 may be utilized for the purpose of effectively controlling interference between a transmission signal and a reception signal when transmission and reception operations are performed simultaneously at a base station or a terminal device. For example, when transmission and reception occur simultaneously at either device, a transmission signal 1201 transmitted through a transmission antenna 1215 of a transmitter may be received through a reception antenna 1224 of a receiver, and in this case, the transmission signal 1201 received by the receiver may cause interference 1200 with the reception signal 1202 that the receiver originally intended to receive. The interference between the reception signal 1202 and the transmission signal 1201 received by the receiver is referred to as self-interference 1200. For example, to be specific, when a base station device performs downlink transmission and uplink reception simultaneously, the downlink signal transmitted by the base station may be received by the base station's receiver, and as a result, interference may occur between the downlink signal transmitted by the base station and the uplink signal that the base station originally intended to receive at the receiver. When a terminal device performs downlink reception and uplink transmission simultaneously, the uplink signal transmitted by the terminal may be received by the terminal's receiver, and as a result, interference may occur between the uplink signal transmitted by the terminal and the downlink signal that the terminal originally intended to receive at the receiver. As such, interference between links in different directions, i.e., downlink signals and uplink signals, at the base station and terminal devices is also referred to as cross-link interference.

In an embodiment of the disclosure, self-interference between a transmission signal (or downlink signal) and a reception signal (or uplink signal) may occur in a system in which transmission and reception may be performed simultaneously.

As an example, self-interference may occur in the XDD system mentioned above.

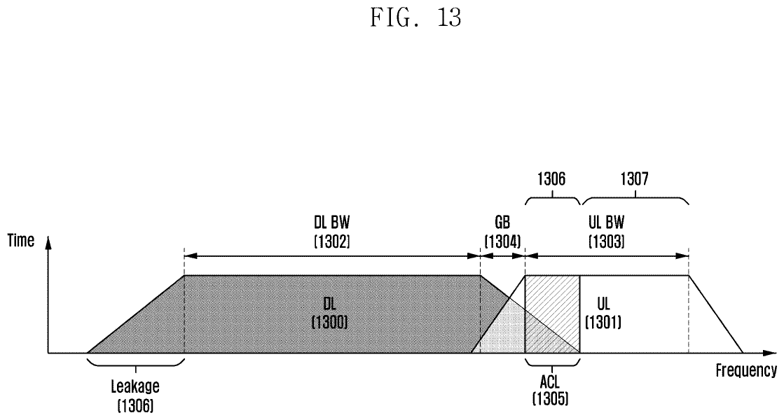

FIG. 13 illustrates an example of downlink and uplink resource configuration in an XDD system.

In the case of XDD, downlink 1300 resources and uplink 1303 resources may be distinguished in the frequency domain, and a guard band (GB) 1304 may exist between the downlink 1300 resources and the uplink 1301 resources. Actual downlink transmission may be performed within the downlink bandwidth 1302, and uplink transmission may be performed within the actual uplink bandwidth 1303. In this case, leakage 1306 may occur outside the uplink or downlink transmission band. In an area where downlink resources 1300 and uplink resources 1301 are adjacent, interference due to this leakage (which may be referred to as Adjacent Carrier Leakage (ACL)) 1305 may occur. FIG. 13 illustrates an example in which ACL 1305 occurs from a downlink 1300 to an uplink 1301. As the downlink bandwidth 1302 and the uplink bandwidth 1303 become closer, the influence of signal interference by the ACL 1305 may increase, and thus performance degradation may occur. For example, as illustrated in FIG. 13, some resource areas 1306 within an uplink band 1303 adjacent to a downlink band 1302 may be greatly affected by interference by the ACL 1305. Some resource areas 1307 within an uplink band 1303 relatively far from the downlink band 1302 may be less affected by interference by the ACL 1305. That is, within the uplink band 1303, there may exist resource areas 1306 (e.g., leakage) that are relatively greatly affected by interference and resource areas 1307 that are relatively less affected by interference.

In order to reduce performance degradation due to the ACL 1305, a guard band 1304 may be inserted between the downlink bandwidth 1302 and the uplink bandwidth 1303. While a larger size of the guard band 1304 has the advantage that the impact of interference due to the ACL 1305 between the downlink bandwidth 1302 and the uplink bandwidth 1303 may be smaller, it may have the disadvantage of being less resource efficient, since fewer resources are available for transmission and reception as the size of the guard band 1304 increases. On the contrary, a smaller size of the guard band 1304 has the advantage of being more resource efficient since the guard band increases the amount of resources available for transmission and reception, while it may have the disadvantage of increasing the impact of interference due to the ACL 1305 between the downlink bandwidth 1302 and the uplink bandwidth 1303. Therefore, it may be important to determine an appropriate size of the guard band 1304 by considering the trade-off.

Meanwhile, subband non-overlapping full duplex (SBFD) is being discussed in 3GPP as a new duplex scheme based on NR. SBFD is a technology that can expand the uplink coverage of a UE by receiving uplink transmissions from the UE as much as the increased uplink resource by utilizing a part of the downlink resource as an uplink resource in the TDD spectrum of a sub 6 GHz frequency or above 6 GHz frequency, and reduce the feedback delay by receiving feedback on the downlink transmissions from the UE on the increased uplink resource. In the present disclosure, a UE capable of receiving information from a base station about whether the UE supports SBFD and performing uplink transmission on a portion of the downlink resources may be referred to as an SBFD-capable UE for convenience. For the purpose of defining the above SBFD schemes in the specification and for an SBFD-capable UE to determine that the above SBFD is supported in a particular cell (or frequency, frequency band), the following schemes may be considered:

First scheme. In addition to the conventional frame structure types of unpaired spectrum (or time division duplex, TDD) or paired spectrum (or frequency division duplex, FDD), another frame structure type (e.g., frame structure type 2) may be introduced to define the above SBFD. The above frame structure type 2 may be defined as supported at a specific frequency or frequency band, or a base station may indicate to a UE whether SBFD is supported with system information. The SBFD-capable UE may determine whether SBFD is supported in the specific cell (or frequency, frequency band) by receiving the system information including whether SBFD is supported.

Second scheme. Whether SBFD is additionally supported in a specific frequency or frequency band of a conventional unpaired spectrum (or TDD) may be indicated without defining a new frame structure type. In the above second method, whether SBFD is additionally supported in a specific frequency or frequency band of a conventional unpaired spectrum may be defined, or a base station may indicate to a UE whether SBFD is supported with system information. The SBFD-capable UE may determine whether SBFD is supported in the specific cell (or frequency, frequency band) by receiving the system information including whether SBFD is supported.

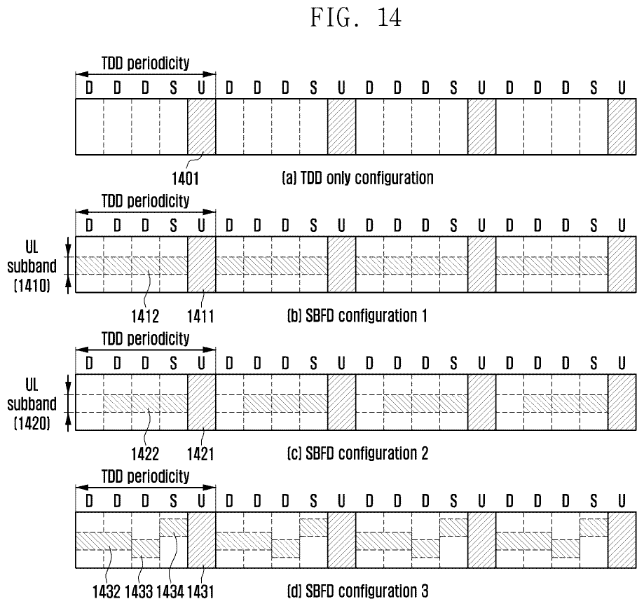

In the first and second methods described above, information on whether SBFD is supported may be information that indirectly indicates whether SBFD is supported by additionally configuring a part of downlink resources as uplink resources in addition to the TDD uplink-downlink (UL-DL) resource configuration information indicating downlink slot (or symbol) resources and uplink slot (or symbol) resources of TDD (for example, SBFD resource configuration information in FIG. 14 described below), or may be information that directly indicates whether SBFD is supported.

In the present disclosure, the SBFD-capable UE may acquire cell synchronization by receiving a synchronization signal block in the initial cell access for accessing a cell (or base station). The process of acquiring the cell synchronization may be the same for the SBFD-capable UE and the conventional TDD UE. Thereafter, the SBFD-capable UE may determine whether the cell supports SBFD through a MIB acquisition process, a SIB acquisition process, or a random access process.

The system information for transmitting information on whether the above SBFD is supported may be system information transmitted separately from the system information for UEs (e.g., conventional TDD UEs) that support other versions of specification within the cell, and the above SBFD-capable UE may determine whether SBFD is supported by acquiring all or part of the system information transmitted separately from the system information for the above conventional TDD UEs. When the SBFD-capable UE acquires only the system information for the conventional TDD UEs or acquires the system information that indicating SBFD is not supported, it may determine that the cell (or base station) supports only TDD.

When the information on whether the above SBFD is supported is included in the system information for UEs supporting a different version of specification (e.g., conventional TDD UEs), the information on whether the above SBFD is supported may be inserted at the very end so as not to affect the acquisition of system information by the conventional TDD UEs. When the SBFD-capable UE fails to acquire the information on whether the above SBFD is supported inserted at the very end, or acquires information indicating that SBFD is not supported, the SBFD-capable UE may determine that the cell (or base station) supports only TDD.

When the information on whether the above SBFD is supported is included in the system information for UEs supporting a different version of specification (e.g., conventional TDD UEs), the information on whether SBFD is supported may be transmitted on a separate PDSCH so as not to affect the acquisition of system information by the conventional TDD UEs. That is, a UE that does not support SBFD may receive the first SIB (or SIB1) including the conventional TDD-related system information on the first PDSCH. A UE that supports SBFD may receive the first SIB (or SIB) including the conventional TDD-related system information on the first PDSCH, and may receive the second SIB including the SBFD-related system information on the second PDSCH. Here, the first PDSCH and the second PDSCH may be scheduled by the first PDCCH and the second PDCCH, and the cyclic redundancy code (CRC) of the first PDCCH and the second PDCCH may be scrambled with the same RNTI (e.g., SI-RNTI). The search space for monitoring the second PDCCH may be acquired from the system information of the first PDSCH, and if it is not acquired (i.e., the system information of the first PDSCH does not include information about the search space), the second PDCCH may be received in the same search space as the search space of the first PDCCH.

As described above, when the SBFD-capable UE determines that the cell (or base station) supports only TDD, the SBFD-capable UE may perform random access procedures and transmit and receive data/control signals in the same manner as conventional TDD UEs.

The base station may configure separate random access resources for each of a conventional TDD UE or an SBFD-capable UE (e.g., an SBFD-capable UE supporting duplex communication and an SBFD-capable UE supporting half-duplex communication), and transmit configuration information (control information or configuration information indicating time-frequency resources that may be used for PRACH) for the random access resources to the SBFD-capable UE through system information. The system information for transmitting information for the random access resources may be separately transmitted system information that is distinguished from system information for a UE supporting different versions of specification within a cell (e.g., a conventional TDD UE).

It is possible for the above base station to distinguish whether a TDD UE supporting the different versions of specification performs random access or an SBFD-capable UE performs random access by configuring separate random access resources for the TDD UE supporting the different versions of specification and the SBFD-capable UE. For example, the separate random access resources configured for the SBFD-capable UE may be a resource that the conventional TDD UE determines to be a downlink time resource, and the above SBFD-capable UE may perform random access through uplink resources (or separate random access resources) configured for some frequencies of the above downlink time resources, such that the base station may determine that the UE attempting random access on the above uplink resource is an SBFD-capable UE.

Alternatively, the base station may not configure separate random access resources for the SBFD-capable UE, but may configure common random access resources for all UEs in the cell. In this case, configuration information for the random access resources may be transmitted to all UEs in the cell through system information, and the SBFD-capable UE that has received the above system information may perform random access on the random access resources. Thereafter, the SBFD-capable UE may complete the random access process and proceed to the RRC connection mode for transmitting and receiving data with the cell. After the RRC connection mode, the SBFD-capable UE may receive an upper or physical signal from the base station from which it can be determined that some frequency resources of the above downlink time resources are configured as uplink resources, and may perform SBFD operation, for example, may transmit an uplink signal on the above uplink resource.

When the above SBFD-capable UE determines that the above cell supports SBFD, the SBFD-capable UE may transmit capability information including at least one of whether the UE supports SBFD, whether full-duplex communication or half-duplex communication is supported, and the number of transmission or reception antennas it has (or supports), to the base station, thereby notifying the base station that the UE attempting to access is an SBFD-capable UE. Alternatively, when half-duplex communication support is a mandatory implementation for the SBFD-capable UE, whether the half-duplex communication is supported may be omitted from the capability information. The SBFD-capable UE's report on the above capability information may be reported to the base station through a random access process, may be reported to the base station after completing the random access process, or may be reported to the base station after proceeding to a RRC connection mode for transmitting and receiving data with a cell.

The above SBFD-capable UE may support half-duplex communication that performs only uplink transmission or downlink reception at one time like a conventional TDD UE, or may support full-duplex communication that performs both uplink transmission and downlink reception at the same time. Accordingly, the SBFD-capable UE may report to the base station whether the above half-duplex communication or full-duplex communication is supported through a capability report, and after the above report, the base station may configure to the SBFD-capable UE whether to transmit and receive using half-duplex communication or full-duplex communication. When the SBFD-capable UE reports the capability for the above half-duplex communication to the base station, a switching gap may be required to change RF between transmission and reception when operating in FDD or TDD, since a duplexer generally does not exist.

FIG. 14 illustrates an example of SBFD operated in a TDD band of a wireless communication system to which the present disclosure is applied.

FIG. 14(a) illustrates a case where TDD operates in a specific frequency band. In a cell operating the above TDD, a base station may transmit and receive signals to and from a conventional TDD UE or an SBFD-capable UE including data/control information in a downlink slot (or symbol), an uplink slot (or symbol) 1401, and a flexible slot (or symbol) based on configurations for TDD UL-DL resource configuration information indicating downlink slot (or symbol) resources and uplink slot (or symbol) resources of TDD.

In FIG. 14, it can be assumed that the DDDSU slot format is configured according to the TDD UL-DL resource configuration information. Here, “D” is a slot constituted entirely by downlink symbols, “U” is a slot constituted entirely by uplink symbols, and “S” is a slot that is not “D” or “U,” that is, a slot that includes a downlink symbol or an uplink symbol or includes a flexible symbol. Here, for convenience, it can be assumed that S is constituted by 12 downlink symbols and 2 flexible symbols. Also, the DDDSU slot format may be repeated according to the TDD UL-DL resource configuration information. That is, the repetition periodicity of the TDD configuration is 5 slots (5 ms for 15 kHz SCS, 2.5 ms for 30 kHz SCS, etc.).

Next, FIGS. 14(b), 14(c) to 14(d) illustrate cases where SBFD is operated together with TDD in a specific frequency band.

Referring to FIG. 14(b), a UE may be configured with some of the frequency bands of a cell as frequency bands 1410 that may be used for uplink transmission. This band is referred to as the uplink subband (UL subband). Also, the above UL subband may be applied to all symbols of all slots. The UE may transmit uplink channels or signals scheduled on all symbols 1412 within the above-mentioned subband (UL subband). However, the UE may not transmit uplink channels or signals in a band other than the above-mentioned UL subband.

Referring to FIG. 14(c), the UE may be configured with some of the frequency bands of a cell as frequency bands 1420 that may be used for uplink transmission, and may be configured with time region in which the above frequency band is activated. Here, this frequency band may be referred to as a UL subband. In FIG. 14(c), the UL subband is deactivated in the first slot, and the UL subband may be activated in the remaining slots. Accordingly, the UE may transmit uplink channels or signals in the UL subband 1422 of the remaining slots. For reference, although the UL subband herein is activated in units of slots, the activation thereof may be configured in units of symbols.

Referring to FIG. 14(d), a UE may be configured with time-frequency resources for which uplink transmission is possible. The UE may be configured with one or more time-frequency resources as time-frequency resources for which uplink transmission is possible. For example, some frequency bands 1432 of the first slot and the second slot may be configured as time-frequency resources for which uplink transmission is possible. In addition, some frequency bands 1433 of the third slot and some frequency bands 1434 of the fourth slot may be configured as time-frequency resources for which uplink transmission is possible.

In the following description, a time-frequency resource for which uplink transmission is possible within a downlink symbol or slot may be referred to as an SBFD resource. In addition, a symbol for which an UL subband is configured within a downlink symbol may be referred to as an SBFD symbol. Further, a time-frequency resource for which downlink reception is possible within an uplink symbol or slot may be referred to as an SBFD resource. Moreover, a symbol for which a downlink subband is configured within an uplink symbol may be referred to as an SBFD symbol.

For convenience, in the present disclosure, a band in which the reception of downlink channels or signals is possible, excluding an UL subband, is referred to as a downlink subband. A UE may be configured with at most one uplink subband, and may be configured with at most two downlink subbands in one symbol. For example, the UE may be configured with one of {uplink subband, downlink subband}, {downlink subband, uplink subband}, or {first downlink subband, uplink subband, second downlink subband} in the frequency domain.

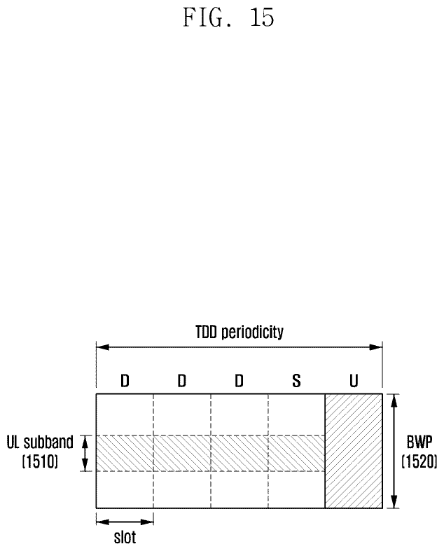

FIG. 15 illustrates an SBFD configuration according to an embodiment of the disclosure.

Referring to FIG. 15, a UE may be configured with uplink symbols, downlink symbols, or flexible symbols according to the TDD configuration. Here, all symbols of a “D” slot are downlink symbols. All symbols of a “U” slot are uplink symbols. An “S” slot is a slot that is not a “D” slot or a “U” slot. The UE may be configured with a UL BWP 1520. In addition, the UE may be configured with a UL subband 1510 within a DL symbol. Further, the UE may be configured with a slot or symbol to which the UL subband 1510 is to be applied. Referring to FIG. 15, a UL subband may be applied only to some symbols among DL symbols of a TDD periodicity. The DL symbols of the second and third slots are applied with UL subbands, but the other DL symbols may not be applied with UL subbands. Here, the SBFD symbol may represent a symbol to which the UL subband is applied.

The base station may configure the UE with a guard frequency interval between the DL subband and the UL subband. When the guard frequency interval is configured for the UE, the frequency resource in the frequency domain may be divided into the UL subband, the guard frequency interval, and the DL subband. For the purpose of explaining this embodiment, it is assumed that the guard frequency interval is included in the UL subband. That is, in the following description, the expression “when ‘X’ overlaps with the UL subband” may be interpreted as “when ‘X’ overlaps with the UL subband or the guard frequency interval.” In addition, the expression “when ‘X’ overlaps with the UL subband” may be interpreted as “when ‘X’ does not overlap with the DL subband.”

The expression “when ‘X’ does not overlap with a UL subband” may be interpreted as “when ‘X’ does not overlap with a UL subband and a guard frequency interval.” Also, the expression “when ‘X’ does not overlap with a UL subband” may be interpreted as “when ‘X’ overlaps with a DL subband.”

Hereafter, embodiments of the disclosure will be described in detail with reference to accompanying drawings. The content of the disclosure may be applied to FDD, TDD and/or XDD (and/or SBFD, full duplex) systems. Hereafter, higher signaling (or higher layer signaling) in the disclosure is a method for delivering a signal from a base station to a UE by using a downlink data channel of a physical layer or from a UE to a base station by using an uplink data channel of the physical layer, and may be referred to as RRC signaling, PDCP signaling, or medium access control (MAC) control element (CE).

Hereafter, in the disclosure, when the UE determines whether to apply the cooperative communication, the UE may use various methods such as applying a specific format to PDCCH(s) for allocating a PDSCH to which the cooperative communication is applied, including a specific indicator indicating whether the PDCCH(s) for allocating the PDSCH to which the cooperative communication is applied applies the cooperative communication, scrambling the PDCCH(s) for allocating the PDSCH to which the cooperative communication is applied with a specific RNTI, or assuming the cooperative communication applied in a specific interval indicated by a higher layer. For convenience of description below, receiving at the UE the PDSCH to which the cooperative communication is applied based on the above similar conditions may be referred to as an NC-JT case.

Hereafter, determining the priority between A and B in the disclosure may be variously mentioned such as selecting one having a higher priority according to a predefined priority rule and performing a corresponding operation or omitting or dropping an operation on one having a lower priority

Hereafter, the examples are described through a plurality of embodiments in the disclosure but are not independent, and one or more embodiments may be applied simultaneously or in combination.

Hereinafter, for convenience of description, a cell, a transmission point, a panel, a beam, and/or a transmission direction which can be distinguished through a higher layer/L1 parameter such as a TCI state or spatial relation information, a cell ID, a TRP ID, or a panel ID may be described as a transmission reception point (TRP), a beam, or a TCI state as a whole. Therefore, during actual application, a TRP, a beam, or a TCI state may be appropriately replaced with one of the above terms.

Hereafter, in the disclosure, when the UE determines whether to apply the cooperative communication, the UE may use various methods such as applying a specific format to PDCCH(s) for allocating a PDSCH to which the cooperative communication is applied, including a specific indicator indicating whether the PDCCH(s) for allocating the PDSCH to which the cooperative communication is applied applies the cooperative communication, scrambling the PDCCH(s) for allocating the PDSCH to which the cooperative communication is applied with a specific RNTI, or assuming the cooperative communication applied in a specific interval indicated by a higher layer. For convenience of description below, receiving at the UE the PDSCH to which the cooperative communication is applied based on the above similar conditions may be referred to as an NC-JT case.

Hereinafter, embodiments of the disclosure will be described in detail with reference to the accompanying drawings. Hereinafter, a base station refers to an entity that allocates resources to a terminal, and may be at least one of a gNode B, a gNB, an eNode B, a node B, a base station (BS), a radio access unit, a base station controller, and a node on a network. A terminal may include user equipment (UE), a mobile station (MS), a cellular phone, a smart phone, a computer, or a multimedia system capable of performing a communication function. Hereinafter, although embodiments of the disclosure will be described with reference to a 5G system as an example, embodiments of the disclosure are also applicable to other communication systems having similar technical backgrounds or channel types. For example, LTE or LTE-A mobile communications and mobile communication technologies developed after 5G may be included therein. Therefore, embodiments of the disclosure are also applicable to other communication systems through a partial modification without substantially deviating from the scope of the disclosure as deemed by those skilled in the art. The content in the disclosure is applicable in FDD, TDD and/or XDD (and/or SBFD, full duplex) systems.

In addition, in the following description of the disclosure, detailed descriptions of related functions or constitutions will be omitted in the case that such descriptions are deemed to unnecessarily obscure the gist of the disclosure. The terminology used herein is defined in view of functions in the disclosure, and may be varied depending on the intent of the user/operator, practices, and the like. Therefore, the definition thereof is to be made based on the overall context of the disclosure.

In the following description of the disclosure, higher layer signaling may refer to signaling corresponding to at least one among the following signaling, or a combination of one or more thereof:
Master information block (MIB);
System information block (SIB) or SIB X (X=1, 2, . . . );
Radio resource control (RRC); and/or
Medium access control (MAC) control element (CE).

In addition, L1 signaling may refer to signaling corresponding to at least one among signaling methods using the following physical layer channel or signaling, or a combination of one or more thereof:
Physical Downlink Control Channel (PDCCH);
Downlink Control Information (DCI);
UE-specific DCI;
Group common DCI;
Common DCI;
Scheduling DCI (for example, DCI used for the purpose of scheduling downlink or uplink data);
Non-scheduling DCI (for example, DCI not used for the purpose of scheduling downlink or uplink data);
Physical Uplink Control Channel (PUCCH); and/or
Uplink Control Information (UCI).

Hereafter, determining the priority between A and B in the disclosure may be variously mentioned such as selecting one having a higher priority according to a predefined priority rule and performing a corresponding operation or omitting or dropping an operation on one having a lower priority

As used herein, the term “slot” may generally refer to a specific time unit corresponding to a transmit time interval (TTI), may specifically refer to a slot used in a 5G NR system, or may refer to a slot or a subframe used in a 4G LTE system.

Hereinafter, the above examples may be described through multiple embodiments in the disclosure, but they are not independent of each other, and one or more embodiments may be applied simultaneously or in combination.

### First Embodiment: CSI Report and CSI Resource Configuration Method During SBFD Configuration and Operation

As an embodiment of the disclosure, a method for configuring CSI report and CSI resource in a UE and a base station is described. This embodiment may be operated in combination with other embodiments in the disclosure.

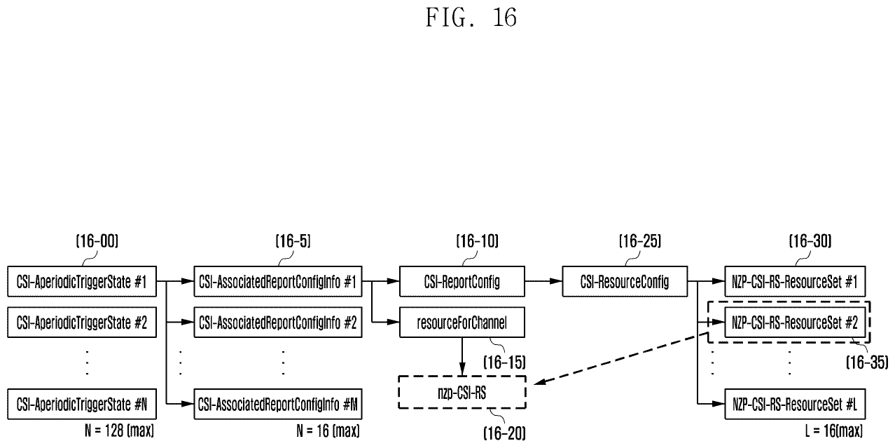

FIG. 16 illustrates an aperiodic CSI report signaling structure that a UE may be configured through higher layer signaling according to an embodiment of the disclosure.

A UE may be configured with up to 128 CSI-AperiodicTriggerState 16-00, which are higher layer signalings, from a base station, and one CSI-AperiodicTriggerState may be mapped to one code point of a CSI request field in DCI. The UE may be configured by the base station the higher layer signaling reportTriggerSize related to the number of code points of the CSI request. The reportTriggerSize may be an integer between 0 and 6. When this value is NTs, the UE may expect that there are 2^{NTs} code points for the CSI request field.
When all bits of the CSI request field in the DCI received by the UE are 0, the UE may consider that there is no information to trigger aperiodic CSI report transmission (which may additionally indicate aperiodic CSI-RS reception).
When the number of CSI-AperiodicTriggerStates configured to the UE through higher layer signaling is greater than 2NTs−1, the UE may select 2NTs−1 of the plurality of CSI-AperiodicTriggerStates configured through higher layer signaling by receiving MAC-CE from the base station.
When the number of CSI-AperiodicTriggerStates configured to the UE through higher layer signaling is less than or equal to 2NTs−1, the UE may use the plurality of CSI-AperiodicTriggerStates configured through higher layer signaling by sequentially connecting them to the code points in each CSI request field. For example, when the UE is configured with 32 CSI-AperiodicTriggerStates through higher layer signaling and is configured with the higher layer signaling reportTriggerSize as 6, i.e., when 26−1=63 code points in the CSI request field may be used for the aperiodic CSI report, the UE may map the CSI-AperiodicTriggerStates to code points of the CSI request in ascending order in the order of the CSI-AperiodicTriggerStates, since the number of the configured CSI-AperiodicTriggerStates is less than the number of code points in the CSI request field.

The UE may be configured with one or more, but not more than 16, CSI-AssociatedReportConfigInfos within the higher layer signaling CSI-AperiodicTriggerState (16-05). One CSI-AssociatedReportConfigInfo configuration information may include one CSI-ReportConfig 16-10, and the CSI-ReportConfig may include CSI-ResourceConfig 16-25, and in the case of aperiodic CSI report, one or more, but not more than 16, NZP-CSI-RS-ResourceSets 16-30 may be included in the CSI-ResourceConfig. In addition, the CSI-AssociatedReportConfigInfo configuration information may include resourceForChannel 16-15, and through a parameter called nzp-CSI-RS 16-20 that may be configured through the corresponding parameter, one of the plurality of NZP-CSI-RS-ResourceSets that may be included in the CSI-ResourceConfig for an aperiodic CSI report may be selected. That is, even if an aperiodic CSI report is associated with a plurality of NZP-CSI-RS-ResourceSets, one aperiodic CSI-RS resource set associated with one aperiodic CSI report configuration may be considered for one CSI-AssociatedReportConfigInfo.

The following describes the association between a CSI report and a CSI-RS resource set according to the time domain behavior of the CSI report and the CSI-RS resource.
When considering a periodic CSI report, the UE may expect that there may be only one periodic CSI-RS resource set that may be associated and used.
When considering a semi-persistent CSI report, the UE may expect that there may be only one periodic or semi-persistent CSI-RS resource set that may be associated and used.
When considering an aperiodic CSI report, if the aperiodic CSI report is associated with a periodic and semi-persistent CSI-RS resource set, the UE may expect/consider that the number of NZP-CSI-RS-ResourceSets that may be included in the higher layer signaling CSI-ResourceConfig may be limited to 1, and if the aperiodic CSI report is associated with an aperiodic CSI-RS resource set, for one CSI-AssociatedReportConfigInfo, one aperiodic CSI-RS resource set associated with one aperiodic CSI report configuration may be selected and considered through the higher layer signaling resourceForChannel, even if the number of NZP-CSI-RS-ResourceSets that may be included in the higher layer signaling CSI-ResourceConfig may be multiple, with a maximum of 16.

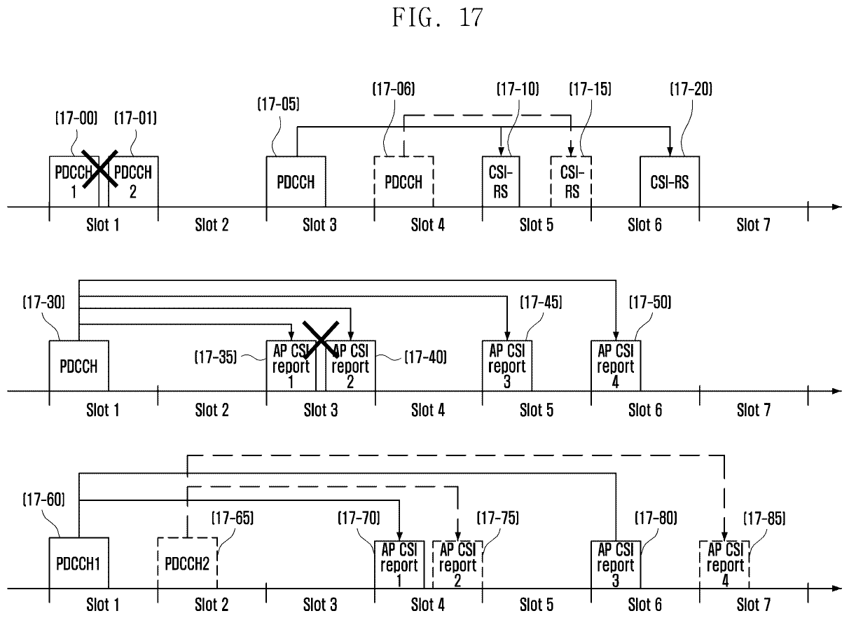

FIG. 17 illustrates an aperiodic CSI report and aperiodic CSI-RS triggering situations and constraints according to an embodiment of the disclosure.

A UE may not expect to receive a plurality of DCIs having CSI request fields including information that triggers aperiodic CSI report transmission (in which aperiodic CSI-RS reception may be additionally indicated) in a slot in a cell. Accordingly, when both PDCCH 1 17-00 and PDCCH 2 17-01 have CSI request fields including information that triggers aperiodic CSI report transmission (in which aperiodic CSI-RS reception may be additionally indicated), the UE may not expect to receive both PDCCHs 17-00, 17-01 in a slot (slot 1). Therefore, when the base station wants to transmit to the UE a plurality of PDCCHs having CSI request fields including information that triggers aperiodic CSI report transmission (in which aperiodic CSI-RS reception may be additionally indicated), the base station may transmit to the UE the plurality of PDCCHs in different slots. For example, when two PDCCHs 17-05, 17-06 are transmitted in different slots (slots 3 and 4), the UE may receive each of the PDCCHs 17-05, 17-06 in two different slots (slots 3 and 4). When a UE receives a DCI having a CSI request field including information triggering aperiodic CSI report transmission (in which aperiodic CSI-RS reception may be additionally indicated) in a particular slot within the same cell group, the UE may not expect to receive another DCI having a CSI request field including information triggering aperiodic CSI report transmission (in which aperiodic CSI-RS reception may be additionally indicated) in any other slot overlapping with the corresponding slot within the corresponding cell group.

The UE may transmit to the base station, through the UE capability report, constraints on the number of CSI-RS resources that may be activated simultaneously for each cell and constraints on the number of CSI-RS ports that may be activated simultaneously for each cell. For example, the UE may report to the base station a natural number from 1 to 32 as the number of CSI-RS resources that may be activated simultaneously for each cell. For example, the UE may report to the base station a multiple of 8 from 8 to 128 as the number of CSI-RS ports that may be activated simultaneously for each cell. Whether the UE receives a plurality of aperiodic CSI-RS resources in one slot or one aperiodic CSI-RS resource for each slot, the UE may receive aperiodic CSI-RS resources 17-10, 17-15, and 17-20 triggered through the PDCCH from the base station under the constraints on the number of CSI-RS resources and the number of CSI-RS ports.

Within a cell, the UE does not expect a plurality of aperiodic CSI reports triggered through a single PDCCH to be transmitted in the same slot. When the UE is triggered for aperiodic CSI report 1 17-35, aperiodic CSI report 2 17-40, aperiodic CSI report 3 17-45, and aperiodic CSI report 4 17-50 from a single PDCCH 17-30, and in the case of being triggered from one PDCCH (17-30) for a plurality of CSI reports, such as aperiodic CSI report 1 17-35 and aperiodic CSI report 2 17-40, the UE may not expect to be triggered in a single slot (slot 3), and may be allowed to be triggered in different slots (slots 5, 6), respectively, such as aperiodic CSI report 3 17-45 and aperiodic CSI report 4 17-50.

The UE may allow both a case where CSI reports triggered from different PDCCHs, for example, aperiodic CSI report 1 17-70 triggered from PDCCH 1 17-60 and aperiodic CSI report 2 17-75 triggered from PDCCH 2 17-65, exist in the same slot (slot 4), or a case where only one of each CSI report exists in each slot (slots 6 and 7) such as aperiodic CSI report 3 17-80 triggered from PDCCH 1 17-60 and aperiodic CSI report 2 17-85 triggered from PDCCH 2 17-65.

Meanwhile, when a UE connected to a base station operating in SBFD is configured with SBFD-related higher layer signaling from the base station, the UE may receive a downlink channel and signal in a downlink slot and a downlink subband within the SBFD slot. In this case, the channel states of the downlink slot and the downlink subband within the SBFD slot may be different, and therefore, measurement of each channel state and CSI calculation according to the channel state need to be performed individually. To this end, the UE and the base station may define how to receive CSI-RS so that they can estimate channels for the downlink slot and the downlink subband within the SBFD slot, and may also define how to report the CSI calculated based on the same. That is, according to an embodiment of the disclosure, a CSI-RS transmission/reception scheme for channel estimation for a downlink subband within the SBFD slot and a CSI reporting scheme based on the same may be provided. Below, a definition scheme for how to receive the above-described CSI-RS and a definition scheme for how to calculate and report CSI based on the same are described.

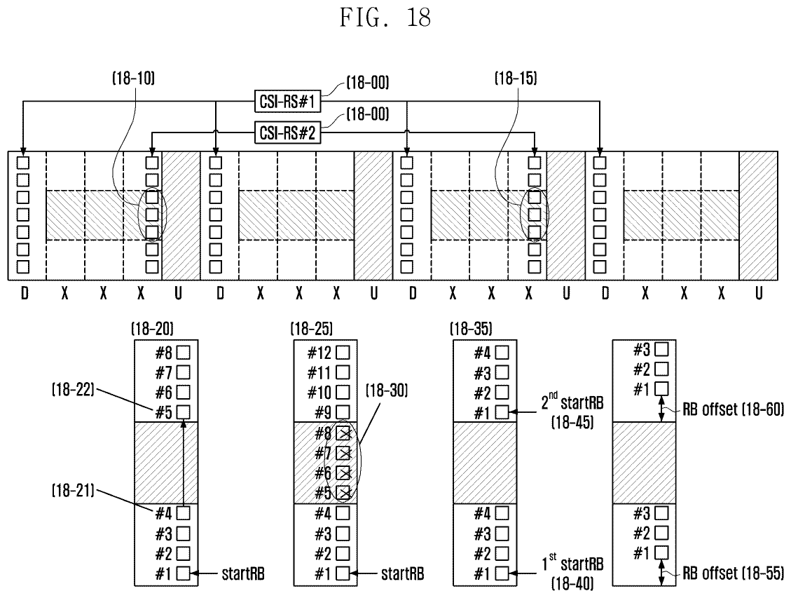

FIG. 18 illustrates a CSI-RS reception scheme considering SBFD according to an embodiment of the disclosure.

A UE may use individual CSI-RSs for channel estimation for a downlink slot and channel estimation for a downlink subband within an SBFD slot, and may use a combination of at least one of the following methods for this purpose.

### [Method R1]

A UE may be individually configured by a base station with a first CSI-RS 18-00 that may be received in a downlink slot and a second CSI-RS 18-05 that may be received in a downlink subband within an SBFD slot. In FIG. 18, D represents a downlink slot, X represents an SBFD slot, and U represents an uplink slot.

When the first CSI-RS is a periodic or semi-persistent CSI-RS, the UE may expect to be configured by the base station such that the periodicity of the first CSI-RS is X times the periodicity of the SBFD slot (wherein X may be a natural number or a rational number such as ½ or ⅓. When X is a rational number, it may denote that the periodicity of the SBFD slot is a multiple of the periodicity of the periodic or semi-persistent CSI-RS), and may expect that the periodic or semi-persistent CSI-RS is received only in the downlink slot. For example, the UE may be configured with the periodicity of the SBFD slot format as 5 slots, and in the same manner, may be configured with the periodicity of the first CSI-RS as 5 slots (18-00). In this case, X may be 1.

Similarly, when the second CSI-RS is a periodic or semi-persistent CSI-RS, the UE may expect to be configured from the base station such that the periodicity of the second CSI-RS is X times the periodicity of the SBFD slot (wherein X may be a natural number or a rational number such as ½ or ⅓. When X is a rational number, it can denote that the periodicity of the SBFD slot is a multiple of the periodicity of the periodic or semi-persistent CSI-RS), and may expect to be configured that the periodic or semi-persistent CSI-RS is received only in the SBFD slot. For example, the UE may be configured with the periodicity of the SBFD slot format as 5 slots, and may be configured with the periodicity of the second CSI-RS as 10 slots (18-00). In this case, X may be 2. By constraining the periodicity of the CSI-RS in this way, the UE can prevent a situation in which the first CSI-RS is received in the SBFD slot or the second CSI-RS is received in the downlink slot.

In another way, the UE does not expect that the periodicity of the first CSI-RS and the second CSI-RS have any constraints with the periodicity of the SBFD slot, and in the case of the periodicity where the first CSI-RS is received in an SBFD slot, or if the case of the periodicity where the second CSI-RS is received in a downlink slot, the UE may not expect to receive the corresponding CSI-RS. That is, the UE may expect that the first CSI-RS and the second CSI-RS are always received in the downlink slot and the SBFD slot, respectively.

When the UE receives the second CSI-RS in the SBFD slot (18-05), the UE may utilize a combination of at least one of the following methods for processing the second CSI-RS in the uplink subband 18-10, 18-15.

### [Method R1-1]

When receiving the second CSI-RS in an SBFD slot, the UE may be configured from the base station with 1 startRB and 1 nrofRBs as higher layer signaling, and may expect that CSI-RS resource allocation may be performed for a number of contiguous RBs equal to nrofRBs starting from the position of starting RB which can be identified through the startRB. In this case, when some of the resource allocation portions for the second CSI-RS overlap with an uplink subband, the UE may expect that resource allocation for the second CSI-RS may not be performed in the position overlapping with the uplink subband, and may expect that a number of RBs equal to nrofRBs may be allocated only for the downlink subband (18-20). Therefore, after the resource allocation of the CSI-RS allocated to the highest RB position 18-21 to which the second CSI-RS can be allocated among the frequency positions of the downlink subband that is lower than the lowest RB position among the uplink subbands, the UE may expect that the resource allocation of the next CSI-RS may be performed to the lowest RB position 18-22 to which the second CSI-RS can be allocated among the frequency positions of the downlink subband that is higher than the highest RB position among the uplink subbands.

### [Method R1-2]

When receiving the second CSI-RS in an SBFD slot, the UE may be configured with 1 startRB and 1 nrofRBs from the base station, and may expect that the resource allocation for the CSI-RS may be performed for a number of contiguous RBs equal to nrofRBs starting from the position of starting RB that may be identified through the startRB (18-25). In this case, if some of the resource allocation portions for the second CSI-RS overlap with the uplink subband, the UE may expect that the second CSI-RS may not be received at the location overlapping with the uplink subband. Therefore, the UE may expect that the second CSI-RS is allocated for RBs as many as the number of contiguous nrofRBs including the uplink subband starting from the position of starting RB that may be indicated through the startRB, and the CSI-RS resources 18-30 within the uplink subband among the allocated CSI-RS resources may be ignored.

### [Method R1-3]

When receiving the second CSI-RS in an SBFD slot, the UE may be configured with two startRBs and two nrofRBs from the base station, and may expect that resource allocation for the CSI-RS may be performed for a number of contiguous RBs as many as each nrofRBs from each starting RB position that may be identified through each startRB. In this case, the UE may expect that when some of the resource allocation portions for the second CSI-RS overlap with the uplink subband, the second CSI-RS may not be received at the position overlapping with the uplink subband (18-35). For example, the UE may expect that CSI-RS resource allocation is performed for a number of contiguous RBs that may be indicated through the first nrofRBs, starting from the position of the first starting RB 18-40 that may be indicated through the first startRB, and similarly, it may expect that CSI-RS resource allocation is performed for a number of contiguous RBs that may be indicated through the second nrofRBs, starting from the position of the second starting RB 18-45 that may be indicated through the second startRB.

In this case, it may not be excluded that only 1 nrofRBs is configured instead of two, and that the number of contiguous RBs configured by only one is commonly applied to the first and second startRBs and used for CSI-RS resource allocation. In addition, instead of being configured with the above two startRBs and two nrofRBs, 1 RB offset and 1 nrofRBs may be configured, and 1 RB offset may be a value that is commonly applied to the RB offset 18-55 from the starting RB of the downlink bandwidth part to the starting RB position to which the CSI-RS resource is allocated or the RB offset 18-60 from the last RB of the uplink subband to the starting RB position to which the CSI-RS resource is allocated, and nrofRBs may denote the number of contiguous RBs from the corresponding start position and may be commonly applied to both downlink subbands. Similarly, the above 1 RB offset may be individually defined into two values through two different higher layer signalings, and each RB offset value may be applied from the starting RB of the downlink bandwidth part or from the last RB of the uplink subband.

### [Method R1-4]

The UE may be configured with two CSI-RSs that may be received in the SBFD slot (for example, the second CSI-RS and the third CSI-RS), it can be assumed that the two CSI-RSs are connected to each other through higher layer signaling, and such assumption may mean that the UE calculates and reports one CSI using the channel measured by receiving the two connected CSI-RSs. In other words, when the UE measures the channel status for the downlink subband within the SBFD slot and reports CSI, it can be considered that one CRI (CSI-RS Resource Indicator) is included. In this case, the second CSI-RS and the third CSI-RS may denote CSI-RSs that may be transmitted in the downlink subband at a low frequency position and the downlink subband at a high frequency position, respectively.

Like the above-mentioned connected second CSI-RS and third CSI-RS, the UE may be configured with one or more pairs of connected CSI-RS from the base station, and the multiple pairs of the connected CSI-RS may be used for the purpose of checking the performance for different beamforming by applying different beamforming to each pair when reporting CSI for downlink subbands within the SBFD slot. For example, the UE may be configured with first CSI-RS pair in which the second CSI-RS and the third CSI-RS are connected to each other from the base station, and similarly, may be configured with a second CSI-RS pair in which the fourth CSI-RS and the fifth CSI-RS are connected to each other from the base station, and the UE may receive the first CSI-RS pair and the second CSI-RS pair within the SBFD slot, compare the performances of each, and report CSI for one or more CSI-RS pairs among them to the base station.

### [Method R1-5]

The UE may be configured with two CSI-RSs that may be received in the SBFD slot (for example, the second CSI-RS and the third CSI-RS), and unlike the above [Method R1-4], the two CSI-RSs may not be connected to each other through higher layer signaling. In this case, the second CSI-RS and the third CSI-RS may denote CSI-RSs that may be transmitted in a downlink subband at a low frequency position and a downlink subband at a high frequency position, respectively. This assumption may mean that, upon receiving the second CSI-RS and the third CSI-RS, the UE may report one or more of the CSI calculated based on the channel estimated by receiving the second CSI-RS, the CSI calculated based on the channel estimated by receiving the third CSI-RS, and the CSI calculated by considering the channel estimated by receiving the second CSI-RS and the third CSI-RS together.

For example, the UE may be configured with a second CSI-RS that may be received in a downlink subband at a low frequency position, and a third CSI-RS and a fourth CSI-RS that may be received in a downlink subband at a high frequency position. In this case, the UE may correspond the first CRI to the CSI calculated by receiving the second CSI-RS, may correspond the second CRI to the CSI calculated by receiving the third CSI-RS, may correspond the third CRI to the CSI calculated by receiving the fourth CSI-RS, and may correspond the fourth CRI to the CSI calculated by considering the second CSI-RS and the third CSI-RS together. In this case, the UE may report to the base station a CSI that includes at least one of the first CRI to the fourth CRI.

### [Method R2]

The UE may be configured with one common CSI-RS from the base station for channel estimation for a downlink slot and channel estimation for a downlink subband within an SBFD slot. The UE may utilize a combination of at least one of the following methods to apply the reception method differently in the case where the corresponding CSI-RS is received in a downlink slot and in the case where the corresponding CSI-RS is received in an SBFD slot, based on the configuration for the corresponding common CSI-RS.

### [Method R2-1]

The UE may be configured with the above common CSI-RS from the base station, and when the corresponding CSI-RS is received in a downlink slot, the UE may expect that the CSI-RS resource is allocated for a number of contiguous RBs from the starting RB based on 1 startRB and 1 nrofRBs configured in the corresponding CSI-RS resource.

The UE may be configured with the above common CSI-RS from the base station, and when the corresponding CSI-RS is received in an SBFD slot, the UE may be configured with 1 startRB and 1 nrofRBs from the base station, and may expect that CSI-RS resource allocation may be performed for a number of contiguous RBs equal to nrofRBs starting from the position of starting RB that may be identified through the startRB. In this case, the UE may expect that when some of the resource allocation portions for the CSI-RS overlap with an uplink subband, resource allocation for the corresponding CSI-RS may not be performed in the position overlapping with the uplink subband, and may expect that a number of RBs equal to nrofRBs may be allocated only for the downlink subband (18-20). Therefore, after the resource allocation of a CSI-RS allocated to the highest RB position 18-21 to which the corresponding CSI-RS can be allocated among the frequency positions of a downlink subband that is lower than the lowest RB position among the uplink subbands, the UE may expect the resource allocation of the next CSI-RS to be performed to the lowest RB position 18-22 to which the corresponding CSI-RS can be allocated among the frequency positions of a downlink subband that is higher than the highest RB position among the uplink subbands.

### [Method R2-2]

The UE may be configured with the above common CSI-RS from the base station, and when the corresponding CSI-RS is received in a downlink slot, the UE may expect that the CSI-RS resource is allocated for a number of contiguous RBs starting from the starting RB based on 1 startRB and 1 nrofRBs configured in the corresponding CSI-RS resource.

The UE may be configured with the above common CSI-RS from the base station, and when the corresponding CSI-RS is received in an SBFD slot, the UE may be configured with 1 startRB and 1 nrofRBs from the base station, and it may expect that the resource allocation for the CSI-RS is performed for a number of contiguous RBs equal to nrofRBs starting from the position of starting RB that may be identified through the startRB (18-25). In this case, when some of the resource allocation portions for the corresponding CSI-RS overlap with the uplink subband, the UE may expect that the corresponding CSI-RS may not be received at the position overlapping with the corresponding uplink subband. Therefore, the UE may expect that the corresponding CSI-RS is allocated for a number of RBs equal to that of contiguous nrofRBs including the uplink subband, starting from the position of starting RB that may be indicated by startRB, and the CSI-RS resources 18-30 within the uplink subband among the allocated CSI-RS resources may be ignored.

### [Method R2-3]

The UE may be configured with the above common CSI-RS from the base station, and through the corresponding CSI-RS resource, it may be configured with 2 startRBs and 2 nrofRBs, which are higher layer signalings, respectively. In this case, when the UE receives the corresponding CSI-RS in the downlink slot, it may expect that the CSI-RS resource is allocated for a number of contiguous RBs starting from the starting RB based on the first startRB and the first nrofRBs configured in the corresponding CSI-RS resource.

The UE may be configured with the above common CSI-RS from the base station, and when the corresponding CSI-RS is received in an SBFD slot, here, the UE may perform resource allocation for the CSI-RS for a number of contiguous RBs equal to each nrofRBs starting from the position of each starting RB that may be identified through each startRB among the two startRBs and two nrofRBs configured by the base station. In this case, when some of the resource allocation portions for the corresponding CSI-RS overlap with the uplink subband, the UE may expect that the corresponding CSI-RS is not received at the position overlapping with the corresponding uplink subband (18-35). For example, the UE may expect that CSI-RS resource allocation is performed for a number of contiguous RBs that may be indicated through the first nrofRBs starting from the position of the first starting RB 18-40 that may be indicated through the first startRB, and similarly, it may expect that CSI-RS resource allocation is performed for a number of contiguous RBs that may be indicated through the second nrofRBs starting from the position of the second starting RB 18-45 that may be indicated through the second startRB.

In this case, it may not be excluded that only 1 nrofRBs is configured instead of two, and that the number of contiguous RBs configured by only one is commonly applied to the first and second startRBs and used for CSI-RS resource allocation. In addition, instead of being configured with the above two startRBs and two nrofRBs, 1 RB offset and 1 nrofRBs may be configured, and 1 RB offset may be a value commonly applied to the RB offset 18-55 from the starting RB of the downlink bandwidth part to the position of starting RB to which the CSI-RS resource is allocated or the RB offset 18-60 from the last RB of the uplink subband to the position of starting RB to which the CSI-RS resource is allocated, and nrofRBs may denote the number of contiguous RBs from the corresponding start position and may be commonly applied to both downlink subbands. Similarly, the above 1 RB offset may be defined as two values individually through two different higher layer signalings, and each RB offset value may be applied from the starting RB of the downlink bandwidth part or from the last RB of the uplink subband.

The UE may be notified by the base station of a combination of at least one of [Method R1], [Method R2], [Method R1-1] to [Method R1-5], [Method R2-1] to [Method R2-3] through a combination of at least one of higher layer signaling, MAC-CE signaling, and L1 signaling, or may expect that a combination of at least one of [Method R1], [Method R2], [Method R1-1] to [Method R1-5], [Method R2-1] to [Method R2-3] is fixedly defined in the specification. Additionally, when the UE is notified of a combination of specific one or more methods from the base station through a combination of at least one of higher layer signaling, MAC-CE signaling, and L1 signaling, it may mean that the UE cannot support other combinations of the specific one or more methods. For example, when the UE receives a configuration for an SBFD slot, the UE may expect that the above [Method R1-1] is fixedly defined in the specification for the method of operating the CSI-RS. As another example, the UE may be notified of the above [Method R2-1] from the base station through a combination of at least one of higher layer signaling, MAC-CE signaling, and L1 signaling, and in this case, the UE may consider that it has been notified by the base station that the above [Method R1-1] is not supported.

The UE may report to the base station as the UE capability whether a combination of at least one of the above [Method R1], [Method R2], [Method R1-1] to [Method R1-5], and [Method R2-1] to [Method R2-3] is supported. In this case, when the UE reports to the base station as the UE capability that a combination of specific one or more methods can be supported, the UE may consider that it has reported that other combinations of the specific one or more methods cannot be supported. For example, the UE may report to the base station whether the above [Method R1-1] can be supported. As another example, the UE may report to the base station that the above [Method R2-2] can be supported, and such UE capability report may mean that the UE cannot not support [Method R1-1].

The UE may be notified by the base station through a combination of at least one of higher layer signaling, MAC-CE signaling, and L1 signaling so that the above-described methods can be similarly applied and operated for reference signals for interference measurement (for example, CSI-IM resource or/and CSI-RS for interference measurement), or may use a method fixed in the specification. In this case, the UE may expect the same method to be applied to the CSI-RS resource for channel measurement and the reference signal for interference measurement (e.g., CSI-IM resource and/or CSI-RS for interference measurement), or different methods may be applied.

For example, when the UE has received a configuration for a CSI-RS resource based on the above [Method R1], it is possible to be configured with individual CSI-IM resources for interference measurement in a downlink slot and interference measurement for a downlink subband within the SBFD slot, and when the CSI-IM resource is configured for interference measurement for a downlink subband within the SBFD slot based on the above [Method R1-1], the UE may be configured with 1 startRB and 1 nrofRBs, and may expect that CSI-IM resource allocation may be performed for a number of contiguous RBs equal to nrofRBs starting from the position of starting RB that may be identified through the startRB. In this case, when some of the resource allocation portions for the corresponding CSI-IM overlap with an uplink subband, the UE may expect that resource allocation for the CSI-IM may not be performed in the position overlapping with the corresponding uplink subband, and may expect that a number of RBs equal to nrofRBs may be allocated only for the downlink subband. In this case, the UE may assume that a one-to-one connection is established between the CSI-RS resource and the CSI-IM resource, and is used to calculate CSI.

As another example, when the UE has received a configuration for the CSI-RS resource based on the above [Method R1-4], the UE may expect to be configured for the CSI-IM resource also based on the above [Method R1-4]. More specifically, when the UE has been configured with a second CSI-RS resource and a third CSI-RS resource, which are connected to each other by higher layer signaling, for channel measurement for the downlink subband within the SBFD slot based on the above [Method R1-4], the UE may be configured with a second CSI-IM resource and a third CSI-IM resource for interference measurement for the downlink subband within the SBFD slot, and may be configured that the two CSI-IM resources are connected by higher layer signaling. In this case, the UE may assume that a one-to-one connection is established between two CSI-RS resources connected by higher layer signaling to each other, and two CSI-IM resources connected by higher layer signaling to each other, and is used to calculate CSI.

As another example, when the UE has received a configuration for a CSI-RS resource based on the above [Method R1-5], that is, when a second CSI-RS resource for measuring a channel of a downlink subband at a low frequency position and a third CSI-RS resource for measuring a channel of a downlink subband at a high frequency position are separately configured by the base station for channel measurement for a downlink subband within an SBFD slot and there is no connection relationship based on higher layer signaling between the two CSI-RS resources, it may be possible for the UE to be configured with one first CSI-IM resource based on the above [Method R1-1] for the CSI-IM resource. In this case, the UE may assume that each CSI-RS resource and the first CSI-IM resource are connected and used to calculate CSI when calculating the first CSI based on a channel of a downlink subband at a lower frequency position calculated based on the second CSI-RS resource, the second CSI based on a channel of a downlink subband at a higher frequency position calculated based on the third CSI-RS resource, and the third CSI based on channels of two downlink subbands calculated based on the second CSI-RS resource and the third CSI-RS resource. That is, when the UE calculates the first CSI, the UE may assume that the second CSI-RS resource and the first CSI-IM resource are connected one-to-one, and when calculating the second CSI, the UE may assume that the third CSI-RS resource and the first CSI-IM resource are connected one-to-one, and when calculating the third CSI, the UE may assume that the second and the third CSI-RS resources and the first CSI-IM resource are connected 2:1.

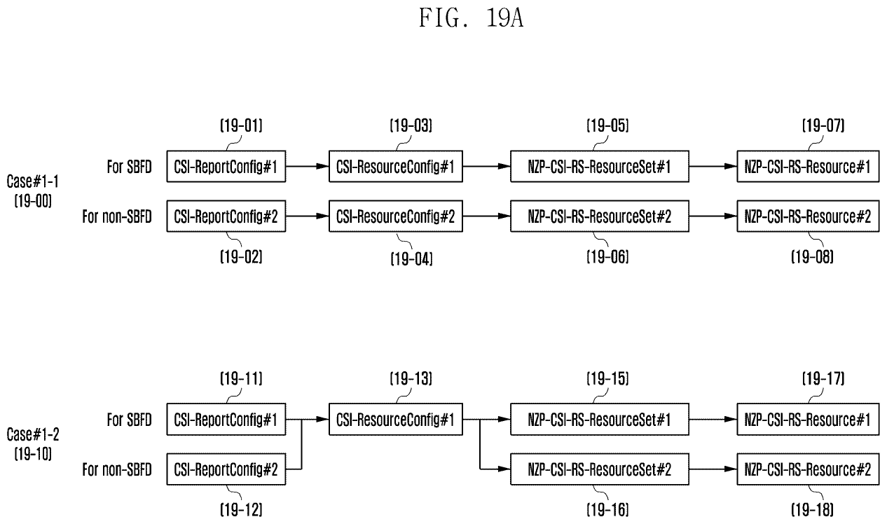

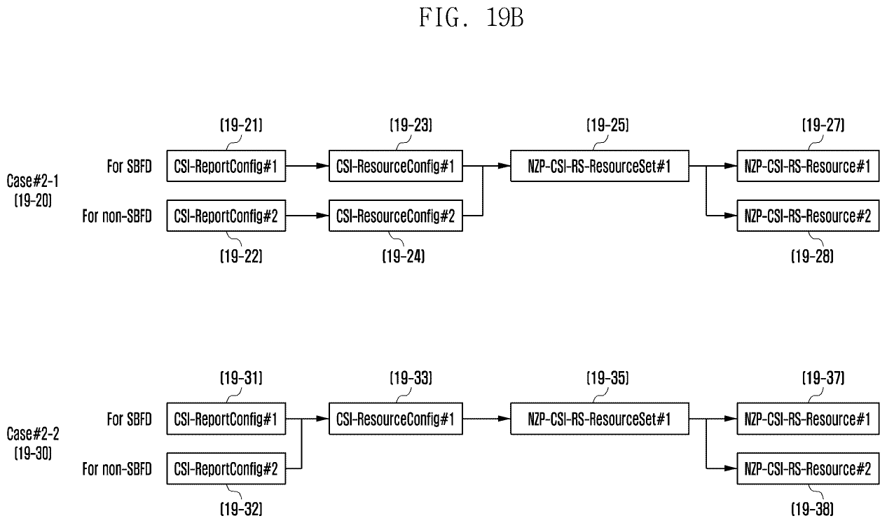

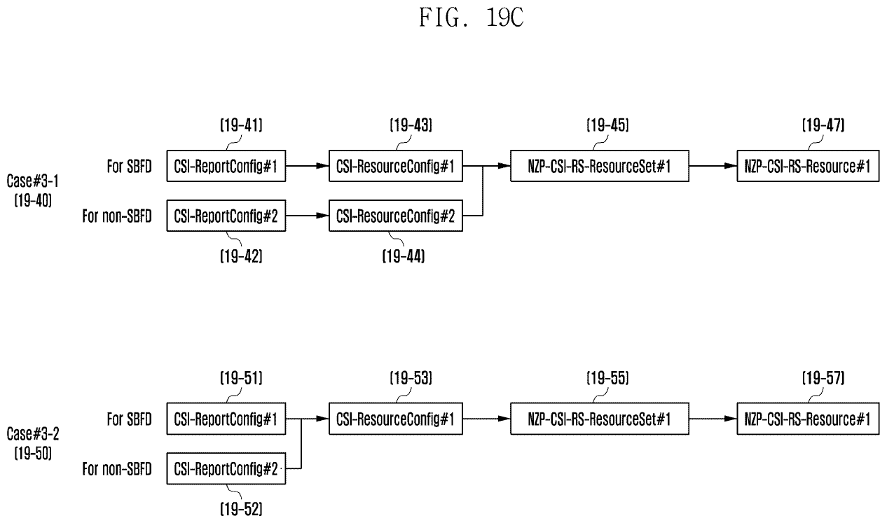

FIG. 19A, FIG. 19B, and FIG. 19C illustrate a structure of higher layer signaling related to CSI reporting considering SBFD according to an embodiment of the disclosure.

Using the above-described CSI-RS configuration and reception method, a UE may estimate a channel in a downlink slot and calculate CSI, and may estimate a channel of a downlink subband in an SBFD slot and calculate CSI. When reporting the CSI calculated in this way, a combination of at least one of the following methods may be used.

### [Method C1]

The UE may report the CSI calculated based on the channel estimation in the downlink slot and the CSI calculated based on the channel estimation in the downlink subband within the SBFD slot to the base station based on different higher layer signaling configuration information. For example, the UE may be configured by the base station with a first CSI-ReportConfig, which is a higher layer signaling, to report the CSI calculated based on the channel estimation in the downlink slot, and may be configured by the base station with a second CSI-ReportConfig, which is a higher layer signaling, to report the CSI calculated based on the channel estimation in the downlink subband within the SBFD slot.

As a detailed method for configuring individual CSI reports as such, the UE may utilize a combination of at least one of the following methods. When the UE operates in [Method C1], the UE performs CSI calculation and reporting separately for the downlink slot and the downlink subband within the SBFD slot, so the elements (e.g., CRI, CQI, PMI, RI, etc.) that may be included in the CSI to be reported and the order of the elements may be most similar to the conventional ones, but there is a disadvantage that two higher layer signaling related to CSI reporting should be used.

### [Method C1-1]

Referring to FIG. 19A, the UE may use the first CSI-ReportConfig configured by the base station to report the CSI calculated based on the channel estimation in the downlink slot (19-01), and may use the second CSI-ReportConfig configured by the base station to report the CSI calculated based on the channel estimation in the downlink subband within the SBFD slot (19-02).

In this case, the UE may expect that all CSI-RS related configuration information that may be configured in the first CSI-ReportConfig and the second CSI-ReportConfig are different (19-00). That is, the UE may assume that the first CSI-ResourceConfig 19-03 that may be configured in the first CSI-ReportConfig and the second CSI-ResourceConfig 19-04 that may be configured in the second CSI-ReportConfig have different CSI-ResourceConfigIds.

In addition, the UE may assume that the first NZP-CSI-RS-ResourceSet 19-05 that may be configured in the first CSI-ResourceConfig and the second NZP-CSI-RS-ResourceSet 19-06 that may be configured in the second CSI-ResourceConfig have different NZP-CSI-RS-ResourceSetIds.

In addition, the UE may assume that one or more NZP-CSI-RS-Resources 19-07 that may be configured in the first NZP-CSI-RS-ResourceSet and one or more NZP-CSI-RS-Resources 19-08 that may be configured in the second NZP-CSI-RS-ResourceSet are different from each other.

In addition, the UE may also consider that the CSI-ResourceConfigs 19-13 configured in the first CSI-ReportConfig 19-11 and in the second CSI-ReportConfig 19-12 are the same (19-10).
When the UE is configured with the first CSI-ReportConfig 19-11 or the second CSI-ReportConfig 19-12 for periodic CSI reporting, the UE may expect that two different NZP-CSI-RS-ResourceSets are configured within the CSI-ResourceConfig commonly configured within the first CSI-ReportConfig 19-11 or the second CSI-ReportConfig 19-12 (for example, the first NZP-CSI-RS-ResourceSet 19-15 and the second NZP-CSI-RS-ResourceSet 19-16). In addition, the UE may be notified by the base station through specific higher layer signaling (which may be, for example, the higher layer signaling (or higher layer signaling parameter, hereinafter the same) that may be included in the first CSI-ReportConfig) about which NZP-CSI-RS-ResourceSet among the two different NZP-CSI-RS-ResourceSets in the CSI-ResourceConfig may be associated with the CSI reporting to be performed through the corresponding first CSI-ReportConfig and used as a reference signal. In addition, the UE may be notified by the base station through specific higher layer signaling (which may be, for example, the higher layer signaling that may be included in the second CSI-ReportConfig) about which NZP-CSI-RS-ResourceSet among the two different NZP-CSI-RS-ResourceSets in the CSI-ResourceConfig may be associated with the CSI reporting to be performed through the corresponding second CSI-ReportConfig and used as a reference signal.
When the UE is configured with the first CSI-ReportConfig 19-11 or the second CSI-ReportConfig 19-12 for semi-persistent CSI reporting, the UE may expect that two different NZP-CSI-RS-ResourceSets are configured within the CSI-ResourceConfig commonly configured within the first CSI-ReportConfig 19-11 or the second CSI-ReportConfig 19-12 (e.g., the first NZP-CSI-RS-ResourceSet 19-15 and the second NZP-CSI-RS-ResourceSet 19-16). In addition, the UE may be notified by the base station about which NZP-CSI-RS-ResourceSet among the two different NZP-CSI-RS-ResourceSets within the CSI-ResourceConfig may be associated with the corresponding CSI reporting and used as a reference signal, through specific higher layer signaling to be included within the first CSI-SemiPersistentOnPUSCH-TriggerState, which is a higher layer signaling including the first CSI-ReportConfig, and may be notified by the base station about which NZP-CSI-RS-ResourceSet among the two different NZP-CSI-RS-ResourceSets within the CSI-ResourceConfig may be associated with the corresponding CSI reporting and used as a reference signal, through specific higher layer signaling to be included the second CSI-SemiPersistentOnPUSCH-TriggerState, which is a higher layer signaling including the second CSI-ReportConfig.
When the UE is configured with the first CSI-ReportConfig 19-11 or the second CSI-ReportConfig 19-12 for aperiodic CSI reporting, the UE may expect that at least two different NZP-CSI-RS-ResourceSets are configured within the CSI-ResourceConfig commonly configured within the first CSI-ReportConfig 19-11 or the second CSI-ReportConfig 19-12 (for example, the first NZP-CSI-RS-ResourceSet 19-15 and the second NZP-CSI-RS-ResourceSet 19-16). In addition, the UE may be notified by the base station about which NZP-CSI-RS-ResourceSet among the at least two different NZP-CSI-RS-ResourceSets within the CSI-ResourceConfig is to be associated with the corresponding CSI reporting and used as a reference signal, through resourceForChannel, which is a higher layer signaling in the first CSI-AssociatedReportConfigInfo, which is a higher layer signaling including the first CSI-ReportConfig, and may be notified by the base station about which NZP-CSI-RS-ResourceSet among the at least two different NZP-CSI-RS-ResourceSets within the CSI-ResourceConfig is to be associated with the corresponding CSI reporting and used as a reference signal, through resourceForChannel, which is a higher layer signaling in the second CSI-AssociatedReportConfigInfo, which is a higher layer signaling including the second CSI-ReportConfig.

When the UE uses the above [Method C1-1] as the higher layer signaling structure for CSI reporting, the UE may use a combination of at least one of [Method R1], [Method R1-1] to [Method R1-5] above as the CSI-RS resource configuration method, wherein the channel measurements for the downlink slot and the channel measurements for the downlink subband within the SBFD slot are based on separate CSI-RS resources.

When the UE operates with [Method C1-1], since the UE may reuse as much of the higher layer signaling structure of conventional CSI reporting that does not take SBFD into account as possible (for example, reusability of the association between CSI-ReportConfig and NZP-CSI-RS-ResourceSet or definition for CRI, etc.), since the individual NZP-CSI-RS-ResourceSet configuration corresponding to CSI calculation and reporting are similar to the conventional ones, but there is a disadvantage in that the higher layer signaling related to CSI reporting and channel measurement can be consumed the most. In addition, for periodic or semi-persistent CSI reporting, the UE may be configured with one NZP-CSI-RS-ResourceSet in one CSI-ResourceConfig conventionally, while for [Method C1-1], at least two NZP-CSI-RS-ResourceSet configurations may be required.

### [Method C1-2]

Referring to FIG. 19B, the UE may use the first CSI-ReportConfig configured by the base station to report the CSI calculated based on the channel estimation in the downlink slot (19-21), and may use the second CSI-ReportConfig configured by the base station to report the CSI calculated based on the channel estimation in the downlink subband within the SBFD slot (19-22).

In this case, the UE may expect that different configuration information regarding reference signals to be used for channel measurement, which are configured in the first CSI-ReportConfig and the second CSI-ReportConfig, are included in the same NZP-CSI-RS-ResourceSet (19-20). That is, the UE may assume that the first CSI-ResourceConfig 19-23 that may be configured in the first CSI-ReportConfig and the second CSI-ResourceConfig 19-24 that may be configured in the second CSI-ReportConfig have different CSI-ResourceConfigIds.

In addition, the UE may assume that the NZP-CSI-RS-ResourceSet 19-25 can be commonly configured in the first CSI-ResourceConfig and the second CSI-ResourceConfig, and that one or more NZP-CSI-RS-Resource 19-27 that may be configured for channel measurement for a downlink slot and one or more NZP-CSI-RS-Resource 19-28 that may be configured for channel measurement for a downlink subband in an SBFD slot are different from each other.

For such an association between CSI-ReportConfig and NZP-CSI-RS-Resource, the UE may be notified by the base station through a combination of at least one of higher layer signaling, MAC-CE signaling, and L1 signaling, or may use a method fixed in the specification. For example, the UE may be configured by the base station with additional higher layer signaling within the higher layer signaling (e.g., CSI-ReportConfig, CSI-AssociatedReportConfigInfo for aperiodic CSI reporting, CSI-SemiPersistentOnPUSCH-TriggerState for semi-persistent CSI reporting) related to the CSI report, and may be notified by the base station about which NZP-CSI-RS-Resource the higher layer signaling (e.g., CSI-ReportConfig, CSI-AssociatedReportConfigInfo for aperiodic CSI reporting, CSI-SemiPersistentOnPUSCH-TriggerState for semi-persistent CSI reporting) related to the corresponding CSI report is associated with, and used for CSI reporting.

In addition, the UE may also consider that CSI-ResourceConfig 19-33 configured in a first CSI-ReportConfig 19-31 and a second CSI-ReportConfig 19-32 are the same (19-30).
When the UE is configured with the first CSI-ReportConfig 19-31 or the second CSI-ReportConfig 19-32 for periodic or semi-persistent CSI reporting, the UE may expect that one NZP-CSI-RS-ResourceSet 19-35 is configured in the CSI-ResourceConfig 19-33 commonly configured in the first CSI-ReportConfig 19-31 or the second CSI-ReportConfig 19-32. In this case, as described above, one or more NZP-CSI-RS-Resources 19-37 that may be configured for channel measurement for a downlink slot and one or more NZP-CSI-RS-Resources 19-38 that may be configured for channel measurement for a downlink subband within the SBFD slot are separately configured in the NZP-CSI-RS-ResourceSet 19-35, so that the UE may assume that, when reporting CSI for the first CSI-ReportConfig 19-31, CSI is calculated based on channel information corresponding to one or more NZP-CSI-RS-Resources 19-37 that may be configured for channel measurement for a downlink slot, and may assume that, when reporting CSI for the second CSI-ReportConfig 19-32, CSI is calculated based on the channel information corresponding to one or more NZP-CSI-RS-Resources 19-38 that may be configured for channel measurement for a downlink subband within the SBFD slot.
When the UE is configured with the first CSI-ReportConfig 19-31 or the second CSI-ReportConfig 19-32 for aperiodic CSI reporting, the UE may expect that at least one NZP-CSI-RS-ResourceSet 19-35 is configured in the CSI-ResourceConfig 19-33 commonly configured in the first CSI-ReportConfig 19-31 or the second CSI-ReportConfig 19-32. Additionally, the UE may be notified by the base station about which NZP-CSI-RS-ResourceSet among the at least one NZP-CSI-RS-ResourceSet within the CSI-ResourceConfig is to be associated with the corresponding CSI reporting and used as a reference signal, through resourceForChannel, which is a higher layer signaling within the first CSI-AssociatedReportConfigInfo, which is a higher layer signaling including the first CSI-ReportConfig, and may be notified by the base station about which NZP-CSI-RS-ResourceSet among the at least one different NZP-CSI-RS-ResourceSet within the CSI-ResourceConfig is to be associated with the corresponding CSI reporting and used as a reference signal, through resourceForChannel, which h is a higher layer signaling within the second CSI-AssociatedReportConfigInfo, which is a higher layer signaling including the second CSI-ReportConfig.

In this case, as described above, one or more NZP-CSI-RS-Resources 19-37 that may be configured for channel measurement for a downlink slot and one or more NZP-CSI-RS-Resources 19-38 that may be configured for channel measurement for a downlink subband within the SBFD slot are separately configured in the NZP-CSI-RS-ResourceSet 19-35, so that the UE may assume that, when reporting CSI for the first CSI-ReportConfig 19-31, CSI is calculated based on channel information corresponding to one or more NZP-CSI-RS-Resources 19-37 that may be configured for channel measurement for a downlink slot, and may assume that, when reporting CSI for the second CSI-ReportConfig 19-32, CSI is calculated based on channel information corresponding to one or more NZP-CSI-RS-Resources 19-38 that may be configured for channel measurement for a downlink subband within the SBFD slot.

When the UE uses the above [Method C1-2] as the higher layer signaling structure for CSI reporting, the UE may use a combination of at least one of [Method R1], [Method R1-1] to [Method R1-5] as a CSI-RS resource configuration method, where channel measurement for downlink slot and channel measurement for downlink subband within SBFD slot are based on separate CSI-RS resources.

When the UE operates in [Method C1-2], the UE utilizes a common NZP-CSI-RS-ResourceSet configuration corresponding to CSI calculation and reporting, so that the higher layer signaling consumption is relatively small, but it is difficult to reuse the higher layer signaling structure used for conventional CSI reporting and measurement, and since NZP-CSI-RS-Resources that are separately configured to be used for different purposes may be included in the common NZP-CSI-RS-ResourceSet, when the definition for conventional CRI is reused, the bit length of CRI included in each CSI report may be relatively wasted.

Therefore, redefinition of the bit length of CRI may be required for this. For example, when a UE is configured with K1 NZP-CSI-RS-Resources for the purpose of measuring a channel in a downlink slot within an NZP-CSI-RS-ResourceSet, and is configured with K2 NZP-CSI-RS-Resources for the purpose of measuring a channel in a downlink subband within an SBFD slot, the UE may determine a bit length of a CRI as ceil(log 2(K1)) and ceil(log 2(K2)), respectively, if the corresponding CRI is included in the CSI report corresponding to the first CSI-ReportConfig and the second CSI-ReportConfig, and in this case, ceil(⋅) may denote a rounding function, and log 2(⋅) may denote a logarithmic function with a base of 2. This may also be the same in the following description of the disclosure.

That is, the bit length is not determined by considering the number of all NZP-CSI-RS-Resources in the NZP-CSI-RS-ResourceSet, which was the definition of the conventional CRI, but the bit length of the CRI can be determined by considering only the number corresponding to each purpose. In addition, in the case of periodic or semi-persistent CSI reporting, the UE can be configured with one NZP-CSI-RS-ResourceSet in the CSI-ResourceConfig conventionally, while for [Method C1-2], at least two NZP-CSI-RS-ResourceSet configurations may be required.

### [Method C1-3]

Referring to FIG. 19C, the UE may use the first CSI-ReportConfig configured by the base station to report the CSI calculated based on the channel estimation in the downlink slot (19-41), and may use the second CSI-ReportConfig configured by the base station to report the CSI calculated based on the channel estimation in the downlink subband within the SBFD slot (19-42).

In this case, the UE may expect that different configuration information regarding the reference signal to be used for channel measurement configured in the first CSI-ReportConfig and the second CSI-ReportConfig are included in the same NZP-CSI-RS-ResourceSet (19-40). That is, the UE may assume that the first CSI-ResourceConfig 19-43 that may be configured in the first CSI-ReportConfig and the second CSI-ResourceConfig 19-44 that may be configured in the second CSI-ReportConfig have different CSI-ResourceConfigIds.

In addition, the UE may assume that the NZP-CSI-RS-ResourceSet 19-45 can be commonly configured in the first CSI-ResourceConfig and the second CSI-ResourceConfig, and may assume that one or more NZP-CSI-RS-Resource 19-47 that may be commonly used for channel measurement for a downlink slot and channel measurement for a downlink subband in an SBFD slot are configured.

In this case, the UE may be notified by the base station about whether to report CSI for a channel in a downlink slot or CSI for a channel in a downlink subband in an SBFD slot when one or more NZP-CSI-RS-Resources that may be commonly used for channel measurement for a downlink slot and channel measurement for a downlink subband within the SBFD slot are associated with a specific CSI report, through a combination of at least one of higher layer signaling, MAC-CE signaling, and L1 signaling, or may use a method fixed in the specification,

For example, the UE may be configured by the base station with additional higher layer signaling within the higher layer signaling (e.g., CSI-ReportConfig, CSI-AssociatedReportConfigInfo for aperiodic CSI reporting, CSI-SemiPersistentOnPUSCH-TriggerState for semi-persistent CSI reporting) related to the CSI reporting, and may be notified about whether the higher layer signaling (e.g., CSI-ReportConfig, CSI-AssociatedReportConfigInfo for aperiodic CSI reporting, CSI-SemiPersistentOnPUSCH-TriggerState for semi-persistent CSI reporting) related to the CSI reporting reports CSI for a channel in a downlink slot or CSI for a channel in a downlink subband within an SBFD slot.

Additionally, the UE may also consider a scheme where the CSI-ResourceConfigs 19-53 configured within a first CSI-ReportConfig 19-51 and a second CSI-ReportConfig 19-52 are the same (19-50).
When the UE is configured with the first CSI-ReportConfig 19-51 or the second CSI-ReportConfig 19-52 for periodic or semi-continuous CSI reporting, the UE may expect that one NZP-CSI-RS-ResourceSet 19-55 is configured within the CSI-ResourceConfig 19-53 commonly configured in the first CSI-ReportConfig 19-51 or the second CSI-ReportConfig 19-52. In this case, since one or more common NZP-CSI-RS-Resources 19-57 are configured in the NZP-CSI-RS-ResourceSet 19-55 as described above for channel measurement for the downlink slot and channel measurement for the downlink subband within the SBFD slot, the UE may assume that CSI is calculated based on the channel information measured in the downlink slot among the channel information measured through the above one or more commonly configured NZP-CSI-RS-Resources 19-57 when reporting CSI for the first CSI-ReportConfig 19-51, and may assume that CSI is calculated based on the channel information measured in the downlink subband within the SBFD slot among the channel information measured through the above one or more commonly configured NZP-CSI-RS-Resources 19-57 when reporting CSI for the second CSI-ReportConfig 19-32.
When the UE is configured with the first CSI-ReportConfig 19-51 or the second CSI-ReportConfig 19-52 for aperiodic CSI reporting, the UE may expect that at least one NZP-CSI-RS-ResourceSet 19-55 is configured in the CSI-ResourceConfig 19-53 commonly configured in the first CSI-ReportConfig 19-51 or the second CSI-ReportConfig 19-52. Additionally, the UE may be notified by the base station about which NZP-CSI-RS-ResourceSet among the at least one NZP-CSI-RS-ResourceSet within the CSI-ResourceConfig is to be associated with the corresponding CSI reporting and used as a reference signal, through resourceForChannel, which is a higher layer signaling within the first CSI-AssociatedReportConfigInfo, which is a higher layer signaling including the first CSI-ReportConfig, and may be notified by the base station about which NZP-CSI-RS-ResourceSet among at least one different NZP-CSI-RS-ResourceSet within the CSI-ResourceConfig is to be associated with the corresponding CSI reporting and used as a reference signal, through resourceForChannel, which is a higher layer signaling within the second CSI-AssociatedReportConfigInfo, which is a higher layer signaling including the second CSI-ReportConfig.

In this case, since one or more common NZP-CSI-RS-Resources 19-57 are configured in the NZP-CSI-RS-ResourceSet 19-55 as described above for channel measurement for the downlink slot and channel measurement for the downlink subband within the SBFD slot, the UE may assume that CSI is calculated based on the channel information measured in the downlink slot among the channel information measured through the above one or more commonly configured NZP-CSI-RS-Resources 19-57 when reporting CSI for the first CSI-ReportConfig 19-51, and may assume that CSI is calculated based on the channel information measured in the downlink subband within the SBFD slot among the channel information measured through the above one or more commonly configured NZP-CSI-RS-Resources 19-57 when reporting CSI for the second CSI-ReportConfig 19-52.

When the UE uses the above [Method C1-3] as the higher layer signaling structure for CSI reporting, the UE may use a combination of at least one of [Method R2], [Method R2-1] to [Method R2-3] as a CSI-RS resource configuration method, where channel measurement for downlink slot and channel measurement for downlink subband within SBFD slot are based on a common CSI-RS resource.

When the UE operates in [Method C1-3], the UE may utilize a common NZP-CSI-RS-Resource and a common NZP-CSI-RS-ResourceSet configuration corresponding to CSI calculation and reporting, so that the higher layer signaling consumption is relatively small, but it is difficult to reuse the higher layer signaling structure used for conventional CSI reporting and measurement, and since a common NZP-CSI-RS-Resource for different purposes may be included in the common NZP-CSI-RS-ResourceSet, the definition of CRI may be maintained, but from the UE's perspective, even though the UE has been configured with one NZP-CSI-RS-Resource, there may be a burden of having to manage the resource as if two NZP-CSI-RS-Resources are configured.

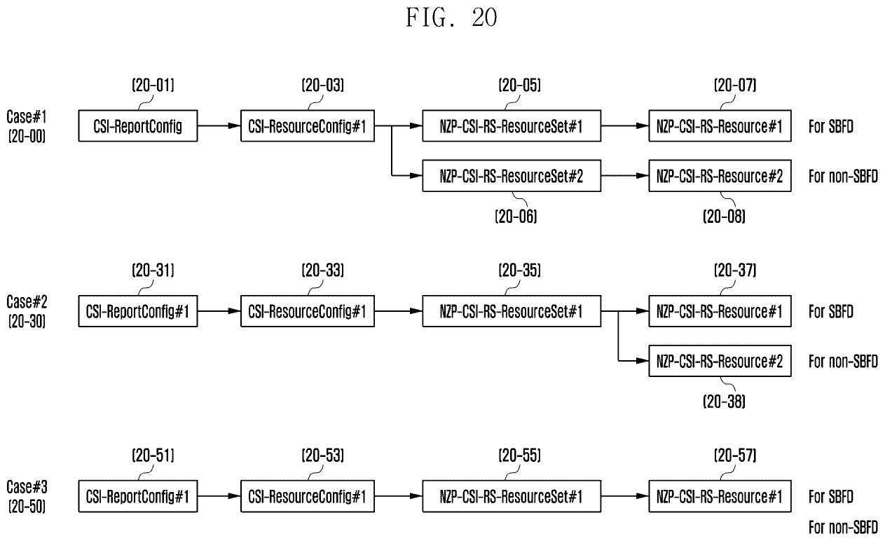

FIG. 20 illustrates another structure of higher layer signaling related to CSI reporting considering SBFD according to an embodiment of the disclosure.

### [Method C2]

The UE may report to the base station CSI calculated based on channel estimation in a downlink slot and CSI calculated based on channel estimation in a downlink subband within the SBFD slot based on common higher layer signaling configuration information. For example, the UE may be configured with a common higher layer signaling, CSI-ReportConfig, from the base station to report CSI calculated based on channel estimation in a downlink slot and CSI calculated based on channel estimation in a downlink subband within the SBFD slot.

As a detailed method for such common CSI reporting configuration, the UE may use a combination of at least one of the following methods. When the UE operates in [Method C2], the UE may perform two different CSI reportings using one higher layer signaling related to CSI reporting, but an additional CSI reporting configuration, trigger, or instruction method may be added in order to report at least one of the CSI corresponding to channel information in the downlink slot and/or the CSI corresponding to channel information of the downlink subband within the SBFD slot, and accordingly, the elements (for example, CRI, CQI, PMI, RI, etc.) that may be included in the CSI report and the order of the elements may be different from the conventional ones.

### [Method C2-1] (20-00)

The UE may use a common CSI-ReportConfig configured by the base station for the CSI report calculated based on the channel estimation in the downlink slot and the CSI report calculated based on the channel estimation in the downlink subband within the SBFD slot (20-01). In addition, the UE may assume that a first NZP-CSI-RS-ResourceSet 20-05 corresponding to a CSI report calculated based on channel estimation in a downlink slot and a second NZP-CSI-RS-ResourceSet 20-06 corresponding to a CSI report calculated based on channel estimation in a downlink subband within an SBFD slot are configured in the CSI-ResourceConfig 20-03 that may be configured in the CSI-ReportConfig. In addition, the UE may assume that one or more NZP-CSI-RS-Resources 20-07 that may be configured in the first NZP-CSI-RS-ResourceSet and one or more NZP-CSI-RS-Resources 20-08 that may be configured in the second NZP-CSI-RS-ResourceSet are different from each other.
When the UE is configured with CSI-ReportConfig 20-01 for periodic CSI reporting, the UE may expect that two different NZP-CSI-RS-ResourceSets are configured within CSI-ResourceConfig 20-03 configured in the corresponding CSI-ReportConfig 20-01 (for example, a first NZP-CSI-RS-ResourceSet 20-05 and a second NZP-CSI-RS-ResourceSet 20-06). In addition, the UE may be notified by the base station about which NZP-CSI-RS-ResourceSet among the two different NZP-CSI-RS-ResourceSets within the CSI-ResourceConfig may be associated with the CSI reporting to be performed through the corresponding CSI-ReportConfig and used as a reference signal, through specific higher layer signaling (for example, the higher layer signaling that may be included within the CSI-ReportConfig). Additionally, the UE may be notified by the base station about which NZP-CSI-RS-ResourceSet among the two different NZP-CSI-RS-ResourceSets within the CSI-ResourceConfig may be associated with the CSI report to be performed through the corresponding CSI-ReportConfig and used as a reference signal, through specific higher layer signaling (for example, the higher layer signaling that may be included in the CSI-ReportConfig). In another way, the UE may include an indicator in the CSI report corresponding to the corresponding CSI-ReportConfig, which distinguishes which NZP-CSI-RS-ResourceSet the CSI corresponds to, for example, the indicator may be a 1-bit or 2-bit CSI-RS resource set indicator. When the CSI-RS resource set indicator is 1 bit, the UE may use 1 bit to express information on which NZP-CSI-RS-ResourceSet among the two NZP-CSI-RS-ResourceSets the CSI corresponds to. When the corresponding CSI-RS resource set indicator is 2 bits, the UE may use 2 bits to express information on whether the CSI corresponds to at least one NZP-CSI-RS-ResourceSet among the two NZP-CSI-RS-ResourceSets. In another way, for periodic CSI reporting, the UE may expect to always report CSI for the channel within the downlink slot and CSI for the channel within the downlink subband within the SBFD slot together, without including information such as the corresponding CSI-RS resource set indicator.
When the UE is configured with CSI-ReportConfig 20-01 for semi-persistent CSI reporting, the UE may expect two different NZP-CSI-RS-ResourceSets to be configured within CSI-ResourceConfig 20-03 configured in CSI-ReportConfig 20-01 (for example, a first NZP-CSI-RS-ResourceSet 20-05 and a second NZP-CSI-RS-ResourceSet 20-06). Additionally, the UE may be notified by the base station about which NZP-CSI-RS-ResourceSet among the two different NZP-CSI-RS-ResourceSets within the CSI-ResourceConfig may be associated with the corresponding CSI report and used as a reference signal, through specific higher layer signaling to be included within CSI-SemiPersistentOnPUSCH-TriggerState, which is a higher layer signaling including CSI-ReportConfig. In another way, the UE may include an indicator in the CSI report corresponding to the corresponding CSI-ReportConfig, which distinguishes which NZP-CSI-RS-ResourceSet the CSI corresponds to, and for example, the indicator may be a 1-bit or 2-bit CSI-RS resource set indicator. When the corresponding CSI-RS resource set indicator is 1 bit, the UE may use 1 bit to express information on which NZP-CSI-RS-ResourceSet among the two NZP-CSI-RS-ResourceSets the CSI corresponds to. When the corresponding CSI-RS resource set indicator is 2 bits, the UE may use 2 bits to express information on whether the CSI corresponds to at least one NZP-CSI-RS-ResourceSet among the two NZP-CSI-RS-ResourceSet. In another way, for semi-persistent CSI reporting, the UE may expect to always report CSI for a channel in a downlink slot and CSI for a channel in a downlink subband within an SBFD slot together, without including information such as the corresponding CSI-RS resource set indicator.
When the UE has be configured with CSI-ReportConfig 20-01 for aperiodic CSI reporting, the UE may expect at least two different NZP-CSI-RS-ResourceSets to be configured within CSI-ResourceConfig 20-03 configured in CSI-ReportConfig 20-01 (e.g., the first NZP-CSI-RS-ResourceSet 20-05 and the second NZP-CSI-RS-ResourceSet 20-06). In addition, the UE may be notified by the base station about which at least one NZP-CSI-RS-ResourceSet among the at least two different NZP-CSI-RS-ResourceSets in the CSI-ResourceConfig may be associated with the corresponding CSI report and used as a reference signal, through the higher layer signaling resourceForChannel in the first CSI-AssociatedReportConfigInfo which is the higher layer signaling including the CSI-ReportConfig. In another way, the UE may include an indicator in the CSI report corresponding to the corresponding CSI-ReportConfig that distinguishes which NZP-CSI-RS-ResourceSet the CSI corresponds to, and for example, the indicator may be a 1-bit or 2-bit CSI-RS resource set indicator. When the CSI-RS resource set indicator is 1 bit, the UE may use 1 bit to express information on which of the two NZP-CSI-RS-ResourceSets the CSI corresponds to. When the corresponding CSI-RS resource set indicator is 2 bits, the UE may use 2 bits to express information on whether the CSI corresponds to at least one NZP-CSI-RS-ResourceSet among the two NZP-CSI-RS-ResourceSets. In another way, for aperiodic CSI reporting, the UE may expect to always report CSI for a channel in a downlink slot and CSI for a channel in a downlink subband within an SBFD slot together without including information such as the corresponding CSI-RS resource set indicator.

When the UE uses the above [Method C2-1] as the higher layer signaling structure for CSI reporting, the UE may use a combination of at least one of the above [Method R1], [Method R1-1] to [Method R1-5] as a CSI-RS resource configuration method, where channel measurement for a downlink slot and channel measurement for a downlink subband within an SBFD slot are based on separate CSI-RS resources.

When the UE operates in [Method C2-1], the UE is configured with NZP-CSI-RS-ResourceSet separately for CSI for a channel in a downlink slot and CSI for channel in a downlink subband within the SBFD slot, so that the definition of CRI is maintained, but an additional indicator that can express which NZP-CSI-RS-ResourceSet the CSI report is for may be required, and there is a disadvantage that the UE may consume the most higher layer signalings related to CSI reporting and channel measurement among [Method C2-1] to [Method C2-3]. In addition, for periodic or semi-persistent CSI reporting, the UE may be configured with one NZP-CSI-RS-ResourceSet in one CSI-ResourceConfig conventionally, while for [Method C2-1], at least two NZP-CSI-RS-ResourceSet configurations may be required. In addition, for aperiodic CSI reporting, the UE is configured with a plurality of NZP-CSI-RS-ResourceSets in one CSI-ResourceConfig and one NZP-CSI-RS-ResourceSet is selected through higher layer signaling conventionally, while for [Method C2-1], additional signaling for selecting one or more NZP-CSI-RS-ResourceSets may be required.

### [Method C2-2] (20-30)

The UE may use a common CSI-ReportConfig configured by the base station for the CSI report calculated based on channel estimation in a downlink slot and the CSI report calculated based on channel estimation in a downlink subband in an SBFD slot (20-31). In addition, the UE may assume the CSI-ResourceConfig 20-33 that may be configured in the CSI-ReportConfig, and the NZP-CSI-RS-ResourceSet 20-35 that may be commonly configured for the CSI report calculated based on the channel estimation in the downlink slot and the CSI report calculated based on the channel estimation in the downlink subband within the SBFD slot in the corresponding CSI-ResourceConfig, and may assume that one or more NZP-CSI-RS-Resources 20-37 that may be configured for the channel measurement for the downlink slot and one or more NZP-CSI-RS-Resources 20-38 that may be configured for the channel measurement for the downlink subband within the SBFD slot are different from each other.

For such an association between the NZP-CSI-RS-Resource that may be configured separately for each of the CSI reporting based on a channel of a downlink slot and the CSI reporting based on a channel for the downlink subband within the SBFD slot, the UE may be notified by the base station through a combination of at least one of higher layer signaling, MAC-CE signaling, and L1 signaling, or may use a method fixed in the specification.

For example, the UE may be configured by the base station with additional higher layer signaling within t higher layer signaling (e.g., CSI-ReportConfig, CSI-AssociatedReportConfigInfo for aperiodic CSI reporting, CSI-SemiPersistentOnPUSCH-TriggerState for semi-persistent CSI reporting) related to the CSI report, and may be notified about which NZP-CSI-RS-Resource the higher layer signaling (e.g., CSI-ReportConfig, CSI-AssociatedReportConfigInfo for aperiodic CSI reporting, CSI-SemiPersistentOnPUSCH-TriggerState for semi-persistent CSI reporting) related to the CSI report is associated with and used for CSI reporting

When the UE uses the above [Method C2-2] as the higher layer signaling structure for CSI reporting, the UE may use a combination of at least one of [Method R1], [Method R1-1] to [Method R1-5] as a CSI-RS resource configuration method, where channel measurement for a downlink slot and channel measurement for a downlink subband within an SBFD slot are based on separate CSI-RS resources.

When the UE operates in [Method C2-2], the UE utilizes a common NZP-CSI-RS-ResourceSet configuration corresponding to CSI calculation and reporting, so that the higher layer signaling consumption is relatively small, but it is difficult to reuse the higher layer signaling structure used for conventional CSI reporting and measurement, and since NZP-CSI-RS-Resources separately configured for different purposes may be included in the common NZP-CSI-RS-ResourceSet, when the definition for conventional CRI is reused, only one of the CSIs corresponding to the channel in the downlink slot or the channel for the downlink subband within the SBFD slot may be reported. To report both of the above CSIs, additional CRI overhead may be incurred.

For example, in the case that the UE is configured with K1 NZP-CSI-RS-Resources for the purpose of measuring a channel in a downlink slot within the NZP-CSI-RS-ResourceSet and K2 NZP-CSI-RS-Resources for the purpose of measuring a channel in a downlink subband within a SBFD slot, when the UE is configured by the base station with a higher layer signaling related to CSI reporting such that the UE may report only one of the CSI corresponding to the downlink channel and the CSI corresponding to the channel of the downlink subband within the SBFD slot, the UE may use ceil(log 2(K1+K2)) bits as a bit length of a CRI if the CRI is included in the CSI report corresponding to the above CSI-ReportConfig that may be commonly configured.

In addition, in the case that the UE is configured by the base station with the higher layer signaling related to CSI reporting such that the UE may report at least one of the CSI corresponding to the downlink channel and the CSI corresponding to the channel of the downlink subband within the SBFD slot, the UE may use ceil(log 2(K1+K2+K1*K2)) bits or ceil(log 2(K1+1))+ceil(log 2(K2+1)) bits as the bit length of the CRI when the CRI is included in the CSI report corresponding to the above CSI-ReportConfig that may be commonly configured.

### [Method C2-3] (20-50)

The UE may use the common CSI-ReportConfig configured by the base station for the CSI report calculated based on the channel estimation in the downlink slot and the CSI report calculated based on the channel estimation in the downlink subband within the SBFD slot (20-51). In addition, the UE may assume the CSI-ResourceConfig 20-53 that may be configured in the CSI-ReportConfig, and the NZP-CSI-RS-ResourceSet 20-55 that may be commonly configured for the CSI report calculated based on the channel estimation in the downlink slot and the CSI report calculated based on the channel estimation in the downlink subband within the SBFD slot in the corresponding CSI-ResourceConfig, and also may assume that one or more NZP-CSI-RS-Resource 20-57 that may be commonly used in the channel measurement for the downlink slot and the channel measurement for the downlink subband within the SBFD slot are configured (20-50).

In this case, the UE may be notified by the base station about whether to report CSI for a channel in a downlink slot or CSI for a channel in a downlink subband within the SBFD slot when one or more NZP-CSI-RS-Resources that may be commonly used for channel measurement for a downlink slot and channel measurement for a downlink subband within the SBFD slot are associated with a specific CSI report, through a combination of at least one of higher layer signaling, MAC-CE signaling, and L1 signaling, or may use a method fixed in the specification.

For example, the UE may be configured by the base station with additional higher layer signaling within the higher layer signaling (e.g., CSI-ReportConfig, CSI-AssociatedReportConfigInfo for aperiodic CSI reporting, CSI-SemiPersistentOnPUSCH-TriggerState for semi-persistent CSI reporting) related to the CSI report, may be notified about whether the higher layer signaling (e.g., CSI-ReportConfig, CSI-AssociatedReportConfigInfo for aperiodic CSI reporting, CSI-SemiPersistentOnPUSCH-TriggerState for semi-persistent CSI reporting) related to the CSI report is to report CSI for a channel in a downlink slot, CSI for a channel in a downlink subband within an SBFD slot, or both.

When the UE uses the above [Method C2-3] as the higher layer signaling structure for CSI reporting, the UE may use a combination of at least one of [Method R2], [Method R2-1] to [Method R2-3] as a CSI-RS resource configuration method, where channel measurement for downlink slot and channel measurement for downlink subband within SBFD slot are based on a common CSI-RS resource.

When the UE operates in [Method C2-3], the UE utilizes a common NZP-CSI-RS-ResourceSet configuration corresponding to CSI calculation and reporting and a common NZP-CSI-RS-Resource, so that the higher layer signaling consumption is relatively small, but it is difficult to reuse the higher layer signaling structure used for conventional CSI reporting and measurement, and since a common NZP-CSI-RS-Resource for different purposes may be included in the common NZP-CSI-RS-ResourceSet, the definition of CRI may be maintained, but from the UE's perspective, even though the UE has been configured with one NZP-CSI-RS-Resource, there may be a burden of having to manage the resources as if two NZP-CSI-RS-Resources were configured.

The UE may be notified by the base station about a combination of at least one of [Method C1], [Method C2], [Method C1-1] to [Method C1-3], [Method C2-1] to [Method C2-3] through a combination of at least one of higher layer signaling, MAC-CE signaling, and L1 signaling, or may expect that a combination of at least one of [Method C1], [Method C2], [Method C1-1] to [Method C1-3], [Method C2-1] to [Method C2-3] is fixedly defined in the specification.

In addition, when the UE is notified by the base station about a combination of specific one or more methods through a combination of at least one of higher layer signaling, MAC-CE signaling, and L1 signaling, it may mean that the UE cannot support other combinations of the specific one or more methods. For example, the UE may expect that the [Method C1-1] is fixedly defined in the specification for the CSI reporting method for a channel in a downlink slot and/or for a channel in a downlink subband within an SBFD slot. As another example, the UE may be notified by the base station of [Method C2-1] through a combination of at least one of higher layer signaling, MAC-CE signaling, and L1 signaling, in which case the UE may consider that it has been notified by the base station that the [Method C1-1] is not supported.

The UE may report to the base station, as UE capability, whether the UE can support a combination of at least one of [Method C1], [Method C2], [Method C1-1] to [Method C1-3], [Method C2-1] to [Method C2-3]. In this case, when the UE reports to the base station, as UE capability, whether the UE can support a combination of specific one or more methods, the UE may consider that the UE has reported that other combinations of the specific one or more methods cannot be supported. For example, the UE may report to the base station about whether the UE can support [Method C1-1]. For another example, the UE may report to the base station that [Method C2-2] can be supported, and this UE capability report may mean that the UE cannot support [Method C1-1].

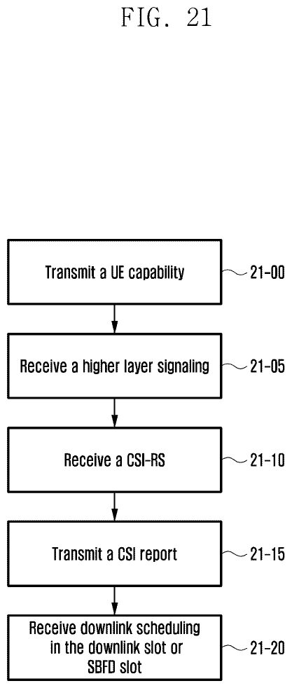

FIG. 21 illustrates an operation of a UE for CSI-RS reception and CSI reporting considering SBFD according to an embodiment of the disclosure.

At step 21-00, the UE may transmit UE capability to the base station. In this case, the UE capability signaling that may be reported here may be for a combination of at least one of UE capability related to SBFD operation, UE capability related to CSI-RS reception and CSI reporting, and UE capabilities corresponding to [Method R1], [Method R2], [Method R1-1] to [Method R1-5], [Method R2-1] to [Method R2-3], [Method C1], [Method C2], [Method C1-1] to [Method C1-3], [Method C2-1] to [Method C2-3]. It is also possible that the above step 21-00 is omitted.

At step 21-05, the UE may receive higher layer signaling from the base station according to the reported UE capability. In this case, the UE may be defined by the base station on higher layer parameters for a combination of at least one of higher layer signaling related to SBFD operation, higher layer signaling related to CSI-RS reception and CSI reporting, and higher layer signaling related to support of [Method R1], [Method R2], [Method R1-1] to [Method R1-5], [Method R2-1] to [Method R2-3], [Method C1], [Method C2], [Method C1-1] to [Method C1-3], [Method C2-1] to [Method C2-3], and use one of them.

At step 21-10, the UE may receive CSI-RS from the base station. In this case, the UE may receive CSI-RS from the base station according to a combination of at least one of [Method R1], [Method R2], [Method R1-1] to [Method R1-5], [Method R2-1] to [Method R2-3]. The UE may receive associated CSI-RS from the base station.

At step 21-15, the UE may report CSI to the base station. In this case, the UE may calculate and report CSI according to a combination of at least one of [Method C1], [Method C2], [Method C1-1] to [Method C1-3], [Method C2-1] to [Method C2-3].

At step 21-20, the UE may receive downlink scheduling from the base station for downlink slots or downlink subbands within the SBFD slot.

The above-described flowchart illustrates an exemplary method that may be implemented according to the principles of the present disclosure, and various changes may be made to the method illustrated in the flowchart herein. For example, although illustrated as a series of steps, various steps in each drawing may overlap, occur in parallel, occur in a different order, or occur multiple times. In other examples, steps may be omitted or replaced with other steps.

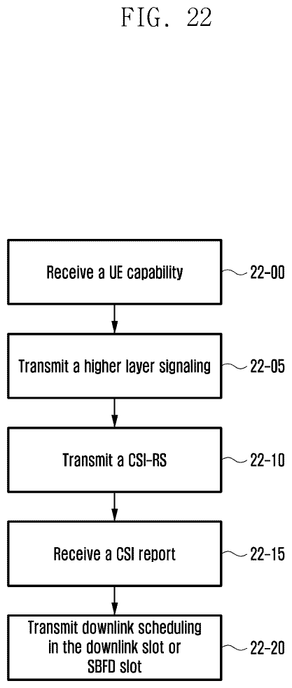

FIG. 22 illustrates an operation of a base station for CSI-RS reception and CSI reporting considering SBFD according to an embodiment of the disclosure.

At step 22-00, the base station may receive UE capability from the UE. In this case, the UE capability signaling that may be received by the base station may be for a combination of at least one of UE capability related to SBFD operation, UE capability related to CSI-RS reception and CSI reporting, and UE capabilities corresponding to [Method R1], [Method R2], [Method R1-1] to [Method R1-5], [Method R2-1] to [Method R2-3], [Method C1], [Method C2], [Method C1-1] to [Method C1-3], [Method C2-1] to [Method C2-3]. It is also possible that the above step 22-00 is omitted.

At step 22-05, the base station may receive higher layer signaling from a base station according to the UE capability reported by the UE. In this case, the UE may be defined by the base station on higher layer parameters for a combination of at least one of higher layer signaling related to SBFD operation, higher layer signaling related to CSI-RS reception and CSI reporting, and higher layer signaling related to support of [Method R1], [Method R2], [Method R1-1] to [Method R1-5], [Method R2-1] to [Method R2-3], [Method C1], [Method C2], [Method C1-1] to [Method C1-3], [Method C2-1] to [Method C2-3], and use one of them.

At step 22-10, the base station may transmit CSI-RS to the UE. In this case, the base station may transmit CSI-RS to the UE according to a combination of at least one of [Method R1], [Method R2], [Method R1-1] to [Method R1-5], [Method R2-1] to [Method R2-3].

At step 22-15, the base station may receive a CSI report from the UE. In this case, the base station may receive the CSI calculated by the UE according to a combination of at least one of [Method C1], [Method C2], [Method C1-1] to [Method C1-3], [Method C2-1] to [Method C2-3].

At step 22-20, the base station may transmit downlink scheduling for a downlink slot or a downlink subband within an SBFD slot to the UE.

The above-described flowchart illustrates an exemplary method that may be implemented according to the principles of the present disclosure, and various changes may be made to the method illustrated in the flowchart herein. For example, although illustrated as a series of steps, various steps in each drawing may overlap, occur in parallel, occur in a different order, or occur multiple times. In other examples, steps may be omitted or replaced with other steps.

### Second Embodiment: Non-Codebook-Based PUSCH Transmission Scheme of a UE Considering SBFD

As an embodiment of the disclosure, a non-codebook-based PUSCH transmission scheme of a UE is described. The present embodiment may be operated in combination with other embodiments.

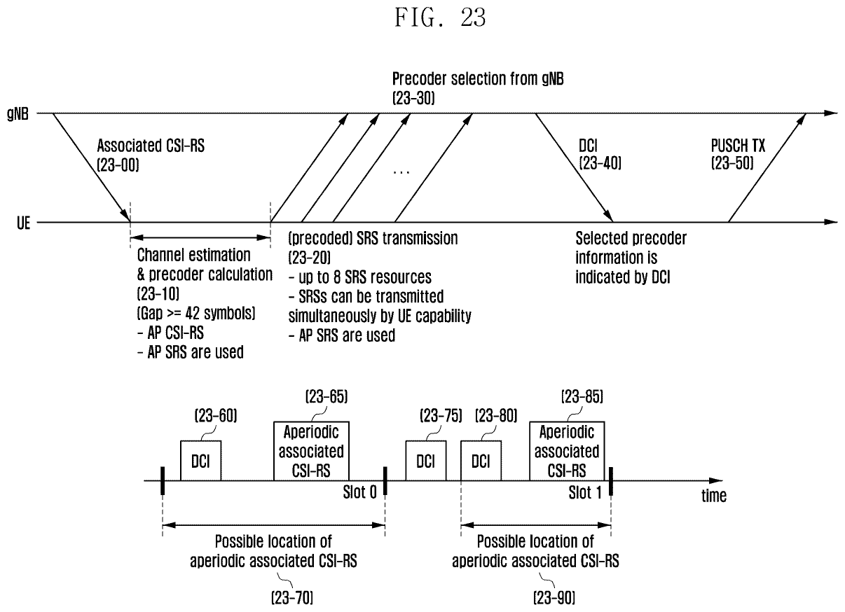

FIG. 23 illustrates a non-codebook-based PUSCH transmission process according to an embodiment of the disclosure.

Referring to FIG. 23, a UE may receive an associated CSI-RS from a base station (23-00). The UE may estimate a channel between the base station and the UE based on the associated CSI-RS received from the base station, and then calculate a precoder to be used for non-codebook-based PUSCH transmission based on the estimated channel (23-10). In this case, the UE may calculate the same precoder for all frequency resource areas where the UE intends to calculate a precoder, or calculate different precoders for each partial frequency resource area. For example, the UE may calculate a wideband precoder or a subband precoder. Then, the UE may apply the vector for each layer of the calculated entire precoding matrix to each SRS resource and transmit the resource to the base station. The layer value of the entire precoding matrix and the number of SRS resources may be determined according to the UE capability report of the UE and the higher layer signaling configuration of the base station (or one or more of the UE capability report of the UE and the higher layer signaling configuration of the base station). Accordingly, the UE may apply the vector for each layer of the entire precoding matrix constituted by up to 8 layers to each of up to 8 SRS resources, and simultaneously transmit one or more SRS resources to which the precoding matrix calculated by the UE is applied to the base station.

For the one or more SRS resources to which the precoding matrix is applied, the UE may report the maximum number of SRS resources that may be simultaneously transmitted as the UE capability to the base station (23-20). When the associated CSI-RS is an aperiodic CSI-RS and the SRS resource in the SRS resource set with usage set to non-codebook is an aperiodic SRS, the UE may not expect that the time interval from the time point of receiving the associated CSI-RS from the base station to transmission of one or more SRS resources to which precoding is applied is less than 42·2^{max(0,μ-3)} symbols. In this case, μ may be a value representing a subcarrier spacing. For example, the subcarrier spacing may be 15·2^{μ} kHz. For example, when the associated CSI-RS is an aperiodic CSI-RS and the SRS resource in the SRS resource set with usage set to non-codebook is an aperiodic SRS, the UE may estimate the channel based on the associated CSI-RS, calculate the precoder, and use a time corresponding to at least 42 symbols to apply the precoding to the SRS resource for transmission (23-10).

The base station that has received one or more SRS resources to which precoding is applied may determine a combination of SRS resources that is determined to have the best reception performance for each PUSCH precoding frequency resource unit. A combination of precoders applied to one or more SRS resources selected through the determined combination of SRS resources may be determined as a precoder of the UE for non-codebook-based PUSCH transmission in the corresponding PUSCH precoding frequency resource unit (23-30).

The UE may receive indication from the base station of information about the combination of SRS resources determined by the base station through an SRI field in the DCI (23-40). In this case, the UE may understand the number of SRS resources indicated to the UE through the SRI as rank information of the non-codebook-based PUSCH to be transmitted by the UE, and may understand the precoder information of the non-codebook-based PUSCH to be transmitted by the UE through one or more SRS resources indicated to the UE through the SRI. Based on the rank and precoder information, the UE may perform non-codebook-based PUSCH transmission (23-50).

The UE may expect that the length of the SRS request field in the DCI format 0_2 is one of 0, 1, 2, or 3 bits, and may interpret the SRS request field for each bit length as follows. Certainly, the present disclosure is not limited to the following examples.
When the higher layer signaling srs-RequestDCI-0-2 is not configured, the SRS request field in DCI format 0_2 may be 0 bits.
When the higher layer signaling srs-RequestDCI-0-2 is set to 1 and the supplementary Uplink (SUL) in ServingCellConfig is not configured, the UE may consider the SRS request field in DCI format 0_2 as 1 bit. The interpretation of 1 bit may follow [Table 25] below or the first two rows of [Table 24] below. When [Table 24] below is used, the UE may interpret a value of 0 in the SRS request field as an operation corresponding to the first row “00” of [Table 24] below, and may interpret a value of 1 in the SRS request field as an operation corresponding to the second row “01” of [Table 24] below.
When the higher layer signaling srs-RequestDCI-0-2 is set to 1 and supplementary Uplink in ServingCellConfig is configured, the UE may consider the SRS request field in DCI format 0_2 as 2 bits. The first bit of the 2 bits may be interpreted as indicating either non-SUL or SUL, and the interpretation of the remaining 1 bit may follow [Table 25] below or may follow the first two rows of [Table 24] below. When [Table 24] below is used, the UE may interpret a value of 0 in the SRS request field as an operation corresponding to the first row “00” of [Table 24] below, and may interpret a value of 1 in the SRS request field as an operation corresponding to the second row “01” of [Table 24] below.
When the higher layer signaling srs-RequestDCI-0-2 is set to 2 and supplementary Uplink in ServingCellConfig is not configured, the UE may consider the SRS request field in DCI format 0_2 as 2 bits, and the interpretation of the 2 bits may follow [Table 24] below.
When the higher layer signaling srs-RequestDCI-0-2 is set to 2 and supplementary Uplink in ServingCellConfig is configured, the UE may consider the SRS request field in DCI format 0_2 as 3 bits, and may interpret the first bit as indicating either non-SUL or SUL, and the interpretation of the remaining 2 bits may follow [Table 24] below.

The UE may expect the length of the SRS request field in DCI format 1_2 to be 1 of 0, 1, 2, or 3 bits, and may interpret the SRS request field for each bit length as follows:
When the higher layer signaling srs-RequestDCI-1-2 is not configured, the SRS request field in DCI format 1_2 may be 0 bits.
When the higher layer signaling srs-RequestDCI-1-2 is set to 1 and supplementary Uplink in ServingCellConfig is not configured, the UE may consider the SRS request field in DCI format 1_2 as 1 bit, and the interpretation for the 1 bit may follow [Table 25] below or the first two rows of [Table 24] below. When the following [Table 24] is used, the UE may interpret a value of 0 in the SRS request field as an operation corresponding to the first row “00” of the following [Table 24], and may interpret a value of 1 in the SRS request field as an operation corresponding to the second row “01” of the following [Table 24].
When the higher layer signaling srs-RequestDCI-1-2 is set to 1 and supplementary Uplink in ServingCellConfig is configured, the UE may consider the SRS request field in DCI format 1_2 as 2 bits, the first bit of which may be interpreted as indicating either non-SUL or SUL, and the interpretation of the remaining 1 bit may follow [Table 25] below, or may follow the first two rows of the following [Table 24]. If the following [Table 24] is used, the UE may interpret a value 0 in the SRS request field as an operation corresponding to the first row “00” of the following [Table 24], and may interpret a value 1 in the SRS request field as an operation corresponding to the second row “01” of the following [Table 24].
When the higher layer signaling srs-RequestDCI-1-2 is set to 2 and supplementary Uplink in ServingCellConfig is not configured, the UE may consider the SRS request field in DCI format 1_2 as 2 bits, and the interpretation of the 2 bits may follow [Table 24] below.
When the higher layer signaling srs-RequestDCI-1-2 is set to 2 and supplementary Uplink in ServingCellConfig is configured, the UE may consider the SRS request field in DCI format 1_2 as 3 bits, the first bit of which may be interpreted as indicating either non-SUL or SUL, and the interpretation of the remaining 2 bits may follow [Table 24] below.

When supplementaryUplink in the higher layer signaling ServingCellConfig is not configured, the UE may interpret the higher layer signaling srs-RequestDCI-0-2 as the length of the SRS request field in DCI format 0_2. Alternatively, when the supplementaryUplink in the higher layer signaling ServingCellConfig is configured, the UE may interpret the higher layer signaling srs-RequestDCI-0-2 as a value that is 1 less than the length of the SRS request field in DCI format 0_2.

When supplementaryUplink in the higher layer signaling ServingCellConfig is not configured, the UE may perform interpretation of the bit length of the SRS request field according to each of the following configuration situations for srs-RequestDCI-0-2. Certainly, the present disclosure is not limited to the following examples.
When the higher layer signaling srs-RequestDCI-0-2 is not configured, the UE may consider the length of the SRS request field in DCI format 0_2 as 0 bits.
When the higher layer signaling srs-RequestDCI-0-2 is set to 1, the UE may consider the SRS request field in DCI format 0_2 as 1 bit. 1 bit may indicate one of the two values in [Table 25] below, or may indicate one of the first two values in [Table 24] below.
When the higher layer signaling srs-RequestDCI-0-2 is set to 2, the UE may consider the SRS request field in DCI format 0_2 as 2 bits, and the 2 bits may indicate one of all rows in [Table 24] below.

When supplementaryUplink in the higher layer signaling ServingCellConfig is configured, the UE may consider an additional 1 bit for the SRS request field from the first bit position (MSB, most significant bit), and the first 1 bit added may indicate either non-SUL or SUL. In this case, even if supplementaryUplink in the higher layer signaling ServingCellConfig is configured, the UE may consider the bit length of the SRS request field in DCI format 0_2 as 0, when the higher layer signaling srs-RequestDCI-0-2 is not configured.

When supplementary Uplink in the higher layer signaling ServingCellConfig is not configured, the UE may interpret the higher layer signaling srs-RequestDCI-1-2 as the length of the SRS request field in DCI format 1_2. Alternatively, when supplementaryUplink in the higher layer signaling ServingCellConfig is configured, the UE may interpret the higher layer signaling srs-RequestDCI-1-2 as the length of the SRS request field in DCI format 1_2 as a value that is 1 less than the length of the SRS request field in DCI format 1_2.

When supplementaryUplink in the higher layer signaling ServingCellConfig is not configured, the UE may perform interpretation of the bit length of the SRS request field according to each of the following configuration situations for srs-RequestDCI-1-2. Certainly, the present disclosure is not limited to the following examples.
When the higher layer signaling srs-RequestDCI-1-2 is not configured, the UE may consider the length of the SRS request field in DCI format 1_2 as 0 bits.
When the higher layer signaling srs-RequestDCI-1-2 is set to 1, the UE may consider the SRS request field in DCI format 1_2 as 1 bit. 1 bit may indicate one of the two values in [Table 25] below, or may indicate one of the first two values in [Table 24] below.
When the higher layer signaling srs-RequestDCI-1-2 is set to 2, the UE may consider the SRS request field in DCI format 1_2 as 2 bits. 2 bits may indicate one of all rows in [Table 24] below.

When supplementaryUplink in the higher layer signaling ServingCellConfig is configured, the UE may consider an additional 1 bit for the SRS request field from the first bit position (MSB, most significant bit), and the first 1 bit added may indicate either non-SUL or SUL. In this case, even if supplementary Uplink in the higher layer signaling ServingCellConfig is configured, the UE may consider the bit length of the SRS request field in DCI format 1_2 as 0, when the higher layer signaling srs-RequestDCI-1-2 is not configured.

TABLE 24

| | | |
|---|---|---|
| SRS | One or more aperiodic SRS resource sets triggered | One or more aperiodic SRS |
| request | by DCI format 0_1, 0_2, 1_1, 1_2, and one or more | resource sets triggered by DCI |
| field values | aperiodic SRS resource sets triggered by DCI | format 2_3 with higher layer |
| | format 2_3 with higher layer signaling srs-TPC- | signaling srs-TPC-PDCCH- |
| | PDCCH-Group set to typeB. | Group set to typeA. |
| 00 | Aperiodic SRS resource set not triggered | Aperiodic SRS resource set not |
| | | triggered |
| 01 | One or more SRS resource sets for which the | One or more SRS resource sets |
| | aperiodicSRS-ResourceTrigger in the higher layer | for which usage in the higher |
| | signaling SRS-ResourceSet is set to 1, or one entry | layer signaling SRS- |
| | in the aperiodicSRS-ResourceTriggerList is set to | ResourceSet is set to |
| | 1 | antennaSwitching and |
| | One or more SRS resource sets in which | resourceType is set to aperiodic, |
| | aperiodicSRS-ResourceTrigger in the higher layer | within the first set including a |
| | signaling SRS-PosResourceSet is set to 1, or one | plurality of serving cells |
| | entry in aperiodicSRS-ResourceTriggerList is set | configured through higher layer |
| | to 1, when the UE receives DCI formats 0_1, 0_2, | signaling |
| | 1_1, and 1_2 | |
| 10 | One or more SRS resource sets in which the | One or more SRS resource sets |
| | aperiodicSRS-ResourceTrigger in the higher layer | for which usage in the higher |
| | signaling SRS-ResourceSet is set to 2, or one entry | layer signaling SRS- |
| | in the aperiodicSRS-ResourceTriggerList is set to | ResourceSet is set to |
| | 2 | antennaSwitching and |
| | One or more SRS resource sets in which | resourceType is set to aperiodic, |
| | aperiodicSRS-ResourceTrigger in the higher layer | within the second set including a |
| | signaling SRS-PosResourceSet is set to 2, or one | plurality of serving cells |
| | entry in aperiodicSRS-ResourceTriggerList is set | configured through higher layer |
| | to 2, when the UE receives DCI formats 0_1, 0_2, | signaling |
| | 1_1, and 1_2 | |
| 11 | One or more SRS resource sets in which the | One or more SRS resource sets |
| | aperiodicSRS-ResourceTrigger in the higher layer | for which usage in the higher |
| | signaling SRS-ResourceSet is set to 3, or one entry | layer signaling SRS- |
| | in the aperiodicSRS-ResourceTriggerList is set to | ResourceSet is set to |
| | 3 | antennaSwitching and |
| | One or more SRS resource sets in which | resourceType is set to aperiodic, |
| | aperiodicSRS-ResourceTrigger in the higher layer | within the third set including a |
| | signaling SRS-PosResourceSet is set to 3, or one | plurality of serving cells |
| | entry in aperiodicSRS -ResourceTriggerList is set | configured through higher layer |
| | to 3, when the UE receives DCI formats 0_1, 0_2, | signaling |
| | 1_1, and 1_2 | |

TABLE 25

| | |
|---|---|
| SRS request field | One or more aperiodic SRS resource sets triggered by DCI format 0_2 and |
| values | 1_2 |
| 0 | Aperiodic SRS resource set not triggered |
| 1 | One or more SRS resource sets in which the higher layer signaling |
| | aperiodicSRS-ResourceTrigger is set to 1, or one entry in aperiodicSRS- |
| | ResourceTriggerList is set to 1 |

When an aperiodic SRS resource set is configured (for example, when resourceType, which is an RRC parameter in the SRS resource set, is aperiodic), an associated CSI-RS may be indicated through an SRS request field in DCI format 0_1, 1_1, 0_2 or 1_2. However, for DCI format 0_2 or 1_2, the associated CSI-RS may be indicated through the SRS request field only if the SRS request field exists in the corresponding DCI. In this case, the UE may be configured by the base station with the higher layer signalings, aperiodicSRS-ResourceTrigger, AperiodicSRS-ResourceTriggerList, srs-ResourceSetId, and csi-RS, in the SRS resource set. The UE may define one or more SRS resource sets associated with the SRS request fields in DCI formats 0_1 and 1_1 through entries in the higher layer signaling, srs-ResourceSetToAddModList. In addition, the UE may define one or more SRS resource sets associated with the SRS request fields in DCI formats 0_2 and 1_2 through entries in the higher layer signaling srs-ResourceSetToAddModListDCI-0-2.

When the UE has been configured by the base station with an SRS resource set with usage set to non-codebook through a higher layer signaling, and the resourceType, which is an RRC parameter in the SRS resource set, is aperiodic, and the associated CSI-RS configured in the same SRS resource set is also an aperiodic NZP CSI-RS, the UE may receive a triggering instruction from the base station for the aperiodic associated CSI-RS through the SRS request field in the DCI. The UE may interpret the triggering instruction from the base station for the aperiodic associated CSI-RS through a combination of at least one of the following items. Certainly, the present disclosure is not limited to the following examples.

The UE may expect to be indicated whether an aperiodic associated CSI-RS exists for the case where the SRS request field in DCI format 0_1 or 1_1 is not “00” and the corresponding DCI is not for cross-carrier scheduling or cross-BWP scheduling. For example, when an SRS resource set with usage set to non-codebook is associated with the SRS request field value “01” (for example, when the value of the higher layer signaling aperiodicSRS-ResourceTrigger is set to 1 or one of the entries of aperiodicSRS-ResourceTriggerList is set to 1), and when the UE receives indication of “01” from the base station through the SRS request field in DCI format 0_1 or 1_1, the UE may interpret that the aperiodic associated CSI-RS is triggered by the base station and transmitted to the UE, and may understand that the aperiodic associated CSI-RS exists.

The UE may expect to be indicated whether an aperiodic associated CSI-RS exists for the case where the last two bits of the SRS request field in DCI format 0_1 or 1_1 are not “00” and the corresponding DCI is not for cross-carrier scheduling or cross-BWP scheduling. When the UE is not configured with supplementary Uplink in the higher layer signaling ServingCellConfig, the UE may assume that the SRS request field in DCI format 0_1 or 1_1 is 2 bits. When the UE is configured with supplementary Uplink in the higher layer signaling ServingCellConfig, the UE may assume that the SRS request field in DCI format 0_1 or 1_1 is 3 bits. When the SRS request field is 3 bits, the UE may interpret the first bit of the 3 bits as indicating either non-SUL or SUL, and the last two bits can be interpreted based on [Table 24].

The UE may interpret at least one of the following combinations based on the setting value of srs-RequestDCI-0-2 or srs-RequestDCI-1-2, which is a higher layer signaling, for the SRS request field in DCI format 0_2 or 1_2.
When the UE is configured with srs-RequestDCI-0-2 or srs-RequestDCI-1-2 as 1 and is not configured with supplementaryUplink in the higher layer signaling ServingCellConfig, the UE may consider the SRS request field in DCI format 0_2 or 1_2 to be 1 bit. In addition, the UE may expect to be indicated whether an aperiodic associated CSI-RS exists for the case where 1 bit of the SRS request field is not “0” and the corresponding DCI is not for cross-carrier scheduling or cross-BWP scheduling. For example, when an SRS resource set with usage set to non-codebook is associated with the SRS request field value “1” (for example, when the value of the higher layer signaling aperiodicSRS-ResourceTrigger is set to 1, or one of the entries of aperiodicSRS-ResourceTriggerList is set to 1), and when UE receives indication of “1” from the base station through the SRS request field in DCI format 0_2 or 1_2, the UE may interpret that the aperiodic associated CSI-RS is triggered by the base station and transmitted to the UE, and may understand that the aperiodic associated CSI-RS exists.
When the UE is configured with srs-RequestDCI-0-2 or srs-RequestDCI-1-2 as 1 and is configured with supplementaryUplink in the higher layer signaling ServingCellConfig, the UE may consider that the SRS request field in DCI format 0_2 or 1_2 is 2 bits. In addition, the UE may expect to be indicated whether an aperiodic associated CSI-RS exists for the case where the last (LSB, least significant bit) 1 bit of the SRS request field is not “0” and the corresponding DCI is not for cross-carrier scheduling or cross-BWP scheduling. For example, when an SRS resource set with usage set to non-codebook is associated with the last 1 bit value “1” of the SRS request field (for example, when the value of the higher layer signaling aperiodicSRS-ResourceTrigger is set to 1 or one of the entries of aperiodicSRS-ResourceTriggerList is set to 1), and when the UE receives indication of “1” for the last 1 bit of the SRS request field in DCI format 0_2 or 1_2 from the base station, the UE may interpret that the aperiodic associated CSI-RS is triggered by the base station and transmitted to the UE, and may understand that the aperiodic associated CSI-RS exits.
When the UE is configured with srs-RequestDCI-0-2 or srs-RequestDCI-1-2 as 2 and is not configured with supplementary Uplink in the higher layer signaling ServingCellConfig, the UE may consider the SRS request field in DCI format 0_2 or 1_2 as 2 bits. In addition, the UE may expect to be indicated whether an aperiodic associated CSI-RS exists for the case where the SRS request field is not “00” and the corresponding DCI is not for cross-carrier scheduling or cross-BWP scheduling. For example, when an SRS resource set with usage set to non-codebook is associated with the SRS request field value “01” (for example, when the value of the higher layer signaling aperiodicSRS-ResourceTrigger is set to 1 or one of the entries of aperiodicSRS-ResourceTriggerList is set to 1), and when the UE receives indication of “01” from the base station through the SRS request field in DCI format 0_2 or 1_2, the UE may interpret that the aperiodic associated CSI-RS is triggered by the base station and transmitted to the UE, and may understand that the aperiodic associated CSI-RS exists.
When the UE is configured with srs-RequestDCI-0-2 or srs-RequestDCI-1-2 as 2 and is configured with supplementaryUplink in the higher layer signaling ServingCellConfig, the UE may consider the SRS request field in DCI format 0_2 or 1_2 to be 3 bits. The UE may expect to be indicated whether an aperiodic associated CSI-RS exists for the case where the last 2 bits of the SRS request field are not “00,” and the corresponding DCI is not for cross-carrier scheduling or cross-BWP scheduling. For example, when an SRS resource set with usage set to non-codebook is associated with the last 2 bits value of the SRS request field, “01” (for example, when the value of the higher layer signaling aperiodicSRS-ResourceTrigger is set to 1, or one of the entries of the aperiodicSRS-ResourceTriggerList is set to 1), and when the UE is indicated “01” by the base station through the last 2 bits of the SRS request field in DCI format 0_2 or 1_2, the UE may interpret that the aperiodic associated CSI-RS is triggered by the base station and transmitted to the UE, and may understand that the aperiodic associated CSI-RS exists.

Cross-carrier scheduling may refer to a case where the scheduling cell that receives the DCI and the cell that performs transmission and reception through scheduling are different. Cross-BWP scheduling may refer to a case where the bandwidth part where the DCI is received and the bandwidth part where the transmission and reception are performed through scheduling are different.

In this case, the UE may understand that the aperiodic associated CSI-RS is located within the same slot as the DCI including the SRS request field that triggered the aperiodic associated CSI-RS.

When the UE receives the DCI 23-60 that triggers the aperiodic associated CSI-RS 23-65 in slot 0, the UE may expect that the aperiodic associated CSI-RS 23-65 that may be triggered through the DCI 23-60 exists within the same slot 0. In addition, even within the same slot 0, the UE may define the position where the aperiodic associated CSI-RS 23-65 may exist as within an interval from the first symbol in which the DCI 23-60 is transmitted to the last symbol of the corresponding slot 0 (23-70). When a DCI that triggers an aperiodic associated CSI-RS 23-85 is repeatedly transmitted (23-75, 23-80) (for example, when two DCIs are repeated PDCCH candidates transmitted in two different search spaces configured with the same searchspacelinkingID), the UE may expect that the aperiodic associated CSI-RS 23-85 exists within the slot 1 in which the repeated DCI exists. Furthermore, even within the same slot 1, the UE may define the position where the aperiodic associated CSI-RS 23-85 may exist as within an interval from the first symbol of the DCI 23-80 that starts later in time among the two repeated DCIs to the last symbol of the corresponding slot 1 (23-90).

When a UE has been configured with an SRS resource set with usage set to non-codebook through higher layer signaling by a base station, an RRC parameter resourceType in the corresponding SRS resource set is aperiodic, and an associated CSI-RS configured in the same SRS resource set is also an aperiodic NZP CSI-RS, if such UE has been configured with the higher layer signaling minimumSchedulingOffsetK0 in an activated downlink bandwidth part, and the set value is greater than 0, then the UE may not expect to receive a scheduling DCI with an SRS request field value of “00.”

When a UE has been configured with an SRS resource set with usage set to non-codebook through higher layer signaling by a base station, an RRC parameter resourceType in the corresponding SRS resource set is aperiodic, and an associated CSI-RS configured in the same SRS resource set is also an aperiodic NZP CSI-RS, if such UE has been configured with the higher layer signaling minimumSchedulingOffsetK0 in an activated downlink bandwidth part, and the set value is greater than 0, then the UE may perform a DCI reception operation considering a combination of at least one of the following items. Certainly, the present disclosure is not limited to the following examples.

When the UE receives DCI format 0_1 or 1_1, the UE may not expect to receive values other than “00” for an SRS request field value in the received DCI.

When the UE receives DCI format 0_1 or 1_1, if the UE is configured with supplementary Uplink in the higher layer signaling ServingCellConfig, then the UE may not expect to receive a value other than “00” for the last two bits of the SRS request field in the received DCI. When the UE is not configured with supplementaryUplink in the higher layer signaling ServingCellConfig, the UE may not expect to receive a value other than “00” for the last two bits of the SRS request field in the received DCI.

When the UE receives DCI format 0_2 or 1_2, if the UE is configured with srs-RequestDCI-0-2 or srs-RequestDCI-1-2 as 1 and is not configured with supplementaryUplink in the higher layer signaling ServingCellConfig, then the UE may consider the SRS request field in DCI format 0_2 or 1_2 to be 1 bit, and may not expect to receive the 1 bit with a value other than “0.”

When the UE receives DCI format 0_2 or 1_2, if the UE is configured with srs-RequestDCI-0-2 or srs-RequestDCI-1-2 as 1 and is configured with supplementaryUplink in the higher layer signaling ServingCellConfig, then the UE may consider the SRS request field in DCI format 0_2 or 1_2 to be 2 bits, and may not expect to receive the last 1 bit of the SRS request field with a value other than “0.”

When the UE receives DCI format 0_2 or 1_2, if the UE is configured with srs-RequestDCI-0-2 or srs-RequestDCI-1-2 as 2 and is not configured with supplementaryUplink in the higher layer signaling ServingCellConfig, then the UE may consider the SRS request field in DCI format 0_2 or 1_2 to be 2 bits and may not expect to receive the SRS request field with a value other than “00.”

When the UE receives DCI format 0_2 or 1_2, if the UE is configured with srs-RequestDCI-0-2 or srs-RequestDCI-1-2 as 2, and is configured with supplementaryUplink in the higher layer signaling ServingCellConfig, then the UE may consider the SRS request field in DCI format 0_2 or 1_2 as 3 bits, and may not expect to receive the last 2 bits of the SRS request field as a value other than “00.”

When the UE is configured with an aperiodic associated CSI-RS associated with an aperiodic SRS resource, all TCI states configured in a scheduled cell may not be expected to have the qcl-Type, which is a higher layer signaling, set to typeD. For example, all TCI states in the scheduled cell may not include QCL-TypeD, or the TCI states may refer to a case where the UE operates in FR1.

For the above described operations, the UE may report corresponding UE capabilities. According to an embodiment, the UE may report a UE capability that means the UE supports aperiodic associated CSI-RS. According to an embodiment, the UE may report a UE capability that means the UE can trigger aperiodic associated CSI-RS through DCI format 0_1, 1_1, 0_2, or 1_2. According to an embodiment, the UE may report a UE capability that means the UE supports supplementary Uplink. According to an embodiment, the UE may report a UE capability that means the UE supports minimumSchedulingOffsetK0.

Referring back to FIG. 14(c), the UE may be configured with some of the frequency bands of the cell as frequency bands 1420 that may be used for uplink transmission, and may be configured with a time region in which the frequency bands are activated. Here, this frequency band may be referred to as an uplink subband (UL subband). In FIG. 14(c), the UL subband is deactivated in the first slot, and the UL subband may be activated in the remaining slots. Accordingly, the UE may transmit an uplink channel or signal in the UL subband 1422 of the remaining slots. That is, the UL subband is activated in units of slots here, but in an embodiment of the present disclosure, whether to activate may be configured in units of symbols.

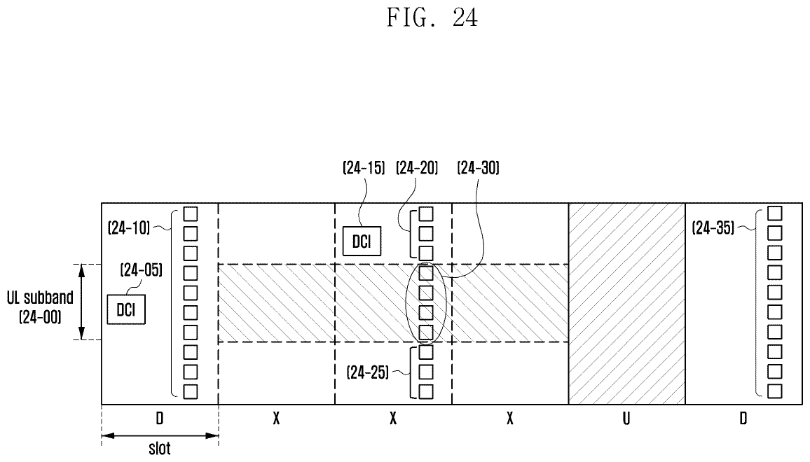

FIG. 24 illustrates a method for determining an associated CSI-RS transmission position for non-codebook-based PUSCH transmission in an SBFD system according to an embodiment of the present disclosure.

It may be assumed that the UE is connected to a base station that supports SBFD operation and is configured with an uplink subband 24-00. When the UE receives a DCI 24-05 that triggers an aperiodic associated CSI-RS, the UE may expect that an aperiodic associated CSI-RS 24-10 that may be triggered by the DCI exists in the same slot in which the DCI 24-05 is received.

Meanwhile, the purpose of the associated CSI-RS is to calculate a precoder when transmitting a PUSCH, and this is based on the reciprocity between the uplink channel and the downlink channel, and therefore, in order to calculate a precoder to be used when transmitting a PUSCH in an uplink subband, the associated CSI-RS may need to be received in a frequency resource corresponding to the uplink subband. However, when the UE receives DCI 24-15 that triggers the aperiodic associated CSI-RS in the SBFD slot where the uplink subband exists, if the aperiodic associated CSI-RS 24-20, 24-25, 24-30 of the UE that may be triggered through the DCI as described above is triggered in the SBFD slot, the resource position where the associated CSI-RS is transmitted may overlap with the uplink subband depending on the time and frequency resource allocation configurations of the associated CSI-RS (24-30). In this case, the UE may not receive the associated CSI-RS in the resource position that overlaps with the uplink subband among the resource positions where the associated CSI-RS is transmitted, and may not perform downlink channel estimation and uplink precoder calculation in the frequency resource corresponding to the uplink subband.

To address these situations, the UE may receive the aperiodic associated CSI-RS based on a combination of at least one of the following methods.

### [Method 4-1]

When the UE has received SBFD related configuration (for example, when the frequency resources and time resources related to uplink subbands are configured), it may be assumed that the UE receives the DCI triggering the aperiodic associated CSI-RS from the base station only in the downlink slot 24-05. Since the UE may use the aperiodic associated CSI-RS to calculate the uplink precoder, the UE may need to calculate the precoder that may be used in the uplink subband based on the associated CSI-RS 24-10 received at the same frequency as the uplink subband. To this end, the UE may assume that the DCI triggering the aperiodic associated CSI-RS is received only in the downlink slot, and only in time resources where frequency resources such as uplink subbands operate as downlink, and the UE may expect that the aperiodic associated CSI-RS triggered by the DCI is received in the same slot as the corresponding DCI. Although restricting the UE to receive the DCI triggering aperiodic associated CSI-RS only in downlink slots may reduce the scheduling freedom of the base station and increase the delay when scheduling non-codebook-based PUSCH for the UE, it may be advantageous in that the precoder that may be used in uplink subbands can be calculated based on the associated CSI-RS received at the same frequency as the uplink subbands.

### [Method 4-2]

When the UE has received SBFD-related configuration (for example, when the frequency resources and time resources related to uplink subbands are configured), it may be assumed that there is no restriction on the type of slot in which the UE receives the DCI triggering the aperiodic associated CSI-RS from the base station. In this case, when the UE receives a DCI triggering an aperiodic associated CSI-RS from the base station in the SBFD slot (24-15), the UE may expect that the triggered aperiodic associated CSI-RS is received not only in the downlink frequency resources 24-20, 24-25 within the SBFD slot but also in the frequency resources corresponding to the uplink subband 24-30. This may mean that the UE is allowed to receive a downlink signal also in the frequency resources operating as uplink within the SBFD slot. In this case, the UE may operate through a combination of at least one of the following items for uplink transmission in the frequency resources corresponding to the uplink subbands within the SBFD slot.
For example, the UE may not expect other uplink transmissions in the frequency resources corresponding to the uplink subbands in all symbols within the corresponding SBFD slot. This may allow the UE to reduce complexity and power consumption by restricting the mode change between uplink and downlink within the corresponding SBFD slot, but may have a disadvantage that the uplink frequency band within the corresponding SBFD slot cannot be used for uplink transmission when the aperiodic associated CSI-RS is triggered within the corresponding SBFD slot.
For another example, the UE may perform other uplink transmissions in the frequency resources corresponding to the uplink subband in the remaining symbols except for the symbols in which the aperiodic associated CSI-RS is received within the corresponding SBFD slot. In this case, the UE may have restrictions on the number of times the UE changes between uplink transmission and downlink reception within the corresponding SBFD slot. This may allow the UE to maximize resource utilization efficiency within the corresponding SBFD slot, but may have a disadvantage that the UE may change modes between uplink and downlink more frequently.

When the UE is scheduled for uplink transmission in the uplink subband within the SBFD slot, the UE may define a priority for whether to receive the triggered aperiodic associated CSI-RS or perform the scheduled uplink transmission, and determine whether to receive the aperiodic associated CSI-RS. That is, the priority between the reception of the aperiodic associated CSI-RS and the scheduled uplink transmission may be defined, and which operation to perform may be determined according to the priority.

For example, when the uplink transmission in the uplink subband within the SBFD slot is a periodic or semi-persistent uplink transmission scheduling, the UE may cancel the corresponding uplink transmission and receive the aperiodic associated CSI-RS. For another example, when the uplink transmission in the uplink subband within the SBFD slot is aperiodic uplink transmission scheduling, the UE may cancel the reception of the aperiodic associated CSI-RS and perform the aperiodic uplink transmission.

In another way, the UE may expect to receive DCI such that the UE can receive aperiodic associated CSI-RS only in SBFD slots where uplink transmission is not scheduled. In this case, the UE may expect to receive DCI that triggers aperiodic associated CSI-RS only in SBFD slots where periodic or semi-persistent uplink transmission is not scheduled, and in the case of aperiodic uplink transmission, the UE may not expect to receive DCI that triggers aperiodic uplink transmission and aperiodic associated CSI-RS within the same SBFD slot through scheduling by the base station.

### [Method 4-3]

When the UE has received SBFD-related configuration (for example, when the frequency resources and time resources related to uplink subbands are configured), it may be assumed that there is no restriction on the type of slot in which the UE receives the DCI triggering the aperiodic associated CSI-RS from the base station. However, when the UE receives a DCI that triggers an aperiodic associated CSI-RS in an SBFD slot (24-15), the UE may expect that the triggered aperiodic associated CSI-RS may not be received in the same slot in which the corresponding DCI is received, but may be received in a downlink slot closest to the SBFD slot in which the corresponding DCI is received (24-35). That is, the aperiodic associated CSI-RS may be received in a downlink slot closest to the SBFD slot in which the corresponding DCI is received among downlink slots after the SBFD slot in which the corresponding DCI is received. Accordingly, the UE may determine in which slot the aperiodic associated CSI-RS may be triggered, depending on whether the DCI that triggers the aperiodic associated CSI-RS is received in a downlink slot or an SBFD slot. Through this, the problem of not receiving the aperiodic associated CSI-RS in the uplink subband even if the UE receives the information triggering the corresponding aperiodic associated CSI-RS in the SBFD slot may be addressed, but this may entail additional delay for non-codebook based PUSCH transmission.

### [Method 4-4]

When the UE has received the SBFD-related configuration (for example, when the frequency resources and time resources related to the uplink subbands are configured), it may be assumed that there is no restriction on the type of slot in which the UE receives the DCI triggering the aperiodic associated CSI-RS from the base station. In this case, when the UE receives the DCI triggering the aperiodic associated CSI-RS from the base station in the SBFD slot (24-15), the UE may receive the triggered aperiodic associated CSI-RS only in the downlink frequency resources 24-20, 24-25 in the SBFD slot, and may not receive the CSI-RS in the frequency resources corresponding to the uplink subband 24-30. In this case, when the UE supports a specific UE capability, the UE may estimate and predict the channel of the uplink subband using the aperiodic associated CSI-RS received in the downlink subband even if the UE did not receive the aperiodic associated CSI-RS in the uplink subband from the base station, and may calculate the precoder to be used for uplink transmission. In this case, the specific UE capability may mean that the UE can estimate and predict the channel of the uplink subband using the aperiodic associated CSI-RS received in the downlink subband. This may require additional implementation complexity for the UE to estimate and predict the channel of the uplink subband, but it can be flexible in resource allocation for the aperiodic associated CSI-RS from the perspective of base station and the UE.

Although the above [Method 4-1] to [Method 4-4] are mentioned as being applied to the aperiodic associated CSI-RS, they can be extended to the periodic or semi-persistent associated CSI-RS. For example, when a UE receives a periodic or semi-persistent associated CSI-RS based on [Method 4-1], the UE may expect to be configured by the base station such that the periodicity of the corresponding periodic or semi-persistent associated CSI-RS is X times the periodicity of the SBFD slot (wherein, X may be a natural number or a rational number such as ½ or ⅓. When X is a rational number, it may mean that the periodicity of the SBFD slot is a multiple of the periodicity of the periodic or semi-persistent associated CSI-RS), and may expect that the periodic or semi-persistent associated CSI-RS is received only in the downlink slot. As another example, when a UE receives a periodic or semi-persistent associated CSI-RS based on [Method 4-4], the UE may assume that there is no specific restriction between the periodicity of the periodic or semi-persistent associated CSI-RS and the periodicity of the SBFD slot, and when the periodic or semi-persistent associated CSI-RS is received in the SBFD slot, the UE may not expect to receive the corresponding associated CSI-RS in the uplink subband, and may perform estimation and prediction of channel information for the uplink subband based on the associated CSI-RS received in the downlink subband.

The UE may be notified of a combination of at least one of [Method 4-1] to [Method 4-4] by the base station through a combination of at least one of higher layer signaling, MAC-CE signaling, and L1 signaling, or may expect that a combination of at least one of [Method 4-1] to [Method 4-4] is fixedly defined in the specification. Additionally, when the UE is notified of a combination of specific one or more methods by the base station through a combination of at least one of higher layer signaling, MAC-CE signaling, and L1 signaling, it may mean that the UE cannot support other combinations of the specific one or more methods. For example, the UE may expect that [Method 4-1] is fixedly defined in the specification, and it may be assumed that the UE uses [Method 4-1] when the UE receives a DCI triggering an aperiodic associated CSI-RS from the base station. As another example, the UE may be notified of the above [Method 4-2] by the base station through a combination of at least one of higher layer signaling, MAC-CE signaling, and L1 signaling, and in this case, it may be considered that the UE has been notified by the base station that the above [Method 4-1] is not supported.

The UE may report to the base station as a UE capability whether the UE can support a combination of at least one of the above [Method 4-1] to [Method 4-4]. In this case, when the UE reports to the base station as a UE capability that a combination of specific one or more methods can be supported, it may be considered that the UE has reported that other combinations of the specific one or more methods cannot be supported. As an example, the UE may report to the base station as to whether the UE can support the above [Method 4-1]. As another example, the UE may report to the base station that the UE can support the above [Method 4-2], and this UE capability report may mean that the UE cannot support [Method 4-1].

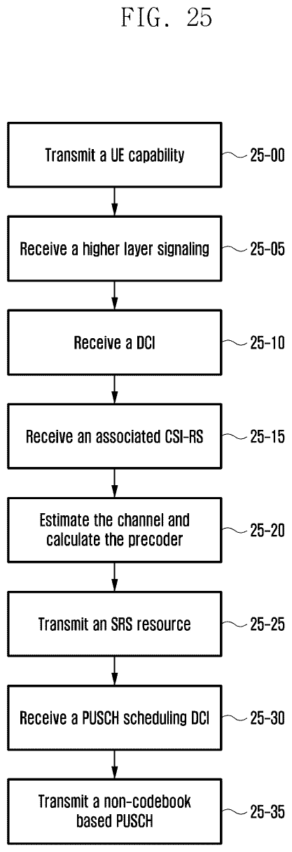

FIG. 25 illustrates an operation of a UE for non-codebook based PUSCH transmission in an SBFD system according to an embodiment of the disclosure.

At step 25-00, the UE may transmit a UE capability to the base station. In this case, UE capability signaling that may be reported may be for a combination of at least one of UE capability related to SBFD operation, UE capability related to non-codebook based PUSCH transmission support, UE capability related to SRS resource configuration and SRS resource set configuration where usage may be set to non-codebook, UE capability related to associated CSI-RS support, and UE capabilities corresponding to [Method 4-1] to [Method 4-4]. It is also possible that the above step 25-00 is omitted.

At step 25-05, the UE may receive higher layer signaling from the base station according to the reported UE capability. In this case, the UE may be defined by the base station about higher layer parameters for a combination of at least one of the higher layer signaling related to SBFD operation, the higher layer signaling related to non-codebook-based PUSCH transmission support, the SRS resource configuration and SRS resource set configuration where usage may be set to non-codebook, the higher layer signaling related to associated CSI-RS support, and the configurations related to [Method 4-1] to [Method 4-4], and may use one of them.

At step 25-10, the UE may receive DCI from the base station. In this case, the format of the DCI may be 1_1, 1_2, 0_1, or 0_2. The UE may trigger on the SRS set indicated through the SRS request field in the corresponding DCI.

At step 25-15, the UE may receive the associated CSI-RS from the base station. In this case, the UE may know how the aperiodic associated CSI-RS is triggered through DCI and at which position the UE exists according to a combination of at least one of [Method 4-1] to [Method 4-4].

At step 25-20, the UE may estimate the channel between the base station and the UE based on the associated CSI-RS received from the base station and calculate the precoder.

At step 25-25, the UE may apply the calculated precoder to one or more SRS resources and transmit the same to the base station.

At step 25-30, the UE may receive DCI scheduling non-codebook based PUSCH transmission from the base station.

At step 25-35, the UE may perform non-codebook based PUSCH transmission by referring to the precoding-related scheduling information in the DCI received from the base station.

The above flowchart illustrates an exemplary method that may be implemented according to the principles of the present disclosure, and various modifications may be made to the method illustrated in the flowchart herein. For example, although illustrated as a series of steps, various steps in each drawing may overlap, occur in parallel, occur in different orders, or occur multiple times. In other examples, steps may be omitted or replaced with other steps.

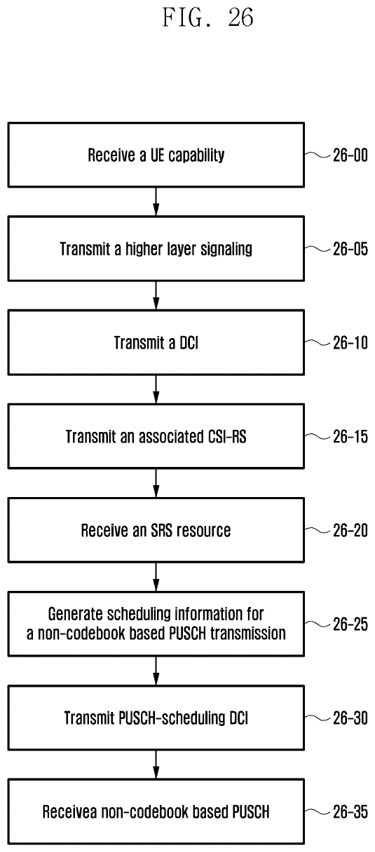

FIG. 26 illustrates an operation of a base station for non-codebook based PUSCH transmission in an SBFD system according to an embodiment of the disclosure.

At step 26-00, the base station may receive a UE capability from the UE. In this case, the UE capability signaling that may be received by the base station may be a combination of at least one of the UE capability related to SBFD operation, the UE capability related to non-codebook based PUSCH transmission support, the UE capability related to SRS resource configuration and SRS resource set configuration where usage can be set to non-codebook, the UE capability related to associated CSI-RS support, and the UE capability corresponding to the above [Method 4-1] to [Method 4-4]. It is also possible that the above step 26-00 is omitted.

At step 26-05, the base station may transmit higher layer signaling from the base station according to the UE capability reported by the UE. In this case, the UE may be defined by the base station about higher layer parameters for a combination of at least one of the higher layer signaling related to SBFD operation, the higher layer signaling related to non-codebook-based PUSCH transmission support, the SRS resource configuration and SRS resource set configuration where usage may be set to non-codebook, the higher layer signaling related to associated CSI-RS support, and the configurations related to [Method 4-1] to [Method 4-4], and may use one of them.

At step 26-10, the base station may transmit a DCI to the UE. In this case, the format of the DCI may be 1_1, 1_2, 0_1, or 0_2.

At step 26-15, the base station may receive an SRS resource transmitted by the UE.

At step 26-20, the base station may receive the SRS resource transmitted by the UE and generate precoding information for scheduling non-codebook based PUSCH transmission to the UE.

At steps 26-30, the base station may transmit a PUSCH scheduling DCI to the UE.

At steps 26-35, the base station may receive a non-codebook based PUSCH from the UE.

The above flowchart illustrates an exemplary method that may be implemented according to the principles of the present disclosure, and various modifications may be made to the method illustrated in the flowcharts herein. For example, although illustrated as a series of steps, various steps in each drawing may overlap, occur in parallel, occur in different orders, or occur multiple times. In other examples, steps may be omitted or replaced with other steps.

### CSI-RS Resource Division (CSI Subband Construction)

The technical problem to be addressed in the following disclosure is related to a method for determining a CSI subband based on the CSI-RS resource configured to the SBFD-capable UE. In the description below, A˜B means A or more and B or less. For example, 24˜72 means 24 or more and 72 or less.

More specifically, the problem to be addressed in the present disclosure is as follows.

The SBFD-capable UE may be configured with a plurality of DL subbands in an SBFD symbol (a symbol configured with UL subbands or DL subbands). The plurality of DL subbands may occupy different frequency bands (non-overlapping each other) on the frequency axis. For the UE, non-DL subband resources in the SBFD symbol may be UL subbands, or guard bands between UL subbands and DL subbands. For convenience, the DL subbands and non-DL subband frequency domains may be expressed in the following description. Here, a non-DL subband frequency domain may include a UL subband or a guard band.

In the present disclosure, two DL subbands may be assumed for convenience. However, this is only an example, and the present disclosure may be extended to a case where two or more DL subbands are configured.

In the description of an embodiment of the present disclosure, an SBFD symbol means a symbol in which a UL subband or a DL subband is configured among downlink symbols or flexible symbols according to a TDD configuration. In the present disclosure, a non-SBFD symbol refers to a symbol in which a UL subband and a DL subband are not configured among downlink symbols or flexible symbols according to a TDD configuration.

An SBFD-capable UE may be configured with CSI-RS resources by a base station. An SBFD-capable UE may be configured with CSI-RS resources through at least one of the following two methods.
As a first method for configuring non-contiguous CSI-RS resources, the CSI-RS resource configuration may include configuration for one set of contiguous RBs within each DL subband (a starting RB (startingRB) and a number of contiguous RBs (nrofRB)). For example, when a UE is configured with two DL subbands, one set of contiguous RBs may be configured for a first DL subband, and one set of contiguous RBs may be configured for a second DL subband.
As a second method for configuring non-contiguous CSI-RS resources, the CSI-RS resource configuration may include a first configuration for one set of contiguous RBs across a plurality of DL subbands (a starting RB (startingRB) and a number of contiguous RBs (nrofRB)). For example, when a UE is configured with two DL subbands, the UE may, based on the first configuration, determine that a starting RB of the contiguous RBs may be located in the first DL subband and that a last RB of the contiguous RBs may be located in the second DL subband. The CSI-RS resource configuration may include a second configuration (a starting RB (startingRB) and a number of contiguous RBs (nrofRB)) for one set of contiguous RBs for indicating resources that cannot be used for CSI-RS resources. The UE may determine the starting RB of the contiguous RBs and the number of contiguous RBs based on the second configuration. The UE may exclude the one contiguous RBs (the second resource) determined according to the second configuration from the one contiguous RBs (the first resource) determined according to the first configuration. In other words, the UE may regard the remaining RBs excluding the second resource from the first resource as CSI-RS resources.

In the second method, the second configuration information may be omitted in the CSI-RS resource configuration. In this case, for the UE, the second resource may be a frequency band other than a DL subband. Therefore, the UE may determine the CSI-RS resource by excluding the frequency band other than a DL subband from the first resource.

In the description of the present disclosure, the first DL subband may be a DL subband corresponding to a low frequency on the frequency axis, and the second DL subband may be a DL subband corresponding to a high frequency on the frequency axis. In the present disclosure, low to high, and start to end may be defined on the frequency axis.

In the description of the present disclosure, the CSI-RS according to the above method may be referred to as a non-contiguous CSI-RS resource (on the frequency axis). In addition, the first CSI-RS part refers to a CSI-RS resource determined within the first DL subband among the CSI-RS resources. The second CSI-RS part refers to a CSI resource determined within the second DL subband among the CSI-RS resources.

The UE may divide the CSI-RS resource into one or more CSI subbands on the frequency axis. When the CSI-RS resource is continuous (on the frequency axis), the UE may divide the CSI-RS resource into CSI subbands as follows.

The UE may determine the size of the CSI subband. The size of the CSI subband may be determined based on [Table 26]. Referring to [Table 26], BWP indicates the number of PRBs included in the downlink BWP. That is, when the number of PRBs included in the downlink BWP is 24 to 72, the size of the CSI subband may be X1=4 or X2=8. When the number of PRBs included in the downlink BWP is 73 to 144, the size of the CSI subband may be X1=8 or X2=16. When the number of PRBs included in the downlink BWP is 145 to 275, the size of the CSI subband may be X1=16 or X2=32. The UE may set one of the values of X1 and X2 according to the higher layer signal.

TABLE 26

| BWP (PRBs) | CSI Subband size (PRBs) |
|---|---|
| 24-72 | 4, 8 |
| 73-144 | 8, 16 |
| 145-275 | 16, 32 |

The size of the CSI subband determined by the UE is referred to as P. In this case, the CSI subband may be determined as follows.

The size of the first CSI subband (the number of RBs included) is P−(N_{BWP}^{start} mod P), and the size of the last CSI subband is (N_{BWP}^{start}+N_{BWP}^{size}) mod P when (N_{BWP}^{start}+N_{BWP}^{size}) mod P is not 0, and is P when (N_{BWP}^{start}+N_{BWP}^{size}) mod P is 0. Here, the number of CSI subbands (N_{SB}) is as follows: N_{SB}=ceil((N_{BWP}^{size}+(N_{BWP}^{start} mod P))/P). Here, ceil(x) represents the smallest integer among the numbers greater than or equal to x.

A technical problem to be addressed in the present disclosure is related to a method for determining a CSI subband for a non-continuous CSI-RS.

Let the index of the starting RB of the first DL subband configured to the UE be N_{DL1}^{start}, and the number of RBs included in the first DL subband be N_{DL1}^{size}. Let the index of the starting RB of the second DL subband configured to the UE be N_{DL2}^{start}, and the number of RBs included in the second DL subband be N_{DL2}^{size}. For reference, it may be N_{DL1}^{start}+N_{DL1}^{size}<N_{DL2}^{start}. RB with N_{DL1}^{start}=0 and RB with N_{DL2}^{start}=0 may be identical to the common resource block (CRB) with index 0. For reference, it may be N_{DL1}^{start}=N_{BWP}^{start}, and may be N_{DL2}^{start}+N_{DL2}^{size}=N_{BWP}^{size}.

The UE may generate CSI subbands by dividing a first DL subband and a second subband along the frequency axis. A method for this is disclosed.

The UE may determine the size of the CSI subband as follows.

As a first method for determining the size of the CSI Subband, the UE may determine the size of the CSI subband based on the number of RBs included in the downlink BWP. When the number of PRBs included in the downlink BWP is 24 to 72, the size of the CSI subband may be X1=4 or X2=8. When the number of PRBs included in the downlink BWP is 73 to 144, the size of the CSI subband may be X1=8 or X2=16. When the number of PRBs included in the downlink BWP is 145 to 275, the size of the CSI subband may be X1=16 or X2=32. The UE may set one of the values of X1 and X2 according to the higher layer signal.

As a second method for determining the size of the CSI subband, the UE may determine the size of the CSI subband based on the total number of RBs included in the DL subbands (N_{DL1}^{size}+N_{DL2}^{size}). When the total number of RBs included in the DL subbands (N_{DL1}^{size}+N_{DL2}^{size}) is 24 to 72, the size of the CSI subband may be X1=4 or X2=8. When the total number of RBs included in the DL subbands (N_{DL1}^{size}+N_{DL2}^{size}) is 73 to 144, the size of the CSI subband may be X1=8 or X2=16. When the total number of RBs included in the DL subbands (N_{DL1}^{size}+N_{DL2}^{size}) is 145 to 275, the size of the CSI subband may be X1=16 or X2=32. The UE may set one of the values of X1 and X2 according to the higher layer signal. Here, the interval (24˜72, 73˜144, 145˜275) and the values of X1 and X2 are examples.

As a third method for determining the size of the CSI Subband, the UE may determine the size of the CSI subband based on the value of one of the numbers of RBs included in each DL subband. Here, the one value may be the largest value among the numbers of RBs included in the DL subbands. It may be the smallest value among the numbers of RBs included in the DL subbands. When the selected one value is 24 to 72, the size of the CSI subband may be X1=4 or X2=8. When the selected one value is 73 to 144, the size of the CSI subband may be X1=8 or X2=16. When the selected one value is 145 to 275, the size of the CSI subband may be X1=16 or X2=32. The UE may set one of the values of X1 and X2 according to the higher layer signal. Here, the intervals (24 to 72, 73 to 144, 145 to 275) and the values of X1 and X2 are examples.

As a fourth method for determining the size of the CSI Subband, the UE may be configured with the size of the CSI subband by the base station. That is, the UE may be configured with one of the values (2, 4, 8, 16, 32) for the size of the CSI subband by the base station. Here, (2, 4, 8, 16, 32) is an example, and one of other values, for example, (2, 4, 6, 8, 12, 16, 24, 32) may be configured.

In the first to fourth methods for determining the size of the CSI subband, the UE may be configured with a single CSI subband size value. With the above CSI subband size value, The UE may divide the first DL subband and the second DL subband along the frequency axis. Specific methods may be as follows.

<Frequency Axis Division Method 1: Divide Two DL Subbands Along the Frequency Axis with the Size of One CSI Subband>
The size of the CSI subband determined by the UE is referred to as P. In this case, The CSI subband may be determined as follows.

Within the first DL subband, the size of the first CSI subband (the number of RBs included in the CSI subband) is P−(N_{DL1}^{start} mod P), and the size of the last CSI subband is (N_{DL1}^{start}+N_{DL1}^{size}) mod P when (N_{DL1}^{start}+N_{DL1}^{size}) mod P is not 0, and is P when (N_{DL1}^{start}+N_{DL1}^{size}) mod P is 0. Here, the number of CSI subbands (N_{SB1}) within the first DL subband is as follows: N_{SB1}=ceil((N_{DL1}^{size}+(N_{DL1}^{start} mod P))/P). Here, ceil (x) represents the smallest integer among the numbers greater than or equal to x.

Within the second DL subband, the size of the first CSI subband (the number of RBs included in the CSI subband) is P−(N_{DL2}^{start} mod P), and the size of the last CSI subband is (N_{DL2}^{start}+N_{DL2}^{size}) mod P, when (N_{DL2}^{start}+N_{DL2}^{size}) mod P is not 0, and is P when (N_{DL2}^{start}+N_{DL2}^{size}) mod P is 0. Here, the number of CSI subbands (N_{SB2}) within the second DL subband is as follows: N_{SB2}=ceil((N_{DL2}^{size}+(N_{DL2}^{start} mod P))/P). Here, ceil(x) represents the smallest integer among the numbers greater than or equal to x.

The total number of CSI subbands may be N_{SB1}+N_{SB2}=ceil((N_{DL1}^{size}+(N_{DL1}^{start} mod P))/P)+ceil((N_{DL2}^{size}+(N_{DL2}^{start} mod P))/P).

As above, in the first to fourth methods for determining the size of the CSI Subband, the UE determines the size of one CSI subband, and apply the same to all DL subbands. However, the size of each DL subband (the number of RBs included in each DL subband) may be different. For example, when the first DL subband includes multiple RBs, and the second DL subband includes a small number of RBs, the size of the determined CSI subband may be larger when compared to the size of the second DL subband. To this end, the size of the CSI subband may be determined based on the size of each DL subband. Specific methods are disclosed.

As a fifth method for determining the size of the CSI subband, the size of the CSI subband for the first DL subband may be determined based on the size of the first DL subband (N_{DL1}^{size¬}), and the size of the CSI subband for the second DL subband may be determined based on the size of the second DL subband (N_{DL2}^{size¬}). When the size of the CSI subband for the kth DL subband is 24 to 72, the size of the CSI subband within the kth DL subband may be X1=4 or X2=8. When the size of the CSI subband for the kth DL subband is 73 to 144, the size of the CSI subband within the kth DL subband may be X1=8 or X2=16. When the size of the CSI subband for the kth DL subband is 145 to 275, the size of CSI subbands within the kth DL subband may be X1=16 or X2=32. The UE may set one of the values of X1 and X2 according to the higher layer signal. Here, it may be that k=1 or 2. Here, the size of the CSI subband within the first DL subband and the size of the CSI subband within the second DL subband may be the same or different.

As a sixth method for determining the size of the CSI Subband, the UE may be configured with the size of the CSI subband within the first DL subband and the size of the CSI subband within the second DL subband by the base station. That is, The UE may be configured with two values among the values (2, 4, 8, 16, 32) for the size of the CSI subband by the base station. The first value among the two values is the size of the CSI subband within the first DL subband, and the second value may be the size of the CSI subband within the second DL subband. The first and second values may be the same or different.

In the fifth to sixth methods for determining the size of the CSI subband, the UE may be configured with a CSI subband size value for each DL subband. With the above CSI subband size value, the UE may divide each of the DL subbands independently along the frequency axis. Specific methods may be as follows.

<Frequency Axis Division Method 2: Divide Each of the Two DL Subbands Along the Frequency Axis with the Size of the Two CSI Subbands>
The first DL subband may be divided into CSI subbands as follows. Let the size of the CSI subband of the first DL subband determined by the UE be P1. In this case, the CSI subband of the first subband may be determined as follows.
Within the first DL subband, the size of the first CSI subband (the number of RBs included) is P1−(N_{DL1}^{start} mod P1), and the size of the last CSI subband is (N_{DL1}^{start}+N_{DL1}^{size}) mod P1 when (N_{DL1}^{start}+N_{DL1}^{size}) mod P1 is not 0, and is P1 when (N_{DL1}^{start}+N_{DL1}^{size}) mod P1 is 0. Here, the number of CSI subbands (N_{SB1}) within the first DL subband is as follows: N_{SB1}=ceil((N_{DL1}^{size}+(N_{DL1}^{start} mod P1))/P1). Here, ceil(x) represents the smallest integer among the numbers greater than or equal to x.
The second DL subband may be divided into CSI subbands as follows. Let the size of the CSI subband of the second DL subband determined by the terminal be P2. In this case, the CSI subband of the second subband may be determined as follows.

Within the second DL subband, the size of the first CSI subband (the number of RBs included) is P2−(NDL2start mod P2), and the size of the last CSI subband is (NDL2start+NDL2size) mod P2 when (NDL2start+NDL2size) mod P2 is not 0, and is P2 when (NDL2start+NDL2size) mod P2 is 0. Here, the number of CSI subbands (NSB2) in the second DL subband is as follows: NSB2=ceil((NDL2size+(NDL2start mod P2))/P2). Here, ceil(x) represents the smallest integer among the numbers greater than or equal to x.
The total number of CSI subbands may be NSB1+NSB2=ceil((NDL1size+ (NDL1start mod P1))/P1)+ceil((NDL2size+ (NDL2start mod P2))/P2).

In the above first to sixth methods, the UE divides the DL subbands into CSI subbands. However, even if the UE is configured with DL subbands, the UE may divide the CSI subbands based on the DL BWP.

<Frequency Axis Division Method 3: Divide DL BWP Including Two DL Subbands Along Frequency Axis with the Size of One CSI Subband>
The UE assume the size of the CSI subband as P. In this case, the above value P may be determined based on at least one method or a combination of one or more methods from the first to sixth methods.
The size of the first CSI subband (the number of RBs included) in DL BWP is P−(NBWPstart mod P), and the size of the last CSI subband is (NBWPstart+NBWPsize) mod P when (NBWPstart+NBWPsize) mod P is not 0, and is P when (NBWPstart+NBWPsize) mod P is 0. Here, the number of CSI subbands (NSB) is as follows: NSB=ceil((NBWPsize+(NBWPstart mod P))/P). Here, ceil(x) represents the smallest integer among the numbers greater than or equal to x.

One or some of the above CSI subbands completely overlap with a frequency band other than a DL subband. The above CSI subbands may be excluded.

As an embodiment of the present disclosure, the UE may determine one of frequency axis division method 1 to frequency axis division method 3 as follows.
For example, the UE may be configured with at least one frequency axis division method from a higher layer.
For example, the UE may determine one frequency axis division method based on the type of the symbol in which the CSI-RS is received. More specifically, in a non-SBFD symbol, the UE may determine CSI subbands based on the frequency axis division method 3. In a SBFD symbol, the UE may determine CSI subbands based on the frequency axis division methods 1 to 2. According to this example, the UE is configured with one CSI reporting, but CSI subbands may be determined with different methods depending on the symbol type. Therefore, the CSI subbands determined depending on the symbol type may be different from each other.
For example, the UE may determine one frequency axis division method based on the symbol type of the symbols in which periodic or semi-persistent CSI-RS is received. More specifically, when the CSI-RSs configured to the UE overlap with non-SBFD symbols in all periods (but do not overlap with SBFD symbols), the UE may determine the CSI subband based on the frequency axis division method 3. When the CSI-RSs configured to the UE overlap with SBFD symbols, the UE may determine the CSI subbands based on the frequency axis division methods 1 and 2. According to this example, the UE may apply the CSI-subbands to all CSI-RSs belonging to one CSI reporting. According to this example, the UE may have CSI subbands determined with one method for all symbols.

### CSI Reporting Band Indication Method

The CSI report configuration of the UE may indicate a frequency band (CSI reporting band) in which CSI information is used for calculation. That is, the UE may calculate CSI information based on the CSI-RS received in the above frequency band and report the same to the base station. The problem addressed in the present disclosure is related to a method for the base station to configure the CSI reporting band to the UE.

More specifically, the base station may indicate to the UE whether each CSI subband is included in the CSI reporting band. [Table 27] shows higher layer signals for indicating CSI subbands included in the CSI reporting band. Referring to [Table 27], csi-ReportingBand may include a configuration constituted by bitmaps of different lengths. For example, subbands3 may be a bitmap of 3 bits in length. The UE may determine the CSI subbands included in the CSI reporting band based on the above bitmap. For example, when the UE includes three CSI subbands in the DL BWP, the UE may receive indication of subbands3 from the base station. subbands3 is a bitmap with a length of 3 bits, where each bit corresponds to one CSI subband. When the bit is “1,” the UE may determine that the above CSI subband is included in the CSI reporting band.

For convenience of description, unless otherwise stated, the bitmap may denote one of subbands3, . . . , subbands19.

TABLE 27

| | |
|---|---|
| reportFreqConfiguration | SEQUENCE { |
| cqi-FormatIndicator | ENUMERATED { widebandCQI, subbandCQI } |

OPTIONAL, -- Need R

| | |
|---|---|
| pmi-FormatIndicator | ENUMERATED { widebandPMI, subbandPMI } |

OPTIONAL, -- Need R

| | |
|---|---|
| csi-ReportingBand | CHOICE { |
| subbands3 | BIT STRING(SIZE(3)), |
| subbands4 | BIT STRING(SIZE(4)), |
| subbands5 | BIT STRING(SIZE(5)), |
| subbands6 | BIT STRING(SIZE(6)), |
| subbands7 | BIT STRING(SIZE(7)), |
| subbands8 | BIT STRING(SIZE(8)), |
| subbands9 | BIT STRING(SIZE(9)), |
| subbands10 | BIT STRING(SIZE(10)), |
| subbands11 | BIT STRING(SIZE(11)), |
| subbands12 | BIT STRING(SIZE(12)), |
| subbands13 | BIT STRING(SIZE(13)), |
| subbands14 | BIT STRING(SIZE(14)), |
| subbands15 | BIT STRING(SIZE(15)), |
| subbands16 | BIT STRING(SIZE(16)), |
| subbands17 | BIT STRING(SIZE(17)), |
| subbands18 | BIT STRING(SIZE(18)), |

...,

| | |
|---|---|
| subbands19-v1530 | BIT STRING(SIZE(19)) |

} OPTIONAL -- Need S

| | |
|---|---|
| } | OPTIONAL, -- Need R |

The technical problem to be addressed in the present disclosure is related to a method for a UE to receive an indication of a CSI subband included in a CSI reporting band from a base station.

According to an embodiment of the present disclosure, a UE may be configured with a non-SBFD symbol and an SBFD symbol. The UE may determine the number of first CSI subbands (N_{SB}(1)) based on one method (at least one method among the frequency axis division methods 1 to 3 described above) in the non-SBFD symbol. The UE may determine the number of second CSI subbands (N_{SB}(2)) based on one method (at least one method among the frequency axis division methods 1 to 3 described above) in the SBFD symbol.

As a first method for indicating a CSI reporting band, the UE may obtain the length of a bitmap based on one of the values of the number of first CSI subbands (N_{SB}(1)) and the number of second CSI subbands (N_{SB}(2)). Here, the length of the bitmap may be obtained based on the larger value of the two numbers N_{SB}(1) and N_{SB}(2). For example, when the number of the first CSI subband (N_{SB}(1)) is 3 and the number of the second CSI subband (N_{SB}(2)) is 5, the UE may obtain the length of the bitmap based on the larger value, 5. That is, the UE may receive an indication of the CSI subbands included in the CSI reporting band through subbands5.

All bits of the bitmap may be one-to-one corresponded to CSI subbands having a larger number of CSI subbands. Each bit of subband5 may correspond to each of the second CSI subbands. More specifically, the first most significant bit (MSB) of subbands5 may correspond to the first CSI subband on the frequency axis among the second CSI subbands. The second MSB of subbands5 may correspond to the second CSI subband on the frequency axis among the second CSI subbands. In this way, the bits of the bitmap may correspond to the CSI subbands in ascending order on the frequency axis from the MSB.

Some bits of the bitmap may correspond one-to-one with CSI subbands having a smaller number of CSI subbands. Some bits of subbands5 may correspond to the first CSI subbands.

As a more specific example, the UE may select N_{SB}(1)=3 bits in subbands5. Here, 3 bits may be selected from the MSB. The first most significant bit (MSB) among the 3 bits selected from subbands5 may correspond to a first CSI subband on the frequency axis among the first CSI subbands. The second MSB among the 3 bits selected from subbands5 may correspond to a second CSI subband on the frequency axis among the first CSI subbands. In this way, the 3 bits selected from subbands5 may correspond to the first CSI subbands in an ascending order on the frequency axis, from the MSB.

As another example, the first CSI subbands and the second CSI subbands determined by the UE may satisfy the following condition.

Condition: The first CSI subbands are a subset of the second CSI subbands, or the second CSI subbands are a subset of the first CSI subbands. Here, when the index and length of the starting RB of the CSI subband among the first CSI subbands and the second CSI subbands are the same, they can be determined to be the same CSI subband. When at least one of the index and length of the starting RB of the CSI subband is different, they can be determined to be not the same.

For example, when the second CSI subbands include all of the first CSI subbands, each bit of subbands5 may correspond to each of the second CSI subbands. More specifically, the first most significant bit (MSB) of subbands5 may correspond to a first CSI subband on the frequency axis among the second CSI subbands. The second MSB of subbands5 may correspond to a second CSI subband on the frequency axis among the second CSI subbands. In this way, the bits of the bitmap may correspond to the CSI subbands in ascending order on the frequency axis from the MSB. In addition, 3 bits of subbands5 may be used to indicate the first CSI subbands. Here, the 3 bits may be bits corresponding to the same second CSI subbands as the 3 first CSI subbands among the second CSI subbands. The above 3 bits may be used to indicate the first CSI subband.

As a second method for indicating a CSI reporting band, the UE may receive a first bitmap corresponding to the number of the first CSI subband (N_{SB}(1)) and a second bitmap corresponding to the number of the second CSI subband (N_{SB}(2)). In other words, the higher layer signal that the base station configures in the UE may include the first bitmap and the second bitmap. The first bitmap and the second bitmap may be included in csi-reportingBand. The lengths of the first bitmap and the second bitmap may be the same or different.

For example, the length of the first bitmap may be equal to N_{SB}(1). For example, the length of the second bitmap may be equal to N_{SB}(2).

For example, when the number of the first CSI subband (N_{SB}(1)) is 3 and the number of the second CSI subband (N_{SB}(2)) is 5, the UE may receive indication of subbands3 by the first bitmap and of subbands5 by the second bitmap.

Each bit of subbands3 may correspond to each of the first CSI subbands. More specifically, the first most significant bit (MSB) of subband3 may correspond to a first CSI subband on the frequency axis among the first CSI subbands. The second MSB of subband3 may correspond to a second CSI subband on the frequency axis among the first CSI subbands. In this way, the bits of subband3 may correspond to the first CSI subbands in ascending order on the frequency axis from the MSB.

Each bit of subbands5 may correspond to each of the second CSI subbands. More specifically, the first most significant bit (MSB) of subbands5 may correspond to a first CSI subband on the frequency axis among the second CSI subbands. The second MSB of subbands5 may correspond to a second CSI subband on the frequency axis among the second CSI subbands. In this way, the bits of subbands5 may correspond to the second CSI subbands in ascending order on the frequency axis from the MSB.

As a third method for indicating the CSI reporting band, the UE may receive a bitmap corresponding to the sum of the number of the first CSI subband (N_{SB}(1)) and the number of the second CSI subband (N_{SB}(2)). In other words, the higher layer signal that the base station configures in the UE may include one bitmap. Some bits (the first bits) of the one bitmap may indicate the first CSI subbands, and the remaining bits (the second bits) may indicate the second CSI subbands.

The length of the bitmap may be N_{SB}(1)+N_{SB}(2). The length of the first bit may be equal to N_{SB}(1). The length of the second bit may be equal to N_{SB}(2).

The first bits may be N_{SB}(1) bits from the MSB of the bitmap. The first bits may be N_{SB}(1) bits from the least significant bit (LSB) of the bitmap. Bits other than the first bits in the bitmap may be second bits.

For example, when the number of the first CSI subband (N_{SB}(1)) is 3 and the number of the second CSI subband (N_{SB}(2)) is 5, the UE may receive indication of subbands8 by the bitmap. Three bits in the subbands8 may be the first bits and the remaining five bits may be the second bits

Each of the first bits may correspond to each of the first CSI subbands. More specifically, the first most significant bit (MSB) among the first bits may correspond to a first CSI subband on the frequency axis among the first CSI subbands. The second MSB of the first bits may correspond to a second CSI subband on the frequency axis among the first CSI subbands. In this way, the first bits may correspond to the first CSI subbands in ascending order on the frequency axis from the MSB.

Each of the second bits may correspond to each of the second CSI subbands. More specifically, the first most significant bit (MSB) of the second bits may correspond to a first CSI subband on the frequency axis among the second CSI subbands. The second MSB of the second bits may correspond to a second CSI subband on the frequency axis among the second CSI subbands. In this way, the second bits may correspond to the second CSI subbands in ascending order on the frequency axis from the MSB.

As an example of the present disclosure, when a UE is configured with a plurality of DL subbands in an SBFD symbol, it may be configured with a bitmap about whether to include subbands to be included in the CSI reporting band in the DL subband. A method for this is disclosed.

In a first method, a UE can receive a first bitmap corresponding to the number (N_{SB1}) of CSI subbands in a first subband and a second bitmap corresponding to the number (N_{SB2}) of CSI subbands in a second subband. In other words, a higher layer signal configured by a base station in a UE may include the first bitmap and the second bitmap. The first bitmap and the second bitmap may be included in csi-reportingBand. The lengths of the first bitmap and the second bitmap may be the same or different.

For example, the length of the first bitmap may be equal to N_{SB1}. For example, the length of the second bitmap may be equal to N_{SB2}.

For example, when the number (N_{SB1}) of CSI subbands in the first subband is 3 and the number (N_{SB2}) of CSI subbands in the second subband is 5, the UE may receive indication of subbands3 by the first bitmap and of subbands5 by the second bitmap.

Each bit of subbands3 may correspond to each of the CSI subbands in the first subband. More specifically, the first most significant bit (MSB) of subband3 may correspond to a first CSI subband on the frequency axis among the CSI subbands in the first subband. The second MSB of subband3 may correspond to a second CSI subband on the frequency axis among the CSI subbands in the first subband. In this way, the bits of subband3 may correspond to the CSI subbands in the first subband in ascending order on the frequency axis from the MSB.

Each bit of subbands5 may correspond to each of the CSI subbands in the second subband. More specifically, the first most significant bit (MSB) of subband5 may correspond to a first CSI subband on the frequency axis among the CSI subbands in the second subband. The second MSB of subband5 may correspond to a second CSI subband on the frequency axis among the CSI subbands in the second subband. In this way, the bits of subband5 may correspond to the CSI subbands in the second subband in ascending order on the frequency axis from the MSB.

As a second method for indicating the CSI reporting band, the UE may receive a bitmap corresponding to the sum of the number (N_{SB1}) of CSI subbands in the first subband and the number (N_{SB2}) of CSI subbands in the second subband. In other words, the higher layer signal that the base station configures in the UE may include one bitmap. Some bits (the first bits) of the one bitmap may indicate CSI subbands within the first subband, and the remaining bits (the second bits) may indicate CSI subbands within the second subband.

The length of the bitmap may be N_{SB1}+N_{SB2}. The length of the first bits may be equal to N_{SB1}. The length of the second bits may be equal to N_{SB2}.

The first bits may be N_{SB1} bits from the MSB of the bitmap. The first bits may be N_{SB1} bits from the LSB of the bitmap. Bits other than the first bits in the bitmap may be second bits.

For example, when the number of the first CSI subband (N_{SB}(1)) is 3 and the number of the second CSI subband (N_{SB}(2)) is 5, the UE may receive indication of subbands8 by the bitmap. 3 bits in subbands8 may be the first bits and the remaining 5 bits may be the second bits.

Each of the first bits may correspond to each of the CSI subbands within the first subband. More specifically, the first most significant bit (MSB) of the first bits may correspond to a first CSI subband on the frequency axis among the CSI subbands within the first subband. The second MSB of the first bits may correspond to a second CSI subband on the frequency axis among the CSI subbands within the first subband. In this way, the first bits may correspond to the CSI subbands within the first subband in ascending order on the frequency axis from the MSB.

Each of the second bits may correspond to each of the CSI subbands within the second subband. More specifically, the first most significant bit (MSB) of the second bits may correspond to a first CSI subband on the frequency axis among the CSI subbands within the second subband. The second MSB of the second bits may correspond to a second CSI subband on the frequency axis among the CSI subbands in the second subband. In this way, the second bits may correspond to the CSI subbands within the second subband in ascending order on the frequency axis from the MSB.

In the first method and the second method, the UE may receive bitmap(s) indicating whether CSI subbands in the first DL subband and the second DL subband are included.

As a third method of the present disclosure, the UE may generate CSI subbands based on the downlink BWP and receive bitmaps indicating whether the above CSI subbands are included. Here, the length of the bitmap may be the same as the number of CSI subbands determined based on the downlink BWP.

The method for generating CSI subbands based on the downlink BWP may refer to the frequency axis division method 3. The CSI subbands determined by the UE may be one of the following three types.
As the first type, all RBs included in the CSI subband may be included in the DL subband.
As the second type, some of the RBs included in the CSI subband may be included in the DL subband, and the remaining ones may be included in a frequency band other than the DL subband.
As the third type, all RBs included in the CSI subband can be included in a frequency band other than the DL subband. The UE may expect that the bit corresponding to the above CSI subband in the bitmap may always be “0.” When the bit is “1,” the UE may determine that the information indicated by the base station is invalid. The bit value is an example, and conversely, the UE may determine that the information indicated by the base station is invalid when the bit is “0.” When it is determined to be invalid, the UE may discard the configurations indicated by the base station without applying them.

### Method for Determining the CSI Reporting Method

The UE may determine the CSI reporting method. CSI reporting may be either subband reporting or wideband reporting. In the case of subband reporting, the UE may generate CSI information for each subband belonging to the CSI reporting band and report the CSI information to the base station. In the case of wideband reporting, the UE may generate CSI information based on all subbands belonging to the CSI reporting band and report the CSI information to the base station.

Wideband reporting can also be expressed as wideband frequency-granularity.

Referring to [Table 27], the CSI reporting configuration may include information indicating whether the reporting configuration is wideband reporting or subband reporting. More specifically, cqi-FormatIndicator may be set to either widebandCQI (wideband reporting) or subbandCQI (subband reporting), and pmi-FormatIndicator may be set to either widebandPMI (wideband reporting) or subbandPMI (subband reporting).

The UE may be restricted to use only wideband reporting depending on the number of RBs included in the DL BWP. More specifically, when the number of RBs included in the DL BWP is less than 24, the UE may use only wideband reporting.

A technical problem to be addressed in the present disclosure is related to a method for determining whether to use wideband reporting depending on the number of RBs included in a plurality of DL subbands.

As an embodiment of the present disclosure, when at least one of the number of RBs included in the first DL subband (N_{DL1}^{size}) and the number of RBs included in the second DL subband (N_{DL2}^{size}) is less than 24 RBs, the UE may be restricted to use wideband reporting only. The above restriction may be applied only to CSI reporting for SBFD symbols. On the contrary, when both the number of RBs included in the first DL subband (N_{DL1}^{size}) and the number of RBs included in the second DL subband (N_{DL2}^{size}) are greater than or equal to 24 RBs, the UE may be capable of subband reporting

As an embodiment of the present disclosure, when both the number of RBs included in the first DL subband (N_{DL1}^{size}) and the number of RBs included in the second DL subband (N_{DL2}^{size}) are less than 24 RBs, the UE may be restricted to use wideband reporting only. The above restriction may be applied only to CSI reporting for SBFD symbols. On the contrary, when at least one of the number of RBs included in the first DL subband (N_{DL1}^{size}) and the number of RBs included in the second DL subband (N_{DL2}^{size}) is greater than or equal to 24 RBs, the UE may be capable of subband reporting.

As an embodiment of the present disclosure, when the sum of the number of RBs included in the first DL subband (N_{DL1}^{size}) and the number of RBs included in the second DL subband (N_{DL2}^{size}) is less than 24 RBs, the UE may be restricted to use wideband reporting only. The above restriction may be applied only to CSI reporting for SBFD symbols. On the contrary, when the sum of the number of RBs included in the first DL subband (N_{DL1}^{size}) and the number of RBs included in the second DL subband (N_{DL2}^{size}) is greater than or equal to 24 RBs, the UE may be capable of subband reporting.

In the above example, the same reporting method (wideband or subband) was applied to CSI reporting of the first and second DL subbands. However, different reporting methods may be applied to each DL subband.

In the case that different reporting methods (wideband or subband) are applied in the first and second DL subbands, and the subband reporting method is applied both in the first DL subband and the second DL subband, when calculating wideband CQI and wideband PMI within the first DL subband, the UE may calculate them based on channel state information measured in the CSI subband defined within the first DL subband, and likewise, when calculating wideband CQI and wideband PMI within a second DL subband, the UE may calculate them based on channel state information measured in the CSI subband defined within the second DL subband.

More specifically, different reporting methods for each DL subband may be configured in CSI reporting.

The UE may be configured with a reporting method for the first DL subband by the base station, and may be configured with a reporting method for the second DL subband. The reporting method for the first DL subband and the reporting method for the second DL subband may be the same or different. For example, referring to [Table 27], the CSI report configuration may include cqi-FormatIndicator and pmi-FormatIndicator for the first DL subband, and may include cqi-FormatIndicator and pmi-FormatIndicator for the second DL subband.

As an embodiment of the present disclosure, the UE may be restricted to use only wideband reporting based on the number of RBs included in each DL subband. For example, when the number of RBs included in the first DL subband (N_{DL1}^{size}) is less than 24 RBs, the UE may be restricted to use only wideband reporting in the first DL subband. The above restriction may be applied only to CSI reporting for the first DL subband. For example, when the number of RBs included in the second DL subband (N_{DL2}^{size}) is less than 24 RBs, the UE may be restricted to use only wideband reporting in the second DL subband. The above restriction may be applied only to CSI reporting for the second DL subband.

As an embodiment of the present disclosure, CSI reporting configuration may include a CSI reporting method for SBFD symbols and a CSI reporting method for non-SBFD symbols. More specifically, the UE may be configured by the base station with a reporting method for non-SBFD symbols, and may be configured with a reporting method for the SBFD symbols. The reporting method for the non-SBFD symbols and the reporting method for the SBFD symbols may be the same or different. For example, referring to [Table 27], the CSI report configuration may include cqi-FormatIndicator and pmi-FormatIndicator for the Non-SBFD symbols, and may include cqi-FormatIndicator and pmi-FormatIndicator for SBFD symbols.

For reference, when the wideband reporting method is configured in a non-SBFD symbol, the wideband reporting method may always be configured in the SBFD symbol as well. This is because the DL BWP of the non-SBFD symbol includes a larger number of RBs than the number of RBs included in the DL subbands of the SBFD symbol, so when wideband reporting is configured for more RBs, wideband reporting may always be configured for a smaller number of RBs.

### CSI-RS Configuration Constraints

Depending on the CSI-RS resource configurations, CSI-RS resources may be determined as follows.
The index of the starting RB included in the CSI-RS resource configuration is referred to as startingRB, and nrofRB is the number of contiguous RBs included in the CSI-RS resource. The RB with startingRB=0 may be the same as the common resource block (CRB) whose index is 0. For example, both startingRB and nrofRB may be integer multiples of 4. When startingRB<NBWPstart, the index of the starting RB of the CSI-RS resource (NinitialRB) may be NBWPstart, otherwise, it may be startingRB. When nrofRBs>NBWPsize+NBWPstart−NinitialRB, the number of RBs included in the CSI-RS resource (NBWCSI-RS) may be NBWPsize+NBWPstart−NinitialRB, otherwise it may be nrofRBs. Here, NBWPstart is the RB index where the BWP starts, which may be a CRB index, and N_{BWP}^{size} may be the number of RBs included in the BWP.

The number of RBs included in the CSI-RS may be greater than or equal to min {N_{BWP}^{size}, 24}. That is, when N_{BWP}^{size} is less than 24 RBs, the CSI-RS may occupy the entire band of DL BWP, and when N_{BWP}^{size} is greater than or equal to 24 RBs, the CSI-RS may occupy at least 24 RBs. This may be necessary to ensure the reliability of the CSI information.

According to an embodiment of the present disclosure, the UE may determine a configuration constraint of a CSI-RS based on a number of RBs included in a DL subband.

For example, the UE may determine the constraint of the CSI-RS based on one of the values of the number of RBs included in the first DL subband (N_{DL1}^{size}) and the number of RBs included in the second DL subband (N_{DL2}^{size}). For example, the constraint of CSI-RS may be determined based on the smaller value among the number of RBs including the first DL subband (N_{DL1}^{size}) and the number of RBs including the second DL subband (N_{DL2}^{size}). The determined value is M=min {N_{DL1}^{size}, N_{DL2}^{size}}. For example, the constraint of the CSI-RS may be determined based on the larger value among the number of RBs including the first DL subband (N_{DL1}^{size}) and the number of RBs including the second DL subband (N_{DL2}^{size}). The determined value may be M=max {N_{DL1}^{size}, N_{DL2}^{size}}.

For example, the UE may determine the constraint of the CSI-RS based on the sum of the number of RBs including the first DL subband (N_{DL1}^{size}) and the number of RBs including the second DL subband (N_{DL2}^{size}). The determined value may be M=N_{DL1}^{size}+N_{DL2}^{size}.

For example, the UE may determine the constraint of the CSI-RS based on the average of the number of RBs including the first DL subband (N_{DL1}^{size}) and the number of RBs including the second DL subband (N_{DL2}^{size}). The determined value may be M=(N_{DL1}^{size}+N_{DL2}^{size})/2.

The above determined value, M, may always be less than or equal to the number of RBs included in the DL BWP, N_{BWP}^{size}.

When the value of M is greater than or equal to 24, the CSI-RS may have to include at least 24 RBs. When the value of M is less than 24, the CSI-RS may always have to include all RBs of the first DL subband and the second DL subband.

For example, the UE may apply a constraint of the CSI-RS to each DL subband. More specifically, when the number of RBs included in the first DL subband (N_{DL1}^{size}) is greater than or equal to 24, the CSI-RS of the first DL subband may have to include at least 24 RBs. When the number of RBs included in the first DL subband (N_{DL1}^{size}) is less than 24, the CSI-RS of the first DL subband may have to include all RBs of the first DL subband. When the number of RBs included in the second DL subband (N_{DL2}^{size}) is greater than or equal to 24, the CSI-RS of the second DL subband may have to include at least 24 RBs. When the number of RBs included in the second DL subband (N_{DL2}^{size}) is less than 24, the CSI-RS of the second DL subband may have to include all RBs of the second DL subband.

A single CSI-RS resource configuration may be applied to both SBFD and non-SBFD symbols simultaneously. That is, periodic CSI or semi-persistent CSI may be received repeatedly according to the period. In this case, one CSI-RS reception occasion may be an SBFD symbol, and another CSI-RS reception occasion may be a non-SBFD symbol. A non-SBFD symbol may have contiguous CSI-RS resources, and a SBFD symbol may have non-contiguous CSI-RS resources. For example, a non-SBFD symbol may have contiguous CSI-RS resources on the frequency axis, and a SBFD symbol may have non-contiguous CSI-RS resources on the frequency axis. The non-contiguous CSI-RS resources in the SBFD symbol may be a subset of the contiguous CSI-RS resources in the non-SBFD symbol. The method for determining non-contiguous CSI-RS resources in the SBFD symbol may refer to method 1 to method 2 for configuring non-contiguous CSI-RS resources described above, and one or a combination of one or more of the methods may be applied.

The technical problem to be addressed in the present disclosure is a case where the CSI-RS constraints are satisfied in non-SBFD symbols, but the CSI-RS constraints are not satisfied in SBFD symbols.

More specifically, in a non-SBFD symbol, the number of RBs included in contiguous CSI-RSs may be greater than or equal to min {24, N_{BWP}^{size}}. However, in an SBFD symbol, the number of RBs included in non-contiguous CSI-RSs may violate the constraints in the preceding examples. In this case, the UE may perform at least one or a combination of at least one of the following actions.

When the number of RBs included in the non-contiguous CSI-RS in the SBFD symbol violates the constraint of the previous examples, the UE may not receive the above non-contiguous CSI-RS in the SBFD symbol. That is, the UE may determine that only the continuous CSI-RS in the non-SBFD symbol is valid and receive the same, and may use the continuous CSI-RS to calculate CSI information.

When the number of RBs included in the CSI-RS in the first DL subband of the SBFD symbol violates the constraint of the previous examples, the UE may not receive the CSI-RS in the first DL subband. However, when the number of RBs included in the CSI-RS in the second DL subband of the SBFD symbol satisfies the constraint of the previous examples, the CSI-RS may be received in the second DL subband. That is, the CSI-RS of the DL subband that satisfies the constraint among the DL subbands may still be assumed to be valid and may be used to calculate CSI information.

The UE may not expect that the number of RBs included in the non-contiguous CSI-RS in an SBFD symbol may violate the constraints according to an embodiment of the present disclosure described above. That is, the UE may expect that the number of RBs included in the non-contiguous CSI-RS in the SBFD symbol may not violate the constraints according to the embodiment of the present disclosure described above or may satisfy the constraints. That is, in the case that the UE is configured with the CSI-RS resource from the higher layer signal (RRC signal) of the base station, when the number of RBs included in the non-contiguous CSI-RS in the SBFD symbol violates the constraints of the previous examples, the above CSI-RS resource configuration may be determined to be invalid. The UE may discard the CSI-RS resource configuration determined to be invalid without applying it.

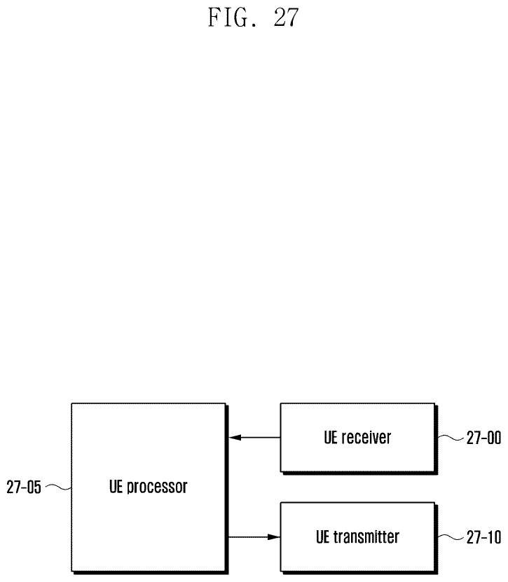

FIG. 27 illustrates a structure of a UE in a wireless communication system according to an embodiment of the disclosure.

With reference to FIG. 27, the UE may include a transceiver, which refers to a UE receiver 27-00 and a UE transmitter 27-10 as a whole, a memory (not illustrated), and a UE processor 27-05 (or UE controller or processor). The UE's transceiver 27-00 and 27-10, memory, and the UE processor 27-05 may operate according to the above-described communication methods of the UE. However, components of the UE are not limited to the above-described example. For example, the UE may include a larger or smaller number of components than the above-described components. Furthermore, the transceiver, memory, and processor may be implemented as a single chip.

The transceiver may transmit/receive signals with the base station. Here, the signals may include control information and data. To this end, the transceiver may be constituted with an RF transmitter to up-convert and amplify the frequency of transmitted signals, an RF receiver to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for the UE's operations. In addition, the memory may store control information or data included in signals transmitted/received by the UE. The memory may include storage media such as a ROM, a RAM, a hard disk, a CD-ROM, and a DVD, or a combination of storage media. In addition, the UE may include a plurality of memories.

In addition, the processor may control a series of processes such that the UE can operate according to the above-described embodiments. For example, the processor may control components of the UE so as to receive DCI constituted in two layers such that multiple PDSCHs are received simultaneously. The UE may include a plurality of processors, and the processors may perform the UE's component control operations by executing programs stored in the memory.

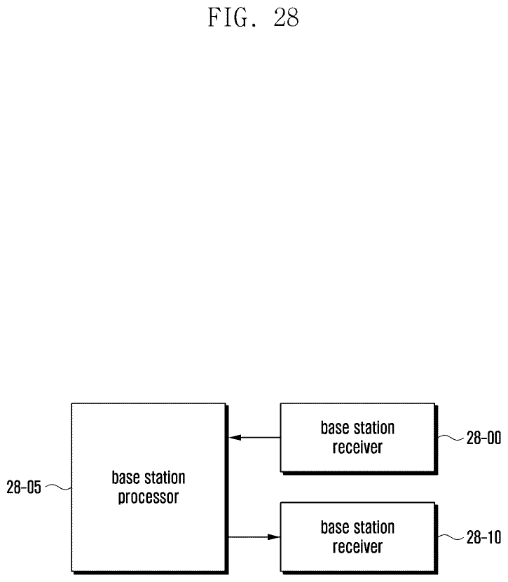

FIG. 28 illustrates a structure of a base station in a wireless communication system according to an embodiment of the disclosure.

With reference to FIG. 28, the base station may include a transceiver, which refers to a base station receiver 28-00 and a base station transmitter 28-10 as a whole, a memory (not illustrated), and a base station processor 28-05 (or base station controller or processor). The base station's transceiver 28-00 and 28-10, memory, and the base station processor 28-05 may operate according to the above-described communication methods of the base station. However, components of the base station are not limited to the above-described example. For example, the base station may include a larger or smaller number of components than the above-described components. Furthermore, the transceiver, memory, and processor may be implemented as a single chip.

The transceiver may transmit/receive signals with the UE. Here, the signals may include control information and data. To this end, the transceiver may be constituted with an RF transmitter to up-convert and amplify the frequency of transmitted signals, an RF receiver to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for the base station's operations. In addition, the memory may store control information or data included in signals transmitted/received by the base station. The memory may include storage media such as a ROM, a RAM, a hard disk, a CD-ROM, and a DVD, or a combination of storage media. In addition, the base station may include a plurality of memories.

The processor may control a series of processes such that the base station can operate according to the above-described embodiments of the disclosure. For example, the processor may control components of the base station so as to constitute DCI of two layers including allocation information regarding multiple PDSCHs and to transmit the same. The base station may include a plurality of processors, and the processors may perform the base station's component control operations by executing programs stored in the memory.

The methods according to embodiments described in the claims or the specification of the disclosure may be implemented by hardware, software, or a combination of hardware and software.

In case that the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, local area network (LAN), wide LAN (WLAN), and storage area network (SAN) or a combination thereof. Such a storage device may access the electronic device that performs the embodiments of the disclosure through an external port. Further, a separate storage device on the communication network may access a device performing the embodiment of the disclosure.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Meanwhile, the embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. For example, a part of one embodiment of the disclosure may be combined with a part of another embodiment to operate a base station and a UE. As an example, a part of embodiment 1 of the disclosure may be combined with a part of embodiment 2 to operate a base station and a UE. Moreover, although the above embodiments have been described based on the FDD LTE system, other variants based on the technical idea of the embodiments may also be implemented in other systems such as TDD LTE, 5G, or NR systems.

Meanwhile, in the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Furthermore, in methods of the disclosure, some or all of the contents of each embodiment may be implemented in combination without departing from the essential spirit and scope of the disclosure.

Various embodiments of the disclosure have been described above. The above description of the disclosure is merely for the purpose of illustration, and embodiments of the disclosure are not limited to the embodiments set forth herein. Those skilled in the art will appreciate that other particular modifications and changes may be easily made without departing from the technical idea or the essential features of the disclosure. The scope of the disclosure should be determined not by the above description but by the appended claims, and all modifications or changes derived from the meaning and scope of the claims and equivalent concepts thereof shall be construed as falling within the scope of the disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a communication system, the method comprising:
receiving, via a higher layer signaling, a first configuration associated with a subband non-overlapping full duplex (SBFD) and a second configuration associated with channel state information (CSI) reference signal (CSI-RS) resources;
identifying, based on the first configuration and the second configuration, CSI-RS resources corresponding to at least one SBFD symbol of an SBFD slot, wherein the CSI-RS resources corresponding to the at least one SBFD symbol include at least one first CSI-RS resource overlapped with at least one downlink SBFD subband corresponding to the SBFD slot and at least one second CSI-RS resource overlapped with at least one uplink SBFD subband corresponding to the SBFD slot;
receiving, based on the at least one first CSI-RS resource, a first CSI-RS corresponding to a sequence, wherein the sequence is mapped to resource elements (REs) within resource blocks (RBs) corresponding to the at least one first CSI-RS resource and the at least one second CSI-RS resource; and
transmitting CSI associated with the first CSI-RS.

2. The method of claim 1, wherein the at least one second CSI-RS resource is not used for a reception of the first CSI-RS.

3. The method of claim 1, wherein the RBs are contiguous in a frequency domain, and
wherein the RBs are identified based on a start RB configuration and an RB configuration number in the second configuration.

4. The method of claim 1, further comprising:
receiving, via the higher layer signaling, a first CSI report configuration associated with the SBFD symbol and a second CSI report configuration associated with a non-SBFD symbol;
identifying, based on the first configuration and the second configuration, CSI-RS resources corresponding to at least one non-SBFD symbol;
receiving, based on the CSI-RS resources corresponding to at least one non-SBFD symbol, a transmitting CSI associated with the second CSI-RS,
wherein the CSI corresponding to the first CSI-RS is transmitted based on the first CSI report, and
wherein the CSI corresponding to the second CSI-RS is transmitted based on the second CSI report.

5. The method of claim 4, wherein the CSI corresponding to the first CSI-RS is derived based on the first CSI-RS, and
wherein the CSI corresponding to the second CSI-RS is derived based on the second CSI-RS.

6. A user equipment (UE) in a communication system, the UE comprising:
a transceiver; and
a processor coupled with the transceiver and configured to:
receive, via a higher layer signaling, a first configuration associated with a subband non-overlapping full duplex (SBFD) and a second configuration associated with channel state information (CSI) reference signal (CSI-RS) resources,
identify, based on the first configuration and the second configuration, CSI-RS resources corresponding to at least one SBFD symbol of an SBFD slot, wherein the CSI-RS resources corresponding to at least one SBFD symbol include at least one first CSI-RS resource overlapped with at least one downlink SBFD subband corresponding to the SBFD slot and at least one second CSI-RS resource overlapped with at least one uplink SBFD subband corresponding to the SBFD slot,
receive, based on the at least one first CSI-RS resource, a first CSI-RS corresponding to a sequence, wherein the sequence is mapped to resource elements (REs) within resource blocks (RBs) corresponding to the at least one first CSI-RS resource and the at least one second CSI-RS resource, and
transmit CSI associated with the first CSI-RS.

7. The UE of claim 6, wherein the at least one second CSI-RS resource is not used for a reception of the first CSI-RS.

8. The UE of claim 6, wherein the RBs are contiguous in a frequency domain, and
wherein the RBs are identified based on a start RB configuration and an RB configuration number in the second configuration.

9. The UE of claim 6, wherein the processor is further configured to:
receive, via the higher layer signaling, a first CSI report configuration associated with the SBFD symbol and a second CSI report configuration associated with a non-SBFD symbol;
identify, based on the first configuration and the second configuration, CSI-RS resources corresponding to at least one non-SBFD symbol;
receive, based on the CSI-RS resources corresponding to at least one non-SBFD symbol, a transmit CSI associated with the second CSI-RS,
wherein the CSI corresponding to the first CSI-RS is transmitted based on the first CSI report, and
wherein the CSI corresponding to the second CSI-RS is transmitted based on the second CSI report.

10. The UE of claim 9, wherein the CSI corresponding to the first CSI-RS is derived based on the first CSI-RS, and
wherein the CSI corresponding to the second CSI-RS is derived based on the second CSI-RS.

11. A method performed by a base station in a communication system, the method comprising:
transmitting, via a higher layer signaling, a first configuration associated with a subband non-overlapping full duplex (SBFD) and a second configuration associated with channel state information (CSI) reference signal (CSI-RS) resources;
identifying CSI-RS resources corresponding to at least one SBFD symbol of an SBFD slot, wherein the CSI-RS resources corresponding to at least one SBFD symbol include at least one first CSI-RS resource overlapped with at least one downlink SBFD subband corresponding to the SBFD slot and at least one second CSI-RS resource overlapped with at least one uplink SBFD subband corresponding to the SBFD slot;
transmitting, based on the at least one first CSI-RS resource, a first CSI-RS corresponding to a sequence, wherein the sequence is mapped to resource elements (REs) within resource blocks (RBs) corresponding to the at least one first CSI-RS resource and the at least one second CSI-RS resource; and
receiving CSI associated with the first CSI-RS.

12. The method of claim 11, wherein the at least one second CSI-RS resource is not used for a transmission of the first CSI-RS.

13. The method of claim 11, wherein the RBs are contiguous in a frequency domain, and
wherein the RBs are configured based on a start RB configuration and an RB configuration number in the second configuration.

14. The method of claim 11, further comprising:
transmitting, via the higher layer signaling, a first CSI report configuration associated with the SBFD symbol and a second CSI report configuration associated with a non-SBFD symbol;
identifying CSI-RS resources corresponding to at least one non-SBFD symbol;
transmitting, based on the CSI-RS resources corresponding to at least one non-SBFD symbol, a second CSI-RS; and
receiving CSI associated with the second CSI-RS,
wherein the CSI corresponding to the first CSI-RS is associated with the first CSI report, and
wherein the CSI corresponding to the second CSI-RS is associated with the second CSI report.

15. The method of claim 14, wherein the CSI corresponding to the first CSI-RS is derived based on the first CSI-RS, and
wherein the CSI corresponding to the second CSI-RS is derived based on the second CSI-RS.

16. A base station in a communication system, the base station comprising:
a transceiver; and
a processor coupled with the transceiver and configured to:
transmit, via a higher layer signaling, a first configuration associated with a subband non-overlapping full duplex (SBFD) and a second configuration associated with channel state information (CSI) reference signal (CSI-RS) resources,
identify CSI-RS resources corresponding to at least one SBFD symbol of an SBFD slot, wherein the CSI-RS resources corresponding to at least one SBFD symbol include at least one first CSI-RS resource overlapped with at least one downlink SBFD subband corresponding to the SBFD slot and at least one second CSI-RS resource overlapped with at least one uplink SBFD subband corresponding to the SBFD slot,
transmit, based on the at least one first CSI-RS resource, a first CSI-RS corresponding to a sequence, wherein the sequence is mapped to resource elements (REs) within resource blocks (RBs) corresponding to the at least one first CSI-RS resource and the at least one second CSI-RS resource, and
receive CSI associated with the first CSI-RS.

17. The base station of claim 16, wherein the at least one second CSI-RS resource is not used for a transmission of the first CSI-RS.

18. The base station of claim 16, wherein the RBs are contiguous in a frequency domain, and
wherein the RBs are configured based on a start RB configuration and an RB configuration number in the second configuration.

19. The base station of claim 16, wherein the processor is further configured to:
transmit, via the higher layer signaling, a first CSI report configuration associated with the SBFD symbol, and a second CSI report configuration associated with a non-SBFD symbol;
identify CSI-RS resources corresponding to at least one non-SBFD symbol;
transmit, based on the CSI-RS resources corresponding to at least one non-SBFD symbol, a second CSI-RS; and
receive CSI associated with the second CSI-RS,
wherein the CSI corresponding to the first CSI-RS is associated with the first CSI report, and
wherein the CSI corresponding to the second CSI-RS is associated with the second CSI report.

20. The base station of claim 19, wherein the CSI corresponding to the first CSI-RS is derived based on the first CSI-RS, and
wherein the CSI corresponding to the second CSI-RS is derived based on the second CSI-RS.
